(19) United States
(12) Patent Application Publication
(10) Pub. No.: US 2006/0293817 A1
(43) Pub. Date: Dec. 28, 2006

(54) Intelligent electronically-controlled suspension system based on soft computing optimizer

(76) Inventors: Takahide Hagiwara, Iwata-shi (JP); Sergei A. Panfilov, Crema (IT); Sergei V. Ulyanov, Crema (IT)

Correspondence Address: KNOBBE MARTENS OLSON & BEAR LLP, 2040 MAIN STREET, FOURTEENTH FLOOR, IRVINE, CA, 92614, US

(21) Appl. No.: 11/159,830

(22) Filed: Jun. 23, 2005

(51) Int. Cl. B60G 17/018; G06F 17/00

(52) U.S. Cl. 701/40; 701/27

(57) ABSTRACT

A Soft Computing (SC) optimizer for designing a Knowledge Base (KB) to be used in a control system for controlling a suspension system is described. The SC optimizer includes a fuzzy inference engine based on a Fuzzy Neural Network (FNN). The SC Optimizer provides Fuzzy Inference System (FIS) structure selection, FIS structure optimization method selection, and teaching signal selection and generation. The user selects a fuzzy model, including one or more of: the number of input and/or output variables; the type of fuzzy inference model (e.g., Mamdani, Sugeno, Tsukamoto, etc.); and the preliminary type of membership functions. A Genetic Algorithm (GA) is used to optimize linguistic variable parameters and the input-output training patterns. A GA is also used to optimize the rule base, using the fuzzy model, optimal linguistic variable parameters, and a teaching signal. The GA produces a near-optimal FNN. The near-optimal FNN can be improved using classical derivative-based optimization procedures. The FIS structure found by the GA is optimized with a fitness function based on a response of the actual suspension system model of the controlled suspension system. The SC optimizer produces a robust KB that is typically smaller that the KB produced by prior art methods.

### BACKGROUND

1. Field of the Invention

The present invention relates generally to electronically-controlled suspension systems based on soft computing optimization.

2. Description of the Related Art

Feedback control systems are widely used to maintain the output of a dynamic system at a desired value in spite of external disturbances that would displace it from the desired value. For example, a household space-heating furnace, controlled by a thermostat, is an example of a feedback control system. The thermostat continuously measures the air temperature inside the house, and when the temperature falls below a desired minimum temperature the thermostat turns the furnace on. When the interior temperature reaches the desired minimum temperature, the thermostat turns the furnace off. The thermostat-furnace system maintains the household temperature at a substantially constant value in spite of external disturbances such as a drop in the outside temperature. Similar types of feedback controls are used in many applications.

A P(I)D control system is a linear control system that is based on a dynamic model of the suspension system. In classical control systems, a linear dynamic model is obtained in the form of dynamic equations, usually ordinary differential equations. The suspension system is assumed to be relatively linear, time invariant, and stable. However, many real-world suspension systems, such as vehicle suspension systems, are time varying, highly non-linear, and unstable. For example, the dynamic model may contain parameters (e.g., masses, inductance, aerodynamics coefficients, etc.), which are either only approximately known or depend on a changing environment. If the parameter variation is small and the dynamic model is stable, then the P(I)D controller may be satisfactory. However, if the parameter variation is large or if the dynamic model is unstable, then it is common to add Adaptive or Intelligent (AI) control functions to the P(I)D control system.

Classical advanced control theory is based on the assumption that all controlled “suspension systems” can be approximated as linear systems near equilibrium points. Unfortunately, this assumption is rarely true in the real world. Most suspension systems are highly nonlinear, and often do not have simple control algorithms. In order to meet these needs for a nonlinear control, systems have been developed that use Soft Computing (SC) concepts such as Fuzzy Neural Networks (FNN), Fuzzy Controllers (FC), and the like. By these techniques, the control system evolves (changes) in time to adapt itself to changes that may occur in the controlled “suspension system” and/or in the operating environment.

Control systems based on SC typically use a Knowledge Base (KB) to contain the knowledge of the FC system. The KB typically has many rules that describe how the SC determines control parameters during operation. Thus, the performance of an SC controller depends on the quality of the KB and the knowledge represented by the KB. Increasing the number of rules in the KB generally increases (very often with redundancy) the knowledge represented by the KB but at a cost of more storage and more computational complexity. Thus, design of a SC system typically involves tradeoffs regarding the size of the KB, the number of rules, the types of rules. etc. Unfortunately, the prior art methods for selecting KB parameters such as the number and types of rules are based on ad hoc procedures using intuition and trial-and-error approaches.

Control of a vehicle suspension system is particularly difficult because the excitation of the suspension system is based on the road that the vehicle is driven on. Different roads can produce strikingly different excitations with different stochastic properties. Control of the suspension system in a soft computing control system is based on the information in the KB, and good control is achieved by using a good KB. However, the varying stochastic conditions produced by different roads makes it difficult to create a globally optimized KB that provides good control for a wide variety of roads.

### SUMMARY

The present invention solves these and other problems by providing a SC optimizer for designing a globally-optimized KB to be used in a SC system for an electronically-controlled suspension system. In one embodiment, the SC optimizer includes a fuzzy inference engine. In one embodiment, the fuzzy inference engine includes a Fuzzy Neural Network (FNN). In one embodiment, the SC Optimizer provides Fuzzy Inference System (FIS) structure selection, FIS structure optimization method selection, and Teaching signal selection.

The control system uses a fitness (performance) function that is based on the physical laws of minimum entropy and, optionally, biologically inspired constraints relating to rider comfort, driveability, etc. In one embodiment, a genetic analyzer is used in an off-line mode to develop a teaching signal. In one embodiment, an optional information filter is used to filter the teaching signal to produce a compressed teaching signal. The compressed teaching signal can be approximated online by a fuzzy controller that operates using knowledge from a knowledge base. The control system can be used to control complex suspension systems described by linear or nonlinear, stable or unstable, dissipative or nondissipative models. The control system is configured to use smart simulation techniques for controlling the shock absorber (suspension system).

In one embodiment, the control system includes a Fuzzy Inference System (FIS), such as a neural network that is trained by a genetic analyzer. The genetic analyzer uses a fitness function that maximizes sensor information while minimizing entropy production based on biologically-inspired constraints.

In one embodiment, a suspension control system uses a difference between the time differential (derivative) of entropy (called the entropy production rate) from the learning control unit and the time differential of the entropy inside the controlled process (or a model of the controlled process) as a measure of control performance. In one embodiment, the entropy calculation is based on a thermodynamic model of an equation of motion for a controlled process suspension system that is treated as an open dynamic system.

The control system is trained by a genetic analyzer that generates a teaching signal. The optimized control system provides an optimum control signal based on data obtained from one or more sensors. For example, in a suspension system, a plurality of angle and position sensors can be used. In an off-line learning mode (e.g., in the laboratory, factory, service center, etc.), fuzzy rules are evolved using a kinetic model (or simulation) of the vehicle and its suspension system. Data from the kinetic model is provided to an entropy calculator that calculates input and output entropy production of the model. The input and output entropy productions are provided to a fitness function calculator that calculates a fitness function as a difference in entropy production rates for the genetic analyzer constrained by one or more constraints obtained from rider preferences. The genetic analyzer uses the fitness function to develop a training signal for the off-line control system. The training signal is filtered to produce a compressed training signal. Control parameters from the off-line control system are then provided to an online control system in the vehicle that, using information from a knowledge base, develops an approximation to the compressed training signal.

One embodiment provides a method for controlling a nonlinear object (e.g., a suspension system) by obtaining an entropy production difference between a time differentiation (dSᵤ/dt) of the entropy of the suspension system and a time differentiation (dS_{c}/dt) of the entropy provided to the suspension system from a controller. A genetic algorithm that uses the entropy production difference as a fitness (performance) function evolves a control rule in an off-line controller. The nonlinear stability characteristics of the suspension system are evaluated using a Lyapunov function. The genetic analyzer minimizes entropy and maximizes sensor information content. Filtered control rules from the off-line controller are provided to an online controller to control suspension system. In one embodiment, the online controller controls the damping factor of one or more shock absorbers (dampers) in the vehicle suspension system.

In some embodiments, the control method also includes evolving a control rule relative to a variable of the controller by means of a genetic algorithm. The genetic algorithm uses a fitness function based on a difference between a time differentiation of the entropy of the suspension system (dSₚ/dt) and a time differentiation (dS_{c}/dt) of the entropy provided to the suspension system. The variable can be corrected by using the evolved control rule.

In one embodiment, a self-organizing control system is adapted to control a nonlinear suspension system. The AI control system includes a simulator configured to use a thermodynamic model of a nonlinear equation of motion for the suspension system. The thermodynamic model is based on a Lyapunov function (V), and the simulator uses the function V to analyze control for a state stability of the suspension system. The control system calculates an entropy production difference between a time differentiation of the entropy of said suspension system (dSₚ /dt) and a time differentiation (dS_{c}/dt) of the entropy provided to the suspension system by a low-level controller that controls the suspension system. The entropy production difference is used by a genetic algorithm to obtain an adaptation function wherein the entropy production difference is minimized in a constrained fashion. The genetic algorithm provides a teaching signal. The teaching signal is filtered to remove stochastic noise to produce a filtered teaching signal. The filtered teaching signal is provided to a fuzzy logic classifier that determines one or more fuzzy rules by using a leaming process. The fuzzy logic controller is also configured to form one or more control rules that set a control variable of the controller in the vehicle.

In one embodiment, a physical measure of control quality is based on minimum entropy production and using this measure for a fitness function of genetic algorithm in optimal control system design. This method provides a local entropy feedback loop in the control system. The entropy feedback loop provides for optimal control structure design by relating stability of the suspension system (using a Lyapunov function) and controllability of the suspension system (based on entropy production of the control system).

In one embodiment, the user makes the selection of parameters for a fuzzy model, including one or more of: the number of input and/or output variables; the type of fuzzy inference model (e.g., Mamdani, Sugeno, Tsukamoto, etc.); and the preliminary type of membership functions.

In one embodiment, a Genetic Algorithm (GA) is used to optimize linguistic variable parameters and the input-output training patterns. In one embodiment, a GA is used to optimize the rule base, using the fuzzy model, optimal linguistic variable parameters, and a teaching signal.

One embodiment includes fine tuning of the FNN. The GA produces a near-optimal FNN. In one embodiment, the near-optimal FNN can be improved using classical derivative-based optimization procedures.

One embodiment includes optimization of the FIS structure by using a GA with a fitness function based on a response of the actual suspension system model.

One embodiment includes optimization of the FIS structure by a GA with a fitness function based on a response of the actual suspension system.

The result is a specification of an FIS structure that specifies parameters of the optimal FC according to desired requirements.

### BRIEF DESCRIPTION OF THE FIGURES

FIG. 1 shows a vehicle with an electronically-controlled suspension system.

FIG. 2 is a block diagram of the general structure of a self-organizing intelligent control system based on SC that uses a FNN to generate a KB for a FC.

FIG. 3 is a block diagram of the general structure of a self-organizing intelligent control system based on SC with a SC optimizer to optimize the structure of the KB used by the FNN of FIG. 2.

FIG. 4 illustrates the structure of a self-organizing intelligent suspension control system with physical and biological measures of control quality based on soft computing.

FIG. 5 shows use of the control systems shown in FIGS. 2-4 in offline learning and online control.

FIG. 6 illustrates the process of constructing the Knowledge Base (KB) for the Fuzzy Controller (FC).

FIG. 7 shows road signals for 9 representative roads.

FIG. 8 shows a normalized auto-correlation function for different velocities of motion along the road number 9 (from FIG. 7).

FIG. 9 shows the structure of one embodiment of an SSCQ for use in connection with a simulation model of the full car and suspension system.

FIG. 10 is a flowchart showing operation of the SSCQ of FIG. 9.

FIG. 11 shows time intervals associated with the operating mode of the SSCQ of FIG. 9.

FIG. 12 is a flowchart showing operation of the SSCQ of FIG. 9 in connection with the GA.

FIG. 13 shows a coordinate model of a passenger car as a non-linear system with four local coordinates for each wheel suspension and three for the vehicle body.

FIG. 14 shows information flow in the SC optimizer.

FIG. 15 is a flowchart of the SC optimizer.

FIG. 16 shows information levels of the teaching signal and the linguistic variables.

FIG. 17 shows inputs for linguistic variables 1 and 2.

FIG. 18 shows outputs for linguistic variable 1.

FIG. 19 shows the activation history of the membership functions presented in FIGS. 17 and 18.

FIG. 20 shows the activation history of the membership functions presented in FIGS. 17 and 18.

FIG. 21 shows the activation history of the membership functions presented in FIGS. 17 and 18.

FIG. 22 is a diagram showing rule strength versus rule number for 15 rules.

FIG. 23A shows the ordered history of the activations of the rules, where the Y-axis corresponds to the rule index, and the X-axis corresponds to the pattern number (t).

FIG. 23B shows the output membership functions, activated in the same points of the teaching signal, corresponding to the activated rules of FIG. 23A.

FIG. 23C shows the corresponding output teaching signal.

FIG. 23D shows the relation between rule index, and the index of the output membership functions it may activate.

FIG. 24A shows an example of a first complete teaching signal variable.

FIG. 24B shows an example of a second complete teaching signal variable.

FIG. 24C shows an example of a third complete teaching signal variable.

FIG. 24D shows an example of a first reduced teaching signal variable.

FIG. 24E shows an example of a second reduced teaching signal variable.

FIG. 24F shows an example of a third reduced teaching signal variable.

FIG. 25 is a diagram showing rule strength versus rule number for 12 selected rules after second GA optimization.

FIG. 26 shows approximation results using a reduced teaching signal corresponding to the rules from FIG. 25.

FIG. 27 shows the complete teaching signal corresponding to the rules from FIG. 25.

FIG. 28 shows embodiment with KB evaluation based on approximation error.

FIG. 29 shows embodiment with KB evaluation based on suspension system dynamics.

FIG. 30 shows optimal control signal acquisition.

FIG. 31 shows teaching signal acquisition form an optimal control signal.

FIG. 32 shows input membership functions, number, type and parameters obtained by optimization for control of the suspension system of FIG. 1.

FIG. 33 shows output membership functions, number, type and parameters obtained by optimization for control of the suspension system of FIG. 1.

FIG. 34 shows activation history of the fuzzy sets for a sample teaching signal during a first interval.

FIG. 35 shows activation history of the fuzzy sets for a sample teaching signal during a second interval.

FIG. 36 shows activation history of the fuzzy sets for a sample teaching signal during a third interval.

FIG. 37 shows activation history of the fuzzy sets for a sample teaching signal during a fourth interval.

FIG. 38 shows activation history of the fuzzy sets for a sample teaching signal during a fifth interval.

FIG. 39 shows activation history of the fuzzy sets for a sample teaching signal during a sixth interval.

FIG. 40 shows activation history of the fuzzy sets for a sample teaching signal during a seventh interval.

FIG. 41 shows activation history of the fuzzy sets for a sample teaching signal during a eighth interval.

FIG. 42 shows operation of the rule structure optimization algorithm.

FIG. 43 shows rule optimization using an incomplete teaching signal, where each pattern configuration corresponds to one configuration of input-output pairs with a given structure of membership functions.

FIG. 44 shows the resulting approximation of the reduced teaching signal for output number 4.

FIG. 45 shows dynamics of the genetic optimization of the rules structure.

FIG. 46 shows the best 70 rules obtained with the GA2, where the threshold level was set to prepare a maximum of 70 rules.

FIG. 47 shows membership functions obtained with Back-Propagation in the FNN, where the number of membership functions and their types were set manually.

FIG. 48 shows Sugeno 0 order type membership functions obtained with back propagation in the FNN, where the number of membership functions is equal to the number of rules and each output membership function has is crisp value.

FIG. 49 shows results of approximation with the back-propagation based FNN.

FIG. 50 shows results of teaching signal approximation with the SC optimizer.

FIG. 51A shows a sample road signal to be used for knowledge base creation and simulations to compare (see FIG. 38) the FNN and the SCO controller.

FIG. 51B shows a Gaussian road signal to be used for simulations to compare (see FIG. 53) the FNN and the SCO controllers to evaluate robustness.

FIG. 52 shows a comparison of simulation results between the FNN and the SCO conrollers using the road signal from FIG. 51A.

FIG. 53 shows a comparison of simulation results between the FNN and the SCO controllers using the road signal from FIG. 51B.

FIG. 54 shows field test results comparing FNN and SCO control.

FIG. 55 shows motion of the coupled nonlinear oscillators along the x-y axes under non-Gaussian (Rayleigh noise) stochastic excitation with fuzzy control in TS initial conditions.

FIG. 56 shows comparison of control errors under PID control, FNN-based control and SCO-based control for the coupled nonlinear oscillator's motion under non-Gaussian stochastic excitation (Rayleigh noise).

FIG. 57 shows generalized entropy characteristics of the coupled nonlinear oscillators motion under non-Gaussian stochastic excitation (Rayleigh noise).

FIG. 58 shows the controller entropy characteristics in TS initial conditions for PID, FNN, and SCO-based controllers.

FIG. 59 shows control force characteristics in TS initial conditions for PID, FNN and SCO-based controllers.

FIG. 60 shows results of robustness investigations using the FC with the same KB (obtained from the teaching signal for the given initial conditions) for motion along x-y axes under PID control, FNN-based control and SCO-based control.

FIG. 61 shows results of robustness investigations using the FC with the same KB (obtained from the teaching signal for the given initial conditions) where a new reference signal and new model parameters are considered

FIG. 62 shows results of robustness investigations using the FC with the same KB (obtained from the teaching signal for the given initial conditions) showing comparison of generalized entropy characteristics under PID control, FNN-based control and SCO-based control.

FIG. 63 shows results of robustness investigations using the FC with the same KB (obtained from the teaching signal for the given initial conditions) where new reference signal and new model parameters are considered showing comparison of PID, FNN-and SCO-based controllers entropy characteristics.

FIG. 64 shows results of robustness investigations using the FC with the same KB (obtained from the teaching signal for the given initial conditions) where the new reference signal and new model parameters are considered showing comparison of PID, FNN-and SCO-based control force characteristics.

### DETAILED DESCRIPTION

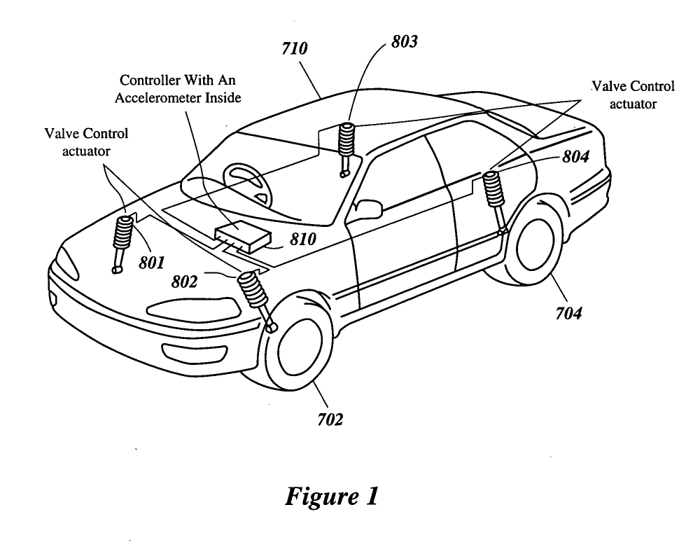

FIG. 1 shows a vehicle with an electronically-controlled suspension system. The vehicle in FIG. 1 includes a vehicle body 710, a front left wheel 702, a rear left wheel 704 (a front right wheel 701 and a rear right wheel 703 are hidden). FIG. 1 also shows dampers 801-804 configured to provide adjustable damping for the wheels 701-704 respectively. In one embodiment, the dampers 801-804 are electronically-controlled dampers. In one embodiment, a stepping motor actuator on each damper controls an oil valve. Oil flow in each rotary valve position determines the damping factor provided by the damper.

In one embodiment, the adjustable dampers 801-804 each have an actuator that controls a rotary valve. In one embodiment, a hard-damping valve allows fluid to flow in the adjustable dampers to produce hard damping, and a soft-damping valve allows fluid to flow in the adjustable dampers to produce soft damping. The actuators control the rotary valves to allow more or less fluid to flow through the valves, thereby producing a desired damping. In one embodiment, the actuator is a stepping motor that receives control signals from a controller, as described below.

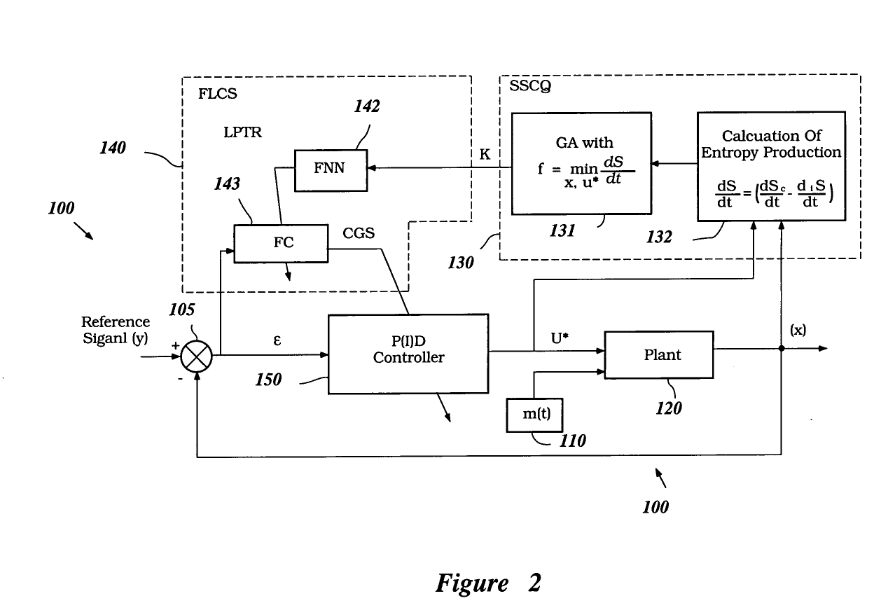

FIG. 2 shows a self-organizing control system 100 for controlling a suspension system such as the suspension system shown in FIG. 1. The system 100 is based on Soft Computing (SC). The control system 100 includes a suspension system 120, a Simulation System of Control Quality (SSCQ) 130, a Fuzzy Logic Classifier System (FLCS) 140 and a P(I)D controller 150. The SSCQ 130 includes a module 132 for calculating a fitness function, such as, in one embodiment, entropy production from of the suspension system 120, and a control signal output from the P(I)D controller 150. The SSCQ 130 also includes a Genetic Algorithm (GA) 131. In one embodiment, a fitness function of the GA 131 is configured to reduce entropy production. The FLCS 140 includes a FNN 142 to program a FC 143. An output of the FC 143 is a coefficient gain schedule for the P(I)D controller 150. The P(I)D controller 150 controls the dampers in the suspension system 120.

A road signal m(t) 110 is provided to the suspension system 120 as an external excitation. Movement of the suspension system 120 is often discussed in terms of acceleration and jerk. However, accleration and jerk are not well suited to control both the suspension system stability and riding comfort. The stability is dominated mainly by a low frequency component around 1 Hz and the comfort by frequency components above 4 or 5 Hz. Three axes of heave, pitch and roll also have to be considered. Therefore, in this case, a fitness function FF is expressed as follows:
FF=|Aₚ(1)|+|Aᵣ(1)|+Aₕ(4)|+Aₕ(5)|+. . . +|Aₕ(10)
where Aₚ(1) is the amplitude of the 1 Hz pitch angular acceleration, Aᵣ(1) the 1 Hz component of the roll acceleration, Aₕ(4) the 4 Hz component of the heave acceleration, and so on. This fitness function FF is minimized by the GA 131 and a teaching signal K is created that is used for knowledge base creation for the fuzzy controller 153 by the FNN 142.

Using a set of inputs, and the fitness function 132, the genetic algorithm 131 works in a manner similar to an evolutional process to arrive at a solution which is, hopefully, optimal.

The genetic algorithm 131 generates sets of “chromosomes” (that is, possible solutions) and then sorts the chromosomes by evaluating each solution using the fitness function 132. The fitness function 132 determines where each solution ranks on a fitness scale. Chromosomes (solutions) that are more fit are those chromosomes that correspond to solutions that rate high on the fitness scale. Chromosomes that are less fit, are those chromosomes that correspond to solutions that rate low on the fitness scale.

Chromosomes that are relatively more fit are kept (survive) and chromosomes that are relatively less fit are discarded (die). New chromosomes are created to replace the discarded chromosomes. The new chromosomes are created by crossing pieces of existing chromosomes and by introducing mutations. The success or failure of the optimization often ultimately depends on the selection of the performance (fitness) function 132.

Evaluating the motion characteristics of a nonlinear suspension system is often difficult, in part due to the lack of a general analysis method. Conventionally, when controlling a suspension system with nonlinear motion characteristics, it is common to find certain equilibrium points of the suspension system and the motion characteristics of the suspension system are linearized in a vicinity near an equilibrium point. Control is then based on evaluating the pseudo (linearized) motion characteristics near the equilibrium point. This technique is scarcely, if at all, effective for suspension systems described by models that are unstable or dissipative.

Computation of optimal control based on soft computing includes the GA 131 as the first step of global search for optimal solution on a fixed space of positive solutions. The GA searches for a set of control gains for the suspension system. Firstly the gain vector K={k₁, . . . , kₙ} is used by a conventional proportional-integral-differential (PID) controller 150 in the generation of a signal δ(K)which is applied to the suspension system. The entropy S(δ(K)) associated to the behavior of the suspension system on this signal is assumed as a fitness function to minimize. The GA is repeated several times at regular time intervals in order to produce a set of weight vectors. The vectors generated by the GA 131 are then provided to the FNN/SCO 142 and the output KB of the FNN/SCO 142 is provided to the FC 143. The FC 143 uses the KB to generate gain schedules for the PID-controller 150 that controls the suspension system.

The intelligent control systems design technology based on soft computing includes the following two process stages:
Stage 1: Computing teaching patterns (input-output pairs) for optimal control by using the GA 131 in the SSCQ block 130, based on the mathematical model of the controlled object (e.g., the suspension system 120) and the physical criteria of minimum of entropy production rate.
Stage 2: Approximation of the optimal control (from Stage 1) by the corresponding Fuzzy Controller (FC) 143.

The first stage is the acquisition of a robust teaching signal for optimal control without unacceptable loss of information. The output of the first stage is the robust teaching signal, which contains the necessary information about the controlled object behavior and corresponding behavior of control system.

The second stage is the approximation of the teaching signal by building of some fuzzy inference system. The output of the second stage is a knowledge base (KB) for fuzzy controller.

The design of optimal fuzzy controller means the design of an optimal Knowledge Base of the FC including optimal numbers of input-output membership functions, their optimal shapes and parameters and a set of optimal fuzzy rules.

In one embodiment for the Stage 2 realization, optimal FC can be obtained using a fuzzy neural network with the learning method based on the error back propagation algorithm. The error back propagation algorithm is based on the application of the gradient descent method to the structure of the FNN. The error is calculated as a difference between the desired output of the FNN and an actual output of the FNN. Then the error is “back propagated” through the layers of the FNN, and parameters of each neuron of each layer are modified towards the direction of the minimum of the propagated error.

The back propagation algorithm has a few disadvantages. In order to apply the back propagation approach it is necessary to know the complete structure of the FNN prior to optimization. The back propagation algorithm can not be applied to a network with an unknown number of layers and/or an unknown number nodes. The back propagation process cannot modify the types of the membership functions;

Usually, the initial state of the coefficients for the back propagation algorithm is set up randomly, and, as a result, the back propagation algorithm often gets only a “local” optimum close to the initial state. One way to avoid this is to manually set to the learning rates, but in this case operator should be confident about the expected result. The error back propagation algorithm is used in many Adaptive Fuzzy Modeler (AFM) systems, such as, for example, the AFM provided by STMicroelectronics (STM) and used as an example herein. The AFM provides implementation of Sugeno 0 order fuzzy inference systems from in-out data using error back propagation. The algorithm of the AFM has the following steps:

In the first step, a user specifies the parameters of a future FNN such as the number of inputs, the number of outputs, and the number of fuzzy sets for each input/output. Then AFM “optimizes” the rule base using the so-called “let the best rule win” (LBRW) technique. During this phase, the membership functions are fixed as uniformly distributed among the universe of discourse, and AFM calculates the firing strength of the each rule, eliminating the rules with zero firing strength, and adjusting centers of the consequents of the rules with nonzero firing strength. It is possible during optimization of the rule base to specify the learning rate parameter, depending on the current problem.

In the AFM, there is also an option to build a rule base manually. In this case, user can specify the centroids of the input fuzzy sets, and then according to the specification, system builds rule base automatically.

In the second step, AFM offers building of the membership functions. User can specify the shape factors of the input membership functions. Supported by AFM shape factors are: Gaussian, Isosceles Triangular, and Scalene Triangular. The user must also specify the type of a fuzzy end operation in the Sugeno model: supported methods are Product and Minimum.

After specification of the membership function shape and Sugeno inference method, the AFM starts optimization of the membership function shapes, using the structure of the rules, developed during stage 1. There are also some optional parameters to control optimization rate such as a target error and the number of iterations, the network should make. The termination condition on the optimization is reaching of the number of iterations, or when the error reaches its target value.

The STM AFM inherits the weakness of the back propagation algorithm described above, and the same limitations. The user must specify the types of membership functions, the number of membership functions for each linguistic variable and so on. The rule number optimizer in the AFM is called before membership function optimization, and as a result, the system can become unstable during membership function optimization phase.

The P(I)D controller 150 has a substantially linear transfer function and thus is based upon a linearized equation of motion for the controlled “suspension system” 120. Prior art GA used to program P(I)D controllers typically use simple fitness functions and thus do not solve the problem of poor controllability typically seen in linearization models. As is the case with most optimizers, the success or failure of the optimization often ultimately depends on the selection of the performance (fitness) function 132.

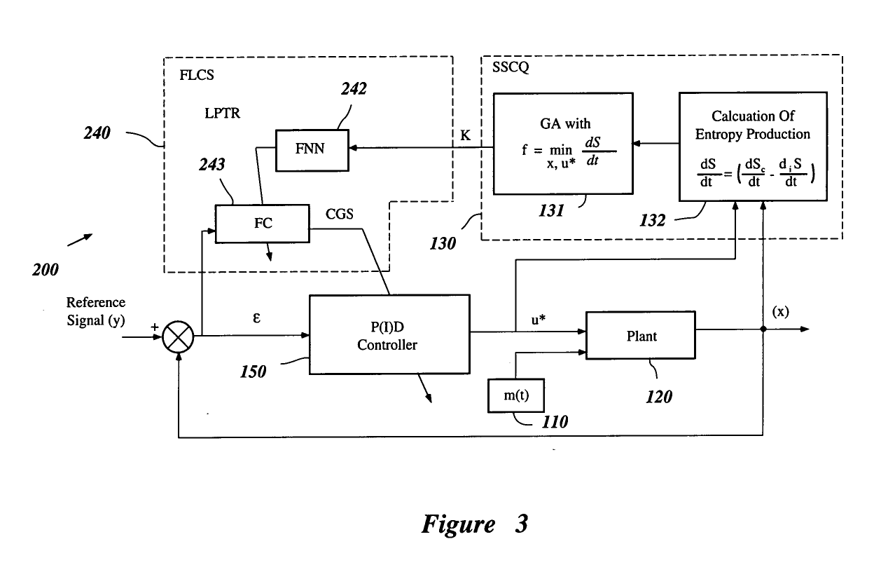

FIG. 3 shows the self-organizing control system of FIG. 1, where the FLCS 140 is replaced by an FLCS 240. The FLCS 240 includes a Soft Computing Optimizer (SCO) 242 configured to program an optimal FC 243.

The SSCQ 130 finds teaching patterns (input-output pairs) for optimal control by using the GA 131 based on a mathematical model of the controlled suspension system 120 and physical criteria of minimum of entropy production rate. The FLCS 240 produces an approximation of the optimal control produced by the SSCQ 130 by programming the optimal FC 243.

The SSCQ 130 provides acquisition of a robust teaching signal for optimal control. The output of SSCQ 130 is the robust teaching signal, which contains the necessary information about the optimal behavior of the suspension system 120 and corresponding behavior of the control system 200.

The SC optimizer 242 produces an approximation of the teaching signal by building a Fuzzy Inference System (FIS). The output of the SC optimizer 242 includes a Knowledge Base (KB) for the optimal FC 243.

The optimal FC operates using the optimal KB from the FC 243 including, but not limited to, the number of input-output membership functions, the shapes and parameters of the membership functions, and a set of optimal fuzzy rules based on the membership functions.

In one embodiment, the optimal FC 243 is obtained using a FNN trained using a training method, such as, for example, the error back propagation algorithm. The error back propagation algorithm is based on application of the gradient descent method to the structure of the FNN. The error is calculated as a difference between the desired output of the FNN and an actual output of the FNN. Then the error is “back propagated” through the layers of the FNN, and the parameters of each neuron of each layer are modified towards the direction of the minimum of the propagated error. The back propagation algorithm has a few disadvantages. First, in order to apply the back propagation approach, it is necessary to know the complete structure of the FNN prior to the optimization. The back propagation algorithm can not be applied to a network with an unknown number of layers or an unknown number of nodes. Second, the back propagation process cannot modify the types of the membership functions. Finally, the back propagation algorithm very often finds only a local optimum close to the initial state rather than the desired global minimum. This occurs because the initial coefficients for the back propagation algorithm are usually generated randomly.

The error back propagation algorithm is used, in a commercially available Adaptive Fuzzy Modeler (AFM). The AFM permits creation of Sugeno 0 order FIS from digital input-output data using the error back propagation algorithm. The algorithm of the AFM has two steps. In the first AFM step, a user specifies the parameters of a future FNN. Parameters include the number of inputs and number of outputs and the number of fuzzy sets for each input/output. Then AFM “optimizes” the rule base, using a so-called “let the best rule win” (LBRW) technique. During this phase, the membership functions are fixed as uniformly distributed among the universe of discourse, and the AFM calculates the firing strength of the each rule, eliminating the rules with zero firing strength, and adjusting centers of the consequents of the rules with nonzero firing strength. It is possible during optimization of the rule base to specify the learning rate parameter. The AFM also includes an option to build the rule base manually. In this case, user can specify the centroids of the input fuzzy sets, and then the system builds the rule base according to the specified centroids.

In the second AFM step, the AFM builds the membership functions. The user can specify the shape factors of the input membership functions. Shape factor supported by the AFM include: Gaussian; Isosceles Triangular; and Scalene Triangular. The user must also specify the type of fuzzy AND operation in the Sugeno model, either as a product or a minimum.

After specification of the membership function shape and Sugeno inference method, the AFM starts optimization of the membership function shapes. The user can also specify optional parameters to control optimization rate such as a target error and the number of iterations.

The AFM inherits the limitations and weaknesses of the back propagation algorithm described above. The user must specify the types of membership functions, the number of membership functions for each linguistic variable and so on. AFM uses -rule number optimization before membership functions optimization, and as a result, the system becomes very often unstable during the membership function optimization phase.

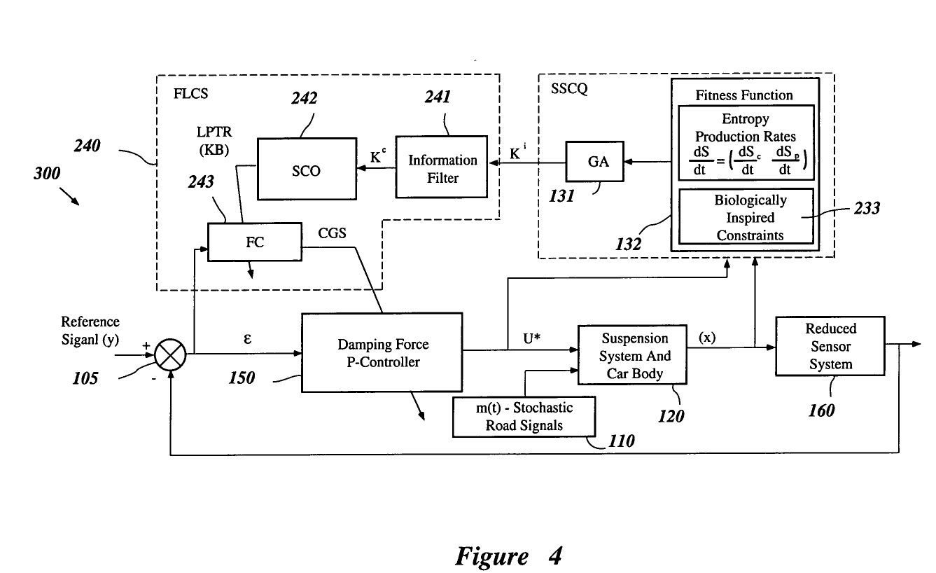

FIG. 4 shows an alternate embodiment of an intelligent electronically-controlled suspension control system 300 for controlling the suspension system. The system 300 is similar to the system 200 with the addition of an information filter 241 to the FLCS and biologically-inspired constraints 233 in the fitness function 132. An information filter 241 is placed between the GA 131 and the SCO 242 such that a solution vector output Kᵢ from the GA 131 is provided to an input of the information filter 241. An output of the information filter 241 is a filtered solution vector K_{c} that is provided to the SCO 242. In FIG. 4, the disturbance 110 is a road signal m(t). (e.g., measured data or data generated via stochastic simulation). In one embodiment, the fitness function 132, in addition to entropy production rate, optionally includes biologically-inspired constraints based on mechanical and/or human factors. In one embodiment, the filter 241 includes an information compressor that reduces unnecessary noise in the training signal provided to the SCO 242.

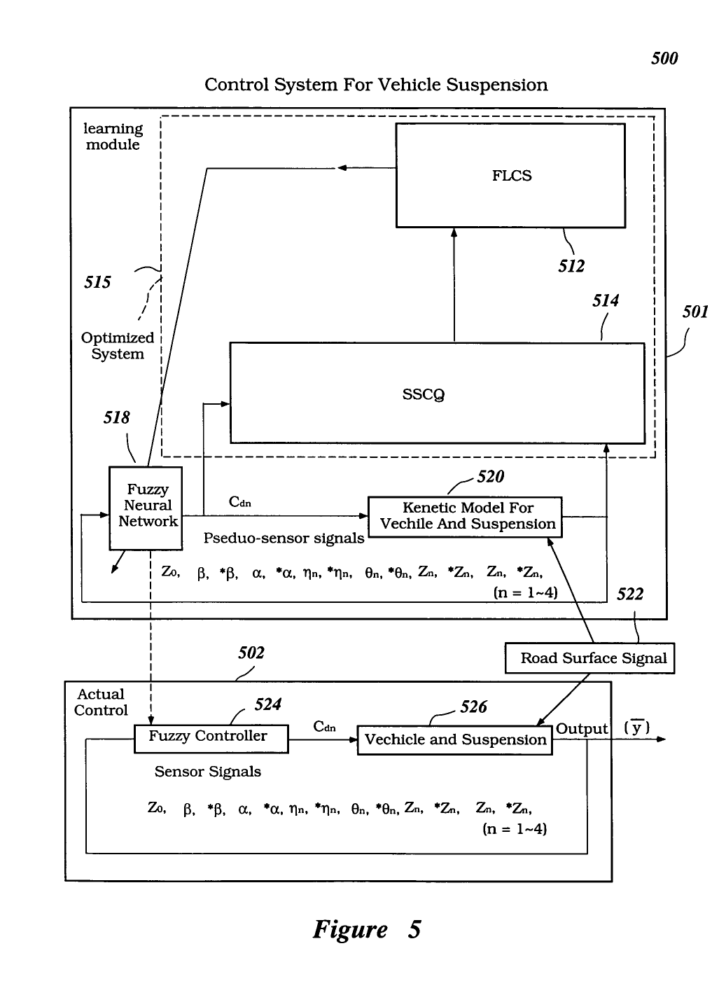

FIG. 5 is a block diagram showing how the systems of FIGS. 2-4 are used in an offline learning mode and an online control mode.

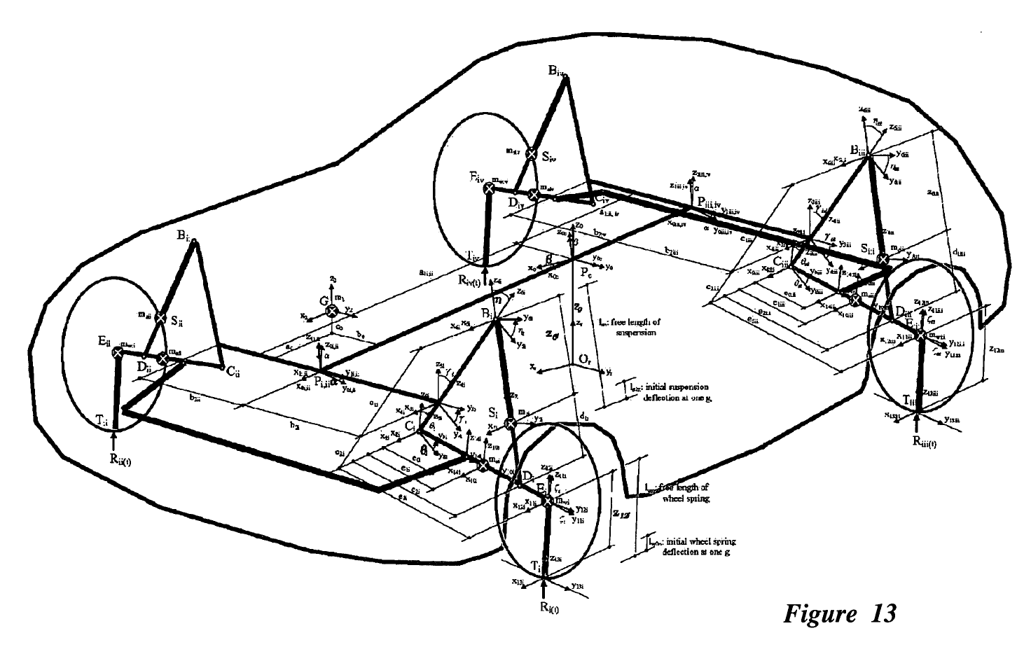

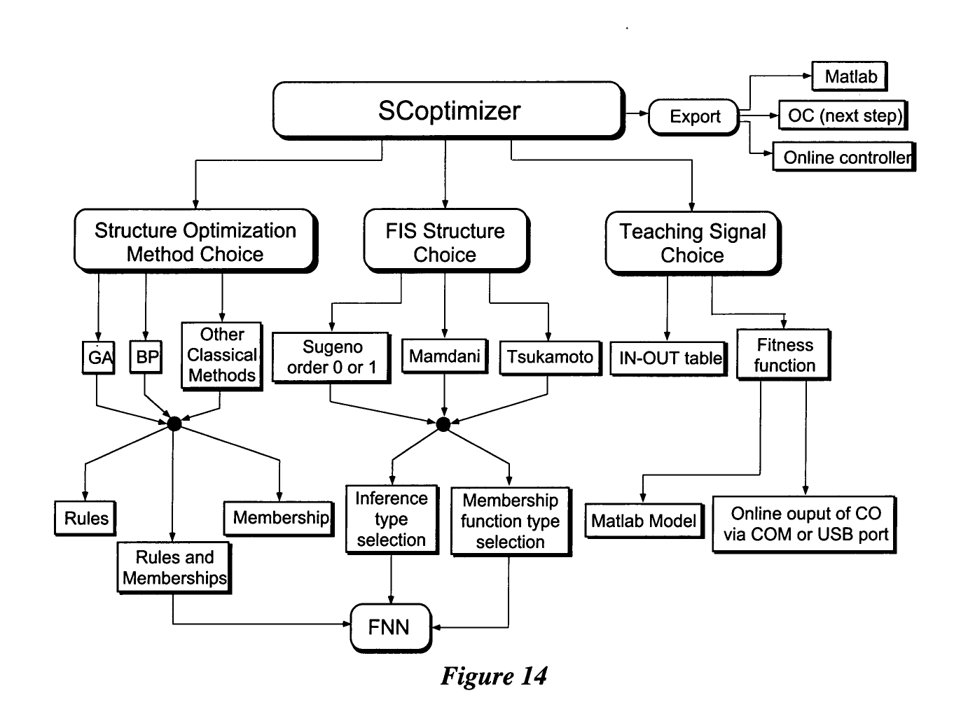

This control system 500 includes an online control module 502 in the vehicle and a learning (offline) module 501. The learning module 501 includes a learning FC 518, such as, for example, the FC systems as discussed in connection with FIG. 2-4. The learning controller can be any type of control system configured to receive a training input and adapt a control strategy using the training input. A control output from the FC 518 is provided to a control input of a kinetic model 520 and to an input of a SSCQ 514. A sensor output from the kinetic model (as described, for example, in connection with FIG. 13) is provided to a sensor input of the FC 518 and to a second input of the SSCQ 514. A training signal output from the SSCQ 514 is provided to an FLCS 512. A KB output from the FLCS 512 is provided to the FC 518.

The actual control module 502 includes a fuzzy controller 524. A control-rule output from the FC 518 is-provided to a control-rule input of the fuzzy controller 524. A sensor-data input of the online FC 524 receives sensor data from a suspension system 526. A control output from the fuzzy controller 524 is provided to a control input of the suspension system 526. A disturbance, such as a road-surface signal, is provided to a disturbance input of the kinetic model 520 and to the vehicle and suspension system 526.

The actual control module 502 is installed into a vehicle and controls the vehicle suspension system 526. The learning module 501 optimizes the actual control module 502 by using the kinetic model 520 of the vehicle and the suspension system 526. After the learning control module 501 is optimized by using a computer simulation, one or more parameters from the FC 518 are provided to the actual control module 502.

In one embodiment, a damping coefficient control-type shock absorber is employed, wherein the FC 524 outputs signals for controlling a throttle in an oil passage in one or more shock absorbers in the suspension system 526.

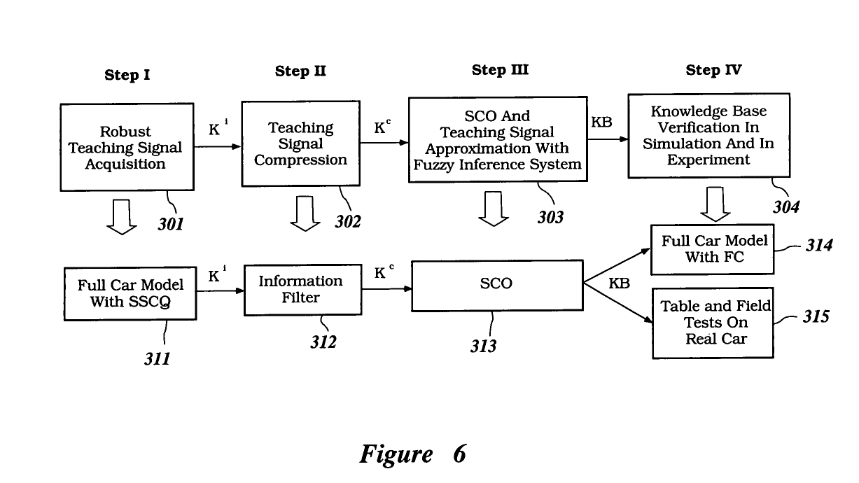

As shown in FIG. 6, realization of the structures depicted in FIGS. 2-5 is divided into four development stages. The development stages include a teaching signal acquisition stage 301, an optional teaching signal compression stage 302, a soft computing optimizer and teaching signal approximation stage 303, and a knowledge base verification stage 304.

The teaching signal acquisition stage 301 includes the acquisition of a robust teaching signal without the loss of information. In one embodiment, the stage 301 is realized using stochastic simulation of a full car with the Simulation System of Control Quality (SSCQ) under stochastic excitation of a road signal. The stage 301 is based on models of the road, of the car body, and of models of the suspension system. Since the desired suspension system control typically aims for the comfort of a human, it is also useful to develop a representation of human needs, and transfer these representations into the fitness function 132 as constraints 233.

The output of the stage 301 is a robust teaching signal Kᵢ, which contains information regarding the car behavior and corresponding behavior of the control system.

Behavior of the control system is obtained from the output of the GA 131, and behavior of the car is a response of the model for this control signal. Since the teaching signal Kᵢ is generated by a genetic algorithm, the teaching signal Kᵢ typically has some unnecessary stochastic noise in it. The stochastic noise can make it difficult to realize (or develop a good approximation for) the teaching signal Kᵢ. Accordingly, in a second stage 302, the information filter 241 is applied to the teaching signal Kᵢ to generate a compressed teaching signal K_{c}. The information filter 241 is based on a theorem of Shannon's information theory (the theorem of compression of data). The information filter 241 reduces the content of the teaching signal by removing that portion of the teaching signal Kᵢ that corresponds to unnecessary information. The output of the second stage 302 is a compressed teaching signal K_{c}.

The third stage 303 includes approximation of the compressed teaching signal K_{c} by building a Fuzzy Inference System (FIS) using a fuzzy logic classifier (FLC). Information of car behavior can be used for training an input part of the FIS, and corresponding information of controller behavior can be used for output-part training of the FIS.

The output of the third stage 303 is a knowledge base (KB) for the FC 143 obtained in such a way that it has the knowledge of car behavior and knowledge of the corresponding controller behavior with the control quality introduced as a fitness function in the first stage 301 of development. The KB is a data file containing control laws of the parameters of the fuzzy controller, such as type of membership functions, number of inputs, outputs, rule base, etc.

In the fourth stage 304, the KB can be verified in simulations and in experiments with a real car, and it is possible to check its performance by measuring parameters that have been optimized.

To summarize, the development of the KB for an intelligent control suspension system includes:

I. Obtaining a stochastic model of the road or roads.

II. Obtaining a realistic model of a car and its suspension system.

III. Development of a Simulation System of Control Quality with the car model for genetic algorithm fitness function calculation, and introduction of human needs in the fitness function.

IV. Optionally, development of the information compressor (information filter).

V. Optimization of the KB for the FC using a Soft Computing Optimizer.

VI. Approximation of the teaching signal with a fuzzy logic classifier system (FLCS) and obtaining the optimized KB for the FC.

VII. Verification of the KB in experiment and/or in simulations of the full car model with fuzzy control.

I. Obtaining Stochastic Models of the Roads

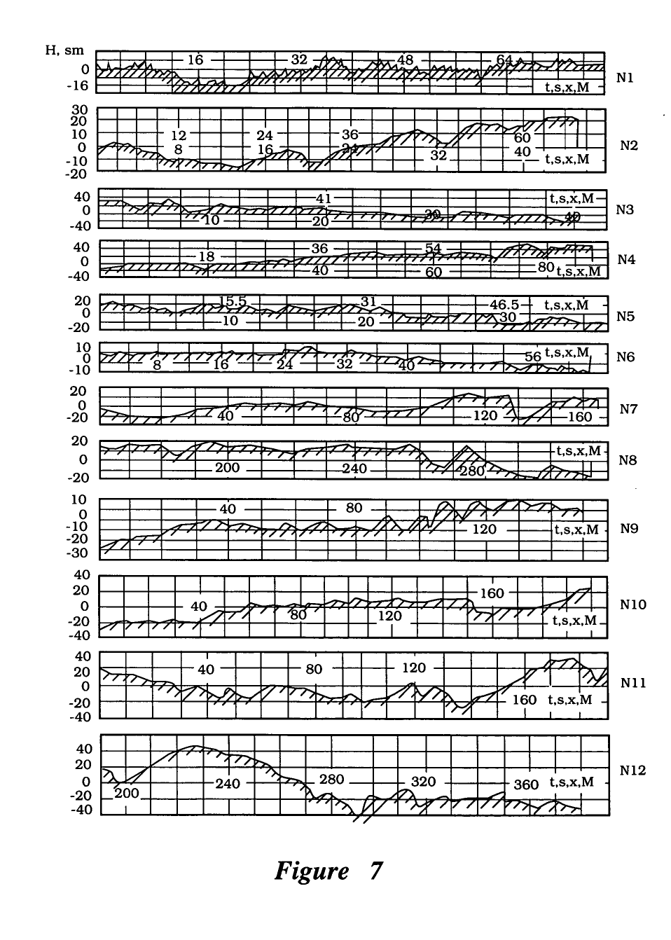

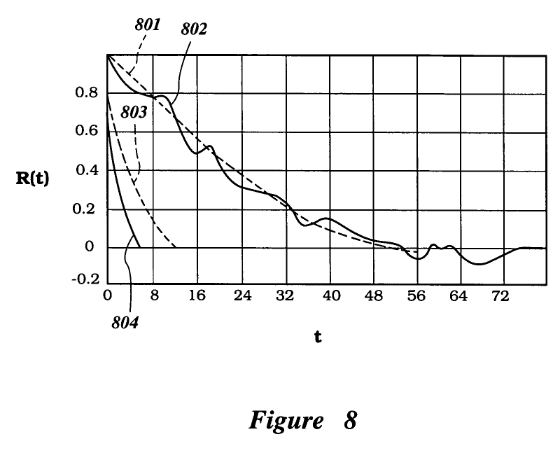

It is useful to consider different types of roads as stochastic processes with different auto-correlation functions and probability density functions. FIG. 7 shows twelve typical road profiles. Each profile shows distance along the road (on the x-axis), and altitude of the road (on the y-axis) with respect to a reference altitude. FIG. 8 shows a normalized auto-correlation function for different velocities of motion along the road number 9 (from FIG. 7). In FIG. 8, a curve 801 and a curve 802 show the normalized auto-correlation function for a velocity [symbol] =1 meter/sec, a curve 803 shows the normalized auto-correlation function for [symbol] =5 meter/sec, and a curve 804 shows the normalized auto-correlation function for [symbol] =10 meter/sec.

The results of statistical analysis of actual roads, as shown in FIG. 7, show that it is useful to consider the road signals as stochastic processes using the following three typical auto-correlation functions.
R(τ)=B(0)exp{−α₁ [symbol] |τ|}; (1.1)
R(τ)=B(0)exp{−α₁ [symbol] |τ|}cos β₁ [symbol] τ; (1.2)

$$R ( τ ) = B ( 0 ) exp \{ - {α}_{1} ϑ \vert τ \vert \} [ cos {β}_{1} ϑτ + \frac{{α}_{1}}{{β}_{1}} sin ( {β}_{1} ϑ \vert τ \vert ) ] ; \qquad ( 1.3 )$$

where α₁and β₁are the values of coefficients for single velocity of motion. The ranges of values of these coefficients are obtained from experimental data as:
α₁=0.014 to 0.111; β₁=0.025 to 0.140.

For convenience, the roads are divided into three classes:

A. \sqrt{B(0)}≦10 cm—small obstacles;

B. \sqrt{B(0)}=10 cm to 20 cm—medium obstacles;

C. \sqrt{B(0)}>20 cm—large obstacles.

The presented auto-correlation functions and its parameters are used for stochastic simulations of different types of roads using forming filters. The methodology of forming filter structure can be described according to the first type of auto-correlation functions (1.1) with different probability density functions.

Consider a stationary stochastic process X(t) defined on the interval [xₗ),Xᵣ], which can be either bounded or unbounded. Without loss of generality, assume that X(t) has a zero mean. Then xₗ<0 and xᵣ>0. With the knowledge of the probability density p(x) and the spectral density Φ_{XX}(ω) of X(t), one can establish a procedure to model the process X(t).

Let the spectral density be of the following low-pass type:

$${Φ}_{XX} ( ω ) = \frac{{ασ}^{2}}{π ( {ω}^{2} + {α}^{2} )} , α > 0 , \qquad ( 2.1 )$$

where σ² is the mean-square value of X(t). If X(t) is also a diffusive Markov process, then it is governed by the following stochastic differential equation in the Ito sense:
dX=−αXdt+D(X)dB(t), (2.2)

where α is the same parameter in (2.1), B(t) is a unit Wiener process, and the coefficients−αX and D(X) are known as drift and the diffusion coefficients, respectively. To demonstrate that this is the case, multiply (2.2) by X(t−τ) and take the ensemble average to yield

$$\frac{ⅆ R ( τ )}{ⅆ τ} = - α R ( τ ) , \qquad ( 2.3 )$$

where R(τ) is the correlation function of X(t), namely, R(τ)=E[X(t−τ)X(t)]. Equation (2.3) has a solution
R(τ)=Aexp(−α|τ|) (2.4)

in which A is arbitrary. By choosing A=σ², equations (2.1) and (2.4) become a Fourier transform pair. Thus equation (2.2) generates a process X(t) with a spectral density (2.1). Note that the diffusion coefficient D(X) has no influence on the spectral density.

Now it is useful to determine D(X) so that X(t) possesses a given stationary probability density p(x). The Fokker-Planck equation, governing the probability density p(x) of X(t) in the stationary state, is obtained from equation (2.2) as follows:

$$\frac{ⅆ}{ⅆ x} G = - \frac{ⅆ}{ⅆ x} \{ α xp ( x ) + \frac{1}{2} \frac{ⅆ}{ⅆ x} [ {D}^{2} ( x ) p ( x ) ] \} = 0 , \qquad ( 2.5 )$$

where G is known as the probability flow. Since X(t) is defined on [xₗ,xᵣ], G must vanish at the two boundaries x=xₗ and x=xᵣ. In the present one-dimensional case, G must vanish everywhere; consequently, equation (2.5) reduces to

$$α xp ( x ) + \frac{1}{2} \frac{ⅆ}{ⅆ x} [ {D}^{2} ( x ) p ( x ) ] = 0. \qquad ( 2.6 )$$

Integration of equation (2.6) results in

$${D}^{2} ( x ) p ( x ) = - 2 α {\int }_{{x}_{l}}^{{x}_{r}} up ( u ) ⅆ u + C , \qquad ( 2.7 )$$

where C is an integration constant. To determine the integration constant C, two cases are considered. For the first case, if xₗ=−∞,or xᵣ=∞, or both, then p(x) must vanish at the infinite boundary; thus C=0 from equation (2.7). For the second case, if both xₗ and Xᵣ are finite, then the drift coefficient −αxₗ at the left boundary is positive, and the drift coefficient −αxᵣ at the right boundary is negative, indicating that the average probability flows at the two boundaries are directed inward. However, the existence of a stationary probability density implies that all sample functions must remain within [xₗ,xᵣ], which requires additionally that the drift coefficient vanish at the two boundaries, namely, D²(xₗ)=D²(xᵣ)=0. This is satisfied only if C=0. In either case,

$${D}^{2} ( x ) = - \frac{2 α}{p ( x )} {\int }_{{x}_{l}}^{{x}_{r}} up ( u ) ⅆ u . \qquad ( 2.8 )$$

Function D²(x), computed from equation (2.8), is non-negative, as it should be, since p(x)≧0 and the mean value of X(t) is zero. Thus the stochastic process X(t) generated from (2.2) with D(x) given by (2.8) possesses a given stationary probability density p(x) and the spectral density (2.1).

The Ito type stochastic differential equation (2.2) may be converted to that of the Stratonovich type:

$$\dot{X} = - α X - \frac{1}{4} \frac{ⅆ {D}^{2} ( X )}{ⅆ X} + \frac{D ( X )}{\sqrt{2 π}} ξ ( t ) , \qquad ( 2.9 )$$

where ξ(t) is a Gaussian white noise with a unit spectral density. Equation (2.9) is better suited for simulating sample functions. Some illustrative examples are given below.

Example 1: Assume that X(t) is uniformly distributed, namely,

$$p ( x ) = \frac{1}{2 Δ} , - Δ \leq x \leq Δ . \qquad ( 2.10 )$$

Substituting (2.10) into (2.8)
D²(X)=α(Δ²−X²). (2.11)

In this case, the desired Ito equation is given by
dX=−αXdt+\sqrt{αβ(Δ²−X²)}dB(t). (2.12)

It is of interest to note that a family of stochastic processes can be obtained from the following generalized version of (2.12):
dX=−αXdt+\sqrt{αβ(Δ²−X²)}dB(t). (2.13)

Their appearances are strikingly diverse, yet they share the same spectral density (2.1).

Example 2: Let X(t) be governed by a Rayleigh distribution
p(x)=γ²x exp(−γx), γ>0,0≦x <∞. (2.14)

Its centralized version Y(t)=X(t)−2/γ has a probability density
p(y)=γ(γy+2)exp(−γy+2), −2/γ≦y∞. (2.15)

From equation (2.8),

$${D}^{2} ( y ) = \frac{2 α}{γ} ( y + \frac{2}{γ} ) . \qquad ( 2.16 )$$

The Ito equation for Y(t) is

$$dY = - α Ydt + {[ \frac{2 α}{γ} ( Y + \frac{2}{γ} ) ]}^{1 / 2} dB ( t ) \qquad ( 2.17 )$$

and the correspondence equation for X(t) in the Stratonovich form is

$$\dot{X} = - α X + \frac{3 α}{2 γ} + {( \frac{α}{πγ} X )}^{1 / 2} ξ ( t ) . \qquad ( 2.18 )$$

Note that the spectral density of X(t) contains a delta function (4/γ²)δ(ω) due to the nonzero mean 2/γ.

Example 3: Consider a family of probability densities, which obeys an equation of the form

$$\frac{ⅆ}{ⅆ x} p ( x ) = J ( x ) p ( x ) . \qquad ( 2.19 )$$

Equation (2.19) can be integrated to yield
p(x)=C₁ exp(∫J(x)dx) (2.20)

where C₁ is a normalization constant. In this case
D²(x)=−2α exp[−J(x)]∫x exp[J(x)]dx. (2.21)

Several special cases may be noted. Let
J(x)=−γx²−δx⁴, −∞<X<∞ (2.22)

where γ can be arbitrary if δ>0. Substitution of equation (2.22) into equation (2.8) leads to

$${D}^{2} ( x ) = \frac{α}{2} \sqrt{π / δ} exp [ {δ ( {x}^{2} + \frac{γ}{2 δ} )}^{2} ] erfc [ \sqrt{δ} ( {x}^{2} + \frac{γ}{2 δ} ) ] \qquad ( 2.23 )$$

where erfc(y) is the complementary error function defined as

$$erf c ( y ) = \frac{2}{\sqrt{π}} {\int }_{y}^{∞} {ⅇ}^{- {t}^{2}} ⅆ t . \qquad ( 2.24 )$$

The case of γ<0 and δ>0 corresponds to a bimodal distribution, and the case of γ>0 and δ=0 corresponds to a Gaussian distribution.

The Pearson family of probability distributions corresponds to

$$J ( x ) = \frac{{a}_{1} x + {a}_{0}}{{b}_{2} {x}^{2} + {b}_{1} x + {b}_{0}} \qquad ( 2.25 )$$

In the special case of a₀+b₁=0,

$${D}^{2} ( x ) = - \frac{2 α}{{a}_{1} + {b}_{2}} ( {b}_{2} {x}^{2} + {b}_{1} x + {b}_{0} ) . \qquad ( 2.26 )$$

From the results of statistical analysis of forming filters with auto-correlation function (1.1) one can describe typical structure of forming filters as in Table 1:

TABLE 1
The Structures of Forming Filters for Typical Probability Density
Functions p(x)

| | Probability | |
|---|---|---|
| Auto-correlation | density | |
| function | function | Forming filter structure |
| ${R}_{y} ( τ ) = {σ}^{2} {ⅇ}^{- α \vert τ \vert}$ | Gaussian | $\dot{y} + α y = {σ}^{2} ξ ( t )$ |
| ${R}_{y} ( τ ) = {σ}^{2} {ⅇ}^{- α \vert τ \vert}$ | Uniform | $\dot{y} + \frac{α}{2} y = \frac{{α}^{2}}{\sqrt{2 π}} \sqrt{α ( {Δ}^{2} - {y}^{2} )} ξ ( t )$ |
| ${R}_{y} ( τ ) = {σ}^{2} {ⅇ}^{- α \vert τ \vert}$ | Rayleigh | $\dot{y} + αy \pm \frac{2 α}{γ} = \frac{{σ}^{2}}{\sqrt{2 π}} \sqrt{\frac{2 α}{γ} ( y + \frac{2}{γ} )} ξ ( t )$ |
| ${R}_{y} ( τ ) = {σ}^{2} {ⅇ}^{- α \vert τ \vert}$ | Pearson | $\dot{y} + αy + \frac{α}{{a}_{1} + 2 {b}_{2}} ( {b}_{2} x + {b}_{1} ) = \\ \frac{{σ}^{2}}{\sqrt{2 π}} \sqrt{\frac{2 α}{{a}_{1} + 2 {b}_{2}} ( {b}_{2} {y}^{2} + {b}_{1} y + {b}_{0} )} ξ ( t )$ |

The structure of a forming filter with an auto-correlation function given by equations (1.2) and (1.3) is derived as follows. A two-dimensional (2D) system is used to generate a narrow-band stochastic process with the spectrum peak located at a nonzero frequency. The following pair of Ito equations describes a large class of 2D systems:
dx₁=(a₁₁x₁+a₁₂x₂)dt+D₁(X₁,X₂)dB₁(t), dx₂=(a₂₁x₁+a₂₂x₂)dt+D₂(x₁,x₂)dB₂(t), (3.1)

where Bᵢ, i=1,2 are two independent unit Wiener processes.

For a system to be stable and to possess a stationary probability density, is required that a₁₁<0, a₂₂<0 and a₁₁a₂₂−a₁₂a₂₁>0. Multiplying (3.1) by x₁(t−τ) and taking the ensemble average, gives

$$\frac{ⅆ}{ⅆ τ} {R}_{11} ( τ ) = {a}_{11} {R}_{11} ( τ ) + {a}_{12} {R}_{12} ( τ ) \\ \frac{ⅆ}{ⅆ τ} {R}_{12} ( τ ) = {a}_{21} {R}_{11} ( τ ) + {a}_{22} {R}_{12} ( τ ) \qquad ( 3.2 )$$

where R₁₁(τ)=M[x₁(t−τ)x₁(t)], R₁₂(τ)=M[x₁(t−τ)x₂(t)] with initial conditions R₁₁(0)=m₁₁=M[x₁²], R₁₂(0)=m₁₂=M[X₁X₂].

Differential equations (3.2) in the time domain can be transformed (using the Fourier transform) into algebraic equations in the frequency domain as follows

$$ⅈω {\overline{R}}_{11} - \frac{{m}_{11}}{π} = {a}_{11} {\overline{R}}_{11} + {a}_{12} {\overline{R}}_{12} \\ ⅈω {\overline{R}}_{12} - \frac{{m}_{12}}{π} = {a}_{21} {\overline{R}}_{11} + {a}_{22} {\overline{R}}_{12} , \qquad ( 3.3 )$$

where \overline{R}ᵢⱼ(ω) define the following integral Fourier transformation:

$${\overline{R}}_{ij} ( ω ) = Θ [ {\overline{R}}_{ij} ( τ ) ] = \frac{1}{π} {\int }_{0}^{∞} {R}_{ij} ( τ ) {ⅇ}^{- ⅈωτ} ⅆ τ .$$

Then the spectral density S₁₁(ω) of x₁(t) can be obtained as

$${S}_{11} ( ω ) = \frac{1}{2 π} {\int }_{- ∞}^{∞} {R}_{11} ( τ ) {ⅇ}^{- ⅈωτ} ⅆ τ = Re [ {\overline{R}}_{11} ( ω ) ] , \qquad ( 3.4 )$$

where Re denotes the real part.

Since Rᵢⱼ(τ)→0 as τ→∞, it can be shown that

$$Θ ( \frac{ⅆ {R}_{ij} ( τ )}{ⅆ τ} ) = ⅈω {\overline{R}}_{ij} ( ω ) - \frac{1}{π} {R}_{ij} ( 0 )$$

and equation (3.3) is obtained using this relation.

Solving equation (3.3) for \overline{R}ᵢⱼ(ω) and taking its real part, gives

$${S}_{11} ( ω ) = \frac{- ( {a}_{11} {m}_{11} + {a}_{12} {m}_{12} ) {ω}^{2} + {A}_{2} ( {a}_{12} {m}_{12} - {a}_{22} {m}_{11} )}{π [ {ω}^{4} + ( {A}_{1}^{2} - 2 {A}_{2} ) {ω}^{2} + {A}_{2}^{2} ]} , \qquad ( 3.5 )$$

where A₁=a₁₁+a₂₂, and A₂=a₁₁a₂₂−a₁₂a₂₁.

Expression (3.5) is the general expression for a narrow-band spectral density. The constants aᵢⱼ, i, j=1,2, can be adjusted to obtain a best fit for a target spectrum. The task is to determine non-negative functions D₁²(x₁,x₂) and D₂²(x₁,x₂) for a given p(x₁,x₂).

Forming filters for simulation of non-Gaussian stochastic processes can be derived as follows. The Fokker-Planck-Kolmogorov (FPK) equation for the joint density p(x₁,x₂) of x₁(t) and x₂(t) in the stationary state is given as

$$\frac{\partial }{{x}_{1}} ( ( {a}_{11} {x}_{1} + {a}_{12} {x}_{2} ) p - \frac{1}{2} \frac{\partial }{{x}_{1}} [ {D}_{1}^{2} ( {x}_{1} , {x}_{2} ) p ] ) + \frac{\partial }{{x}_{2}} ( ( {a}_{21} {x}_{1} + {a}_{22} {x}_{2} ) p - \frac{1}{2} \frac{\partial }{{x}_{2}} [ {D}_{2}^{2} ( {x}_{1} , {x}_{2} ) p ] ) = 0$$

If such D₁²(x₁,x₂) and D₂²(x₁,x₂) functions can be found, then the equations of forming filters for the simulation in the Stratonovich form are given by

$${\dot{x}}_{1} = {a}_{11} {x}_{1} + {a}_{12} {x}_{2} - \frac{1}{4} \frac{\partial }{{x}_{1}} {D}_{1}^{2} ( {x}_{1} , {x}_{2} ) + \frac{{D}_{1} ( {x}_{1} , {x}_{2} )}{\sqrt{2 π}} {ξ}_{1} ( t ) , \\ {\dot{x}}_{2} = {a}_{21} {x}_{1} + {a}_{22} {x}_{2} - \frac{1}{4} \frac{\partial }{{x}_{2}} {D}_{2}^{2} ( {x}_{1} , {x}_{2} ) + \frac{{D}_{2} ( {x}_{1} , {x}_{2} )}{\sqrt{2 π}} {ξ}_{2} ( t ) , \qquad ( 3.6 )$$

(3.6)

where ξᵢ(t),i=1,2, are two independent unit Gaussian white noises.

Filters (3.1) and (3.6) are non-linear filters for simulation of non-Gaussian random processes. Two typical examples are provided.

Example 1: Consider two independent uniformly distributed stochastic process x₁ and X₂, namely,

$$p ( {x}_{1} , {x}_{2} ) = \frac{1}{4 {Δ}_{1} {Δ}_{2}} , - {Δ}_{1} \leq {x}_{1} \leq {Δ}_{1} , - {Δ}_{2} \leq {x}_{2} \leq {Δ}_{2} .$$

Δ₁≦X₁≦Δ₁, −Δ₂≦x₂≦Δ₂.

In this case, from the FPK equation, one obtains

$${a}_{11} - \frac{1}{2} \frac{{\partial }^{2}}{{x}_{1}^{2}} {D}_{1}^{2} + {a}_{21} - \frac{1}{2} \frac{{\partial }^{2}}{{x}_{2}^{2}} {D}_{2}^{2} = 0 ,$$

which is satisfied if
D₁²=−a₁₁(Δ₁−x₁²), D₁²=−a₂₂(Δ₂−x₂^{2).}

The two non-linear equations in (3.6) are now

$${\dot{x}}_{1} = \frac{1}{2} {a}_{11} {x}_{1} + {a}_{12} {x}_{2} + \sqrt{- \frac{{a}_{11}}{2 π} ( {Δ}_{1} - {x}_{1}^{2} )} {ξ}_{1} ( t ) \\ {\dot{x}}_{2} = \frac{1}{2} {a}_{22} {x}_{1} + {a}_{21} {x}_{2} + \sqrt{- \frac{{a}_{22}}{2 π} ( {Δ}_{2} - {x}_{2}^{2} )} {ξ}_{2} ( t ) , \qquad ( 3.7 )$$

which generate a uniformly distributed stochastic process x₁(t) with a spectral density given by (3.5).

Example 2: Consider a joint stationary probability density of x₁(t) and x₂(t) in the form

$$p ( {x}_{1} , {x}_{2} ) = ρ ( λ ) = {{C}_{1} ( λ + b )}^{- δ} , b > 0 , δ > 1 , \\ and$$

$$λ = \frac{1}{2} {x}_{1}^{2} - \frac{{a}_{12}}{2 {a}_{21}} {x}_{2}^{2} .$$

A large class of probability densities can be fitted in this form. In this case

$${D}_{1} ( {x}_{1} , {x}_{2} ) = - \frac{2 {a}_{11}}{δ - 1} ( λ + b ) , {D}_{2} ( {x}_{1} , {x}_{2} ) = \frac{2 {a}_{11} {a}_{12}}{{a}_{21} ( δ - 1 )} ( λ + b )$$

$$and$$

$$p ( {x}_{1} ) = {C}_{1} {\int }_{- ∞}^{∞} {( \frac{1}{2} {x}_{1}^{2} - \frac{{a}_{12}}{2 {a}_{21}} {u}^{2} + b )}^{δ} ⅆ u .$$

The forming filter equations (3.6) for this case can be described as following

$${\dot{x}}_{1} = {a}_{11} {x}_{1} + {a}_{12} {x}_{2} - \frac{2 {a}_{11}^{2}}{{( δ - 1 )}^{2}} [ \frac{1}{2} {x}_{1}^{2} - \frac{{a}_{12}}{2 {a}_{21}} {x}_{2}^{2} + b ] {x}_{1} - \frac{2 {a}_{11}}{\sqrt{2 π ( δ - 1 )}} \cdot \cdot [ \frac{1}{2} {x}_{1}^{2} - \frac{{a}_{12}}{2 {a}_{21}} {x}_{2}^{2} + b ] {ξ}_{1} ( t ) \\ {\dot{x}}_{2} = {a}_{21} {x}_{1} + {a}_{22} {x}_{2} + \frac{2 {a}_{22}^{2} {a}_{12}^{3}}{{( δ - 1 )}^{2}} [ \frac{1}{2} {x}_{1}^{2} - \frac{{a}_{12}}{2 {a}_{21}} {x}_{2}^{2} + b ] {x}_{2} + \frac{2 {a}_{22} {a}_{12}}{\sqrt{2 π ( δ - 1 )}} \cdot \cdot [ \frac{1}{2} {x}_{1}^{2} - \frac{{a}_{12}}{2 {a}_{21}} {x}_{2}^{2} + b ] {ξ}_{2} ( t ) \qquad ( 3.8 )$$

If σᵢₖ(x,t) are bounded functions and the functions Fᵢ(x,t) satisfy the Lipshitz condition ∥F(X′−x∥≦K∥x′−x∥, K=const >0, then for every smoothly-varying realization of process y(t) the stochastic equations can be solved by the method of successive substitution which is convergent and defines smoothly-varying trajectories x(t). Thus, Markovian process x(t) has smoothly trajectories with the probability 1. This result can be used as a background in numerical stochastic simulation.

The stochastic differential equation for the variable xᵢ is given by

$$\frac{ⅆ {x}_{i}}{ⅆ t} = {F}_{i} ( x ) + {G}_{i} ( x ) {ξ}_{i} ( t ) , i = 1 , 2 , … , N , \\ x = ( {x}_{1} , {x}_{2} , … , {x}_{N} ) . \qquad ( 4.1 )$$

These equations can be integrated using two different algorithms: Milshtein; and Heun methods. In the Milshtein method, the solution of stochastic differential equation (4.1) is computed by means of the following recursive relations:

$${x}_{i} ( t + δ t ) = [ {F}_{i} ( x ( t ) ) + \frac{{σ}^{2}}{2} {G}_{i} ( x ( t ) ) \frac{ⅆ {G}_{i} ( x ( t ) )}{ⅆ {x}_{i}} ] δ t + {G}_{i} ( x ( t ) ) \sqrt{{σ}^{2} δ t} {η}_{i} ( t ) , \qquad ( 4.2 )$$

where ηᵢ(t) are independent Gaussian random variables and the variance is equal to 1.

The second term in equation (4.2) is included because equation (4.2) is interpreted in the Stratonovich sense. The order of numerical error in the Milshtein method is δt. Therefore, small δt (i.e., δt=1×10⁻⁴ for σ=1) is to be used, while its computational effort per time step is relatively small. For large σ, where fluctuations are rapid and large, a longer integration period and small δt is used. The Milshtein method quickly becomes impractical.

The Heun method is based on the second-order Runge-Kutta method, and integrates the stochastic equation by using the following recursive equation:

$${x}_{i} ( t + δ t ) = {x}_{i} ( t ) + \frac{δ t}{2} [ {F}_{i} ( x ( t ) ) + {F}_{i} ( y ( t ) ) ] + \frac{\sqrt{{σ}^{2} δ t}}{2} {η}_{i} ( t ) [ {G}_{i} ( x ( t ) ) + {G}_{i} ( y ( t ) ) ] , \\ where \\ {y}_{i} ( t ) = {x}_{i} ( t ) + F ( {x}_{i} ( t ) ) δ t + G ( {x}_{i} ( t ) ) \sqrt{{σ}^{2} δ t} {η}_{i} ( t ) . \qquad ( 4.3 )$$

The Heun method accepts larger δt than the Milshtein method without a significant increase in computational effort per step. The Heun method is usually used for σ²>2.

The time step δt can be chosen by using a stability condition, and so that averaged magnitudes do not depend on δt within statistical errors. For example, δt=5×10⁻⁴ for σ²=1 and δt=1×10⁻⁵ for σ²=15. The Gaussian random numbers for the simulation were generated by using the Box-Muller-Wiener algorithms or a fast numerical inversion method.

Table 2 summarizes the stochastic simulation of typical road signals.

TABLE 2

| Types of Correlation | Type of Probability | |
|---|---|---|
| Function | Density Function | Forming Filter Function |
| R(τ) = σ²e^{-α\|τ\|} | 1D Gaussian $p ( y ) = \frac{1}{σ \sqrt{2 π}} {e}^{\frac{1}{2} {( \frac{y - μ}{σ} )}^{2}}$ | \dot{y} + αy = σ²ξ(t) |
| | 1D Uniform $p ( y ) = \{ \begin{matrix}0 , & y ε [ {y}_{0} - {Δy}_{0} + Δ ] \\ \frac{1}{2 Δ} , & y ε [ {y}_{0} - {Δy}_{0} + Δ ]\end{matrix}$ | $\dot{y} + \frac{α}{2} y = \frac{{σ}^{2}}{2 π} \sqrt{α ( {Δ}^{2} - {y}^{2} )} ξ ( t )$ |
| | 1D Rayleigh $p ( y ) = \frac{y}{{μ}^{2}} {e}^{- ( \frac{{y}^{2}}{2 {μ}^{2}} )}$ | $\dot{y} + \frac{α}{2} y + \frac{2 α}{μ} = \frac{{σ}^{2}}{\sqrt{2 π}} \sqrt{\frac{2 α}{μ} ( y + \frac{2}{μ} )} ξ ( t )$ |
| R(τ) =σ²e^{-α\|τ\|} ${\dot{y}}_{1} = {α}_{11} {y}_{1} + {α}_{12} {y}_{2} \frac{2 {α}_{11}^{2}}{{( δ - 1 )}^{2}} [ \frac{1}{2} {y}_{1}^{2} \frac{{α}_{12}}{2 {α}_{21}} {y}_{2}^{2} + b ] {y}_{1}$ $\frac{2 {α}_{11}}{\sqrt{2 π} ( δ - 1 )} [ \frac{1}{2} {y}_{1}^{2} \frac{{α}_{12}}{2 {α}_{21}} {y}_{2}^{2} + b ] ξ ( t )$ ${\dot{y}}_{2} = {α}_{21} {y}_{1} + {α}_{22} {y}_{2} \frac{2 {α}_{22}^{2} {α}_{12}^{3}}{{{α}_{21}^{3} ( δ - 1 )}^{2}} [ \frac{1}{2} {y}_{1}^{2} \frac{{α}_{12}}{2 {α}_{21}} {y}_{2}^{2} + b ] {y}_{2} \\ + \frac{2 {α}_{22} {α}_{2}}{\sqrt{2 {πα}_{21}} ( δ - 1 )} [ \frac{1}{2} {y}_{1}^{2} \frac{{α}_{12}}{2 {α}_{21}} {y}_{2}^{2} + b ] ξ ( t )$ | 2D Gaussian $\frac{1}{2 {πqσ}_{2}} {e}^{\frac{1}{3} ( {( \frac{{y}_{1} - {μ}_{1}}{{σ}_{1}} )}^{2} + {( \frac{{y}_{2} - {μ}_{2}}{{σ}_{2}} )}^{2} )}$ | $\ddot{y} + 2 α \dot{y} + ( {α}^{2} + {ω}^{2} ) y = \sqrt{2 {ασ}^{2} ( {α}^{2} + {ω}^{2} )} ξ ( t )$ |
| | 2D Uniform $p ( {y}_{1} , {y}_{2} ) = \frac{1}{4 {Δ}_{1} {Δ}_{2}}$ −Δ₁>y₁<Δ₁−Δ₂<y₂<Δ₂ | ${\dot{y}}_{1} = \frac{1}{2} {α}_{11} {y}_{1} + {α}_{12} {y}_{2} + \sqrt{( - \frac{{α}_{11}}{2 π} ( {Δ}_{1} {y}_{1}^{2} ) )} {ξ}_{1} ( t )$ ${{y}^{.} }_{2} = \frac{1}{2} {α}_{12} {y}_{2} + {α}_{21} {y}_{1} + \sqrt{( - \frac{{α}_{21}}{2 π} ( {Δ}_{2} {y}_{2}^{2} ) )} {ξ}_{2} ( t )$ |
| | 2D Hyperbolic p(y₁, y₂) =ρ(λ) = C₁(λ + b)^{-b}b > 0; δ > 1 $λ = \frac{1}{2} {y}_{1}^{2} - \frac{{θ}_{t2}}{2 {θ}_{t2}} {y}_{2}^{2}$ | $[ cosωτ + \frac{α}{ω} sinω \vert τ \vert ]$ |

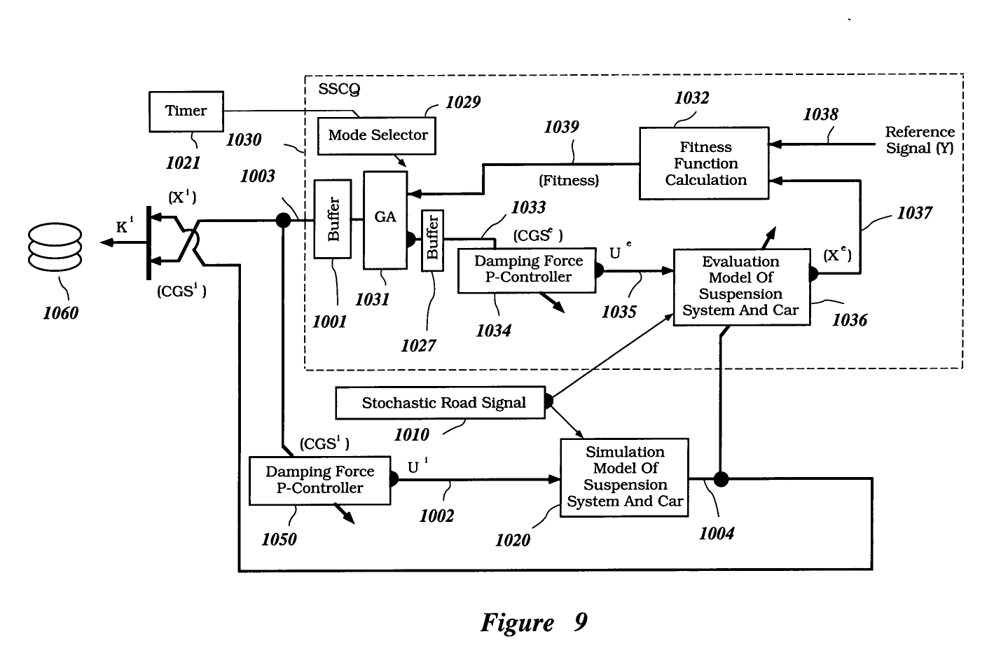

FIG. 9 shows the structure of an SSCQ 1030 for use in connection with a simulation model of the full car and suspension system. The SSCQ 1030 is one embodiment of the SSCQ 130 (shown in FIG. 3). In addition to the SSCQ 1030, FIG. 9 also shows a stochastic road signal generator 1010, a suspension system simulation model 1020, a proportional damping force controller 1050, and a timer 1021. The SSCQ 1030 includes a mode selector 1029, an output buffer 1001, a GA 1031, a buffer 1027, a proportional damping force controller 1034, a fitness function calculator 1032, and an evaluation model 1036.

The Timer 1021 controls the activation moments of the SSCQ 1030. An output of the timer 1021 is provided to an input of the mode selector 1029. The mode selector 1029 controls operational modes of the SSCQ 1030. In the SSCQ 1030, a reference signal y is provided to a first input of the fitness function calculator 1032. An output of the fitness function calculator 1032 is provided to an input of the GA 1031. A CGS^{e} output of the GA 1031 is provided to a training input of the damping force controller 1034 through the buffer 1027. An output of the damping force controller 1034 is provided to an input of the evaluation model 1036. An X^{e} output of the evaluation model 1036 is provided to a second input of the fitness function calculator 1032. A CGSⁱ output of the GA 1031 is provided (through the buffer 1001) to a training input of the damping force controller 1050. A control output from the damping force controller 1050 is provided to a control input of the suspension system simulation model 1020. The stochastic road signal generator 1010 provides a stochastic road signal to a disturbance input of the suspension system simulation model 1020 and to a disturbance input of the evaluation model 1036. A response output Xⁱ from the suspension system simulation model 1020 is provided to a training input of the evaluation model 1036. The output vector Kⁱ from the SSCQ 1030 is obtained by combining the CGSⁱ output from the GA 1031 (through the buffer 1001) and the response signal Xⁱ from the suspension system simulation model 1020.

The road signal generator 1010 generates a road profile. The road profile can be generated from stochastic simulations as described above, or the road profile can be generated from measured road data. The road signal generator 1010 generates a road signal for each time instant (e.g., each clock cycle) generated by the timer 1021.

The simulation model 1020 is a kinetic model of the full car and suspension system with equations of motion, as obtained, for example, in connection with FIG. 13 below. In one embodiment, the simulation model 1020 is integrated using high-precision order differential equation solvers.

The SSCQ 1030 is an optimization module that operates on a discrete time basis. In one embodiment, the sampling time of the SSCQ 1030 is the same as the sampling time of the control system 1050. Entropy production rate is calculated by the evaluation model 1036, and the entropy values are included into the output (X^{e}) of the evaluation model 1036.

The following designations regarding time moments are used herein:

T=Moments of SSCQ calls

T_{c}=the sampling time of the control system 1050

Tₑ=the evaluation (observation) time of the SSCQ 1030

t_{c}=the integration interval of the simulation model 1020 with fixed control parameters, t_{c}∈[T;T+T_{c}]

tₑ=Evaluation (Observation) time interval of the SSCQ, t_{c}∈[T;T+Tₑ]

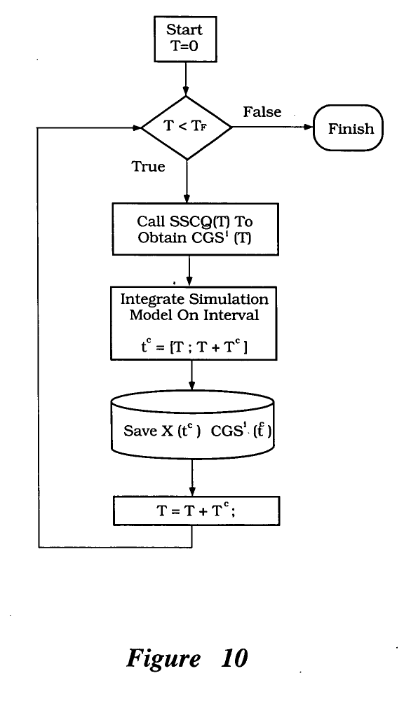

FIG. 10 is a flowchart showing operation of the SSCQ 1030 as follows:

1. At the initial moment (T=0) the SSCQ 1030 is activated and the SSCQ 1030 generates the initial control signal CGSⁱ(T).

2. The simulation model 1020 is integrated using the road signal from the stochastic road generator 1010 and the control signal CGSⁱ(T) on a first time interval t_{c} to generate the output Xⁱ.

3. The output Xⁱ and with the output CGSⁱ(T) are is saved into the data file 1060 as a teaching signal Kⁱ.

4. The time interval T is incremented by T_{c}(T=T+T_{c}).

5. The sequence 1-4 is repeated a desired number of times (that is while T<T_{F}). In one embodiment, the sequence 1-4 is repeated until the end of road signal is reached

Regarding step 1 above, the SSCQ 1030 has two operating modes:
1. Updating of the buffer 1001 using the GA 1031
2. Extraction of the output CGSⁱ(T) from the buffer 1001.

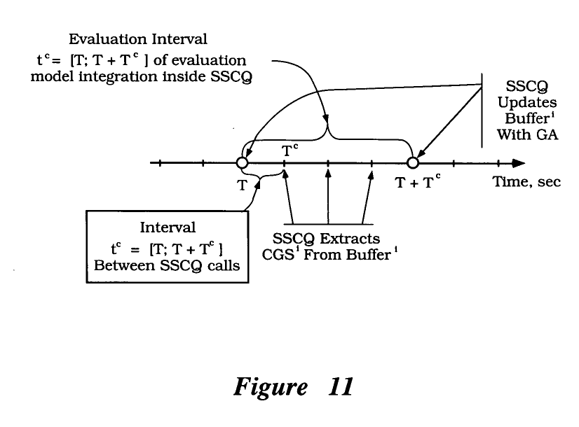

The operating mode of the SSCQ 1030 is controlled by the mode selector 1029 using information regarding the current time moment T, as shown in FIG. 11. At intervals of Tₑ the SSCQ 1030 updates the output buffer 1001 with results from the GA 1031. During the interval Tₑ at each interval T_{c}, the SSCQ extracts the vector CGSⁱ from the output buffer 1001.

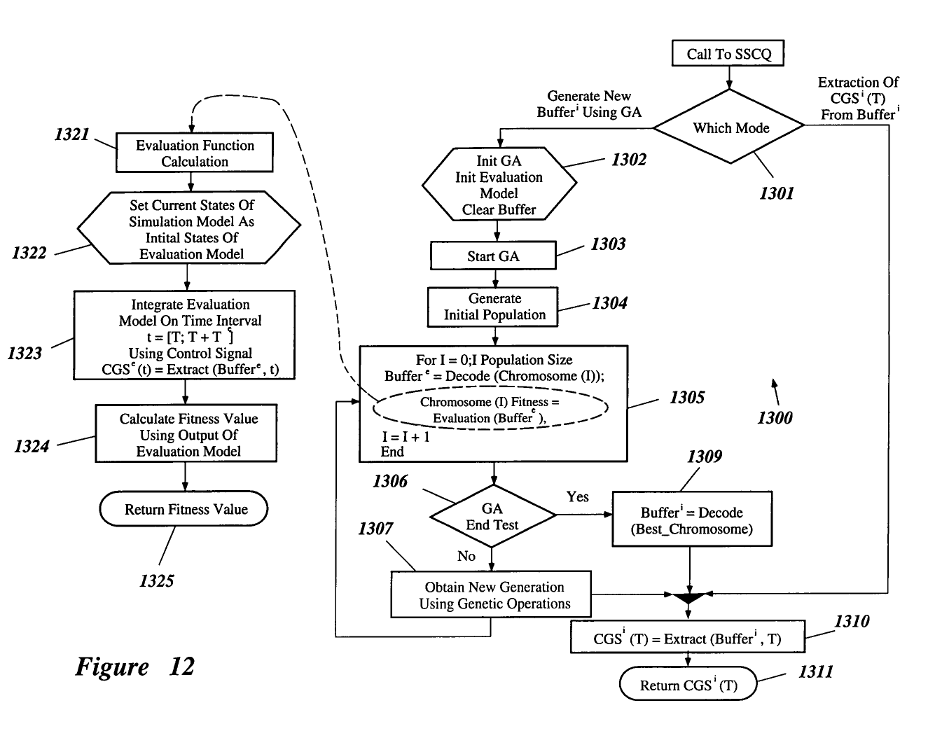

FIG. 12 is a flowchart 1300 showing operation of the SSCQ 1030 in connection with the GA 1031 to compute the control signal CGSⁱ. The flowchart 1300 begins at a decision block 1301, where the operating mode of the SSCQ 1030 is determined. If the operating mode is a GA mode, then the process advances to a step 1302; otherwise, the process advances to a step 1310. In the step 1302, the GA 1031 is initialized, the evaluation model 1036 is initialized, the output buffer 1001 is cleared, and the process advances to a step 1303. In the step 1303, the GA 1031 is started, and the process advances to a step 1304 where an initial population of chromosomes is generated. The process then advances to a step 1305 where a fitness value is assigned to each chromosome. The process of assigning a fitness value to each chromosome is shown in an evaluation function calculation, shown as a sub-flowchart having steps 1322-1325. In the step 1322, the current states of Xⁱ(T) are initialized as initial states of the evaluation model 1036, and the current chromosome is decoded and stored in the evaluation buffer 1022. The sub-process then advances to the step 1323. The step 1323 is provided to integrate the evaluation model 1036 on time interval tₑ using the road signal from the road generator 1010 and the control signal CGS^{e}(tₑ) from the evaluation buffer 1022. The process then advances to the step 1324 where a fitness value is calculated by the fitness function calculator 1032 by using the output X^{e} from the evaluation model 1036. The output X^{e} is a response from the evaluation model 1036 to the control signals CGS^{e}(tₑ) which are coded into the current chromosome. The process then advances to the step 1325 where the fitness value is returned to the step 1305. After the step 1305, the process advances to a decision block 1306 to test for termination of the GA. If the GA is not to be terminated, then the process advances to a step 1307 where a new generation of chromosomes is generated, and the process then returns to the step 1305 to evaluate the new generation. If the GA is to be terminated, then the process advances to the step 1309, where the best chromosome of the final generation of the GA, is decoded and stored in the output buffer 1001. After storing the decoded chromosome, the process advances to the step 1310 where the current control value CGSⁱ(T) is extracted from the output buffer 1001.

The structure of the output buffer 1001 is shown below as a set of row vectors, where first element of each row is a time value, and the other elements of each row are the control parameters associated with these time values. The values for each row include a damper valve position VP_{FL}, VP_{FR}, VP_{RL}, VP_{RR}, corresponding to front-left, front-right, rear-left, and rear-right respectively.

| Time* | CGSⁱ | | | |
|---|---|---|---|---|
| T | VP_{FL}(T)** | VP_{FR}(T) | VP_{RL}(T) | VP_{RR}(T) |
| T + T^{c} | VP_{FL}(T + T^{c}) | VP_{FR}(T + T^{c}) | VP_{RL}(T + T^{c}) | VP_{RR}(T + T^{c}) |
| . . . | . . . | . . . | . . . | . . . |
| T + T^{e} | VP_{FL}(T + T^{e}) | VP_{FR}(T + T^{e}) | VP_{RL}(T + T^{e}) | VP_{RR}(T + T^{e}) |

The output buffer 1001 stores optimal control values for evaluation time interval tₑ from the control simulation model, and the evaluation buffer 1022 stores temporal control values for evaluation on the interval tₑ for calculation of the fitness function.

Two simulation models are used. The simulation model 1020 is used for simulation and the evaluation model 1036 is used for evaluation. There are many different methods for numerical integration of systems of differential equations. Practically, these methods can be classified into two main classes: (1) variable-step integration methods with control of integration error; and (2) fixed-step integration methods without integration error control.

Numerical integration using methods of type (1) is very precise, but time-consuming. Methods of type (2) are typically faster, but with smaller precision. During each SSCQ call in the GA mode, the GA 1031 evaluates the fitness function 1032 many times and each fitness function calculation requires integration of the model of dynamic system (the integration is done each time). By choosing a small-enough integration step size, it is possible to adjust a fixed-step solver such that the integration error on a relatively small time interval (like the evaluation interval tₑ) will be small and it is possible to use the fixed-step integration in the evaluation loop for integration of the evaluation model 1036. In order to reduce total integration error it is possible to use the result of high-order variable-step integration of the simulation model 1020 as initial conditions for evaluation model integration. The use of variable-step solvers to integrate the evaluation model can provide better numerical precision, but at the expense of greater computational overhead and thus longer run times, especially for complicated models.

The fitness function calculation block 1032 computes a fitness function using the reference signal Y and the response (X) from the evaluation model 1036 (due to the control signal CGS^{e}(tₙ) provided to the evaluation module 1036).

The fitness function 1032 is computed as a vector of selected components of a matrix (x^{e}) and its squared absolute value using the following form:

$${Fitness}^{2} = {\sum }_{t ∈ [ T ; {T}^{e} ]} [ {\sum }_{i} {{w}_{i} ( {x}_{it}^{e} )}^{2} + {\sum }_{j} {{w}_{j} ( {y}_{j} - {x}_{jt}^{e} )}^{2} + {\sum }_{k}^{} {w}_{k} {f ( {x}_{kt}^{e} )}^{2} ] -> min , \qquad ( 5.1 )$$

where:

i denotes indexes of state variables which should be minimized by their absolute value; j denotes indexes of state variables whose control error should be minimized; k denotes indexes of state variables whose frequency components should be minimized; and wᵣ, r=i, j, k are weighting factors which represent the importance of the corresponding parameter from the human feelings point of view. By setting these weighting function parameters, it is possible to emphasize those elements from the output of the evaluation model that are correlated with the desired human requirements (e.g., handling, ride quality, etc.). In one embodiment, the weighting factors are initialized using empirical values and then the weighting factors are adjusted using experimental results.

Extraction of frequency components can be done using standard digital filtering design techniques for obtaining the filter parameters. Digital filtering can be provided by a standard difference equation applied to elements of the matrix X^{e}:
a(1)ƒ(x^{e}ₖ(t^{e}(N)))=b(1)x^{e}(t^{e}(N))+b(2)x^{e}ₖ(t^{e}(N−1))+ . . . +b(n_{b}+1)x^{e}ₖ(t^{e}(N−n_{b})) −a(2)ƒ(x^{e}ₖ(t^{e}ₖ(N−1)))− . . . −a(nₐ+1)ƒ(x^{e}ₖ(t^{e}(N−nₐ))) (5.2)

where a,b are parameters of the filter, N is the number of the current point, and n_{b}, nₐ describe the order of the filter. In case of a Butterworth filter, n_{b}=nₐ.

In one embodiment, the GA 1031 is a global search algorithms based on the mechanics of natural genetics and natural selection. In the genetic search, each design variable is represented by a finite length binary string and then these finite binary strings are connected in a head-to-tail manner to form a single binary string. Possible solutions are coded or represented by a population of binary strings. Genetic transformations analogous to biological reproduction and evolution are subsequently used to improve and vary the coded solutions. Usually, three principle operators, i.e., reproduction (selection), crossover, and mutation are used in the genetic search.

The reproduction process biases the search toward producing more fit members in the population and eliminating the less fit ones. Hence, a fitness value is first assigned to each string (chromosome) the population. One simple approach to select members from an initial population to participate in the reproduction is to assign each member a probability of selection on the basis of its fitness value. A new population pool of the same size as the original is then created with a higher average fitness value.

The process of reproduction simply results in more copies of the dominant or fit designs to be present in the population. The crossover process allows for an exchange of design characteristics among members of the population pool with the intent of improving the fitness of the next generation. Crossover is executed by selecting strings of two mating parents, randomly choosing two sites.

Mutation safeguards the genetic search process from a premature loss of valuable genetic material during reproduction and crossover. The process of mutation is simply to choose few members from the population pool according to the probability of mutation and to switch a 0 to 1 or vice versa at randomly sites on the chromosome.

The Fuzzy Logic Classification System (FLCS) 240 shown in FIG. 4 includes the optional information filter 241, the SCO 242 and the FC 243. The optional information filter 241 compresses the teaching signal Kⁱ to obtain the simplified teaching signal K^{c}, which is used with the SCO 242. The SCO 242, by interpolation of the simplified teaching signal K^{c}, obtains the knowledge base (KB) for the FC 143.

As described above, the output of the SSCQ is a teaching signal Kⁱ that contains the information of the behavior of the controller and the reaction of the controlled object to that control. Genetic algorithms in general perform a stochastic search. The output of such a search typically contains much unnecessary information (e.g., stochastic noise), and as a result such a signal can be difficult to interpolate. In order to exclude the unnecessary information from the teaching signal Kⁱ, the information filter 241 (using as a background the Shannon's information theory) is provided. For example, assume that A is a message source that produces the message a with probability p(a), and further assume that it is desired to represent the messages with sequences of binary digits (bits) that are as short as possible. It can be shown that the mean length L of these bit sequences is bounded from below by the Shannon entropy H(A) of the source: L≧H(A), where

$$H ( A ) = - {\sum }_{a}^{} p ( s ) {log}_{2} p ( a ) \qquad ( 6.1 )$$

Furthermore, if entire blocks of independent messages are coded together, then the mean number \overline{L} of bits per message can be brought arbitrary close to H(A).

This noiseless coding theorem shows the importance of the Shannon entropy H(A) for the information theory. It also provides the interpretation of H(A) as a mean number of bits necessary to code the output of A using an ideal code. Each bit has a fixed ‘cost’ (in units of energy or space or money), so that H(A) is a measure of the tangible resources necessary to represent the information produced by A.

In classical statistical mechanics, in fact, the statistical entropy is formally identically to the Shannon entropy. The entropy of a macrostate can be interpreted as the number of bits that would be required to specify the microstate of the system.

Assume x₁, . . . , X_{N} are N independent, identical distributed random variables, each with mean \overline{x} and finite variance. Given δ, ε>0, there exist N₀ such that, for N≧N₀,

$$P ( \vert \frac{1}{N} {\sum }_{i} {x}_{i} - \overline{x} \vert > δ ) < ɛ \qquad ( 6.2 )$$

This result is known as the weak law of large numbers. A sufficiently long sequence of independent, identically distributed random variables will, with a probability approaching unity, have an average that is close to mean of each variable.

The weak law can be used to derive a relation between Shannon entropy H(A) and the number of ‘likely’ sequences of N identical random variables. Assume that a message source A produces the message a with probability p(a). A sequence α=a₁a₂ . . . a_{N} of N independent messages from the same source will occur in ensemble of all N sequences with probability P(α)=p(a₁)·p(a₂)·p(a_{N}). Now define a random variable for each message by x=−log₂p(a), so that H(A)=\overline{x}. It is easy to see that

$$- {log}_{2} P ( α ) = {\sum }_{i} {x}_{i} .$$

From the weak law, it follows that, if go ε, δ>0, then for sufficient large N

$$P ( \vert - \frac{1}{N} {log}_{2} P ( α ) - H ( A ) \vert > δ ) < ɛ \qquad ( 6.3 )$$

for N sequences of α. It is possible to partition the set of all N sequences into two subsets:

a) A set Λ of “likely” sequences for which

$$\vert - \frac{1}{N} {log}_{2} P ( α ) - H ( A ) \vert \leq δ$$

b) A set of ‘unlikely’ sequences with total probability less than ε, for which this inequality fails.

This provides the possibility to exclude the ‘unlikely’ information from the set Λ which leaves the set of sequences Λ₁ with the same information amount as in set Λ but with a smaller number of sequences.

The SCO 242 is used to find the relations between (Input) and (Output) components of the teaching signal K^{c}. The SCO 242 is a tool that allows modeling of a system based on a fuzzy logic data structure, starting from the sampling of a process/function expressed in terms of input-output values pairs (patterns). Its primary capability is the automatic generation of a database containing the inference rules and the parameters describing the membership functions. The generated Fuzzy Logic knowledge base (KB) represents an optimized approximation of the process/function provided as input. FNN performs rule extraction and membership function parameter tuning using learning different learning methods, like error back propagation, fuzzy clustering, etc. The KB includes a rule base and a database. The rule base stores the information of each fuzzy rule. The database stores the parameters of the membership functions. Usually, in the training stage of the FIS, the parts of the KB are obtained separately.

The FC 243 is an on-line device that generates the control signals using the input information from the sensors comprising the following steps: (1) fuzzyfication; (2) fuzzy inference; and (3) defuzzyfication.

Fuzzyfication is a transferring of numerical data from sensors into a linguistic plane by assigning membership degree to each membership function. The information of input membership function parameters stored in the knowledge base of fuzzy controller is used.

Fuzzy inference is a procedure that generates linguistic output from the set of linguistic inputs obtained after fuzzyfication. In order to perform the fuzzy inference, the information of rules and of output membership functions from knowledge base is used.

Defuzzyfication is a process of converting of linguistic information into the digital plane. Usually, the process of defuzzyfication include selecting of center of gravity of a resulted linguistic membership function.

Fuzzy control of a suspension system is aimed at coordinating damping factors of each damper to control parameters of motion of car body. Parameters of motion can include, for example, pitching motion, rolling motion, heave movement, and/or derivatives of these parameters. Fuzzy control in this case can be realized in the different ways, and different number of fuzzy controllers used. For example, in one embodiment fuzzy control is implemented using two separate controllers, one controller for the front wheels, and one controller for the rear wheel shock absorbers 803, 804 and one controller for the front wheel shock absorbers 801, 802. In one embodiment a single controller controls the actuators for the shock absorbers 801-804.

FIG. 13 shows a model of a passenger car having a suspension system with non-linear movement with four local coordinates for each wheel suspension and three coordinates for the vehicle body, totaling 19 local coordinates. Equations of motion are given in Equations (7.1)-(7.11) below based on Lagrange's approach where each variable is represented as follows:
\ddot{z}₀: Heave acceleration
\ddot{β}: Pitch angular acceleration
\ddot{α}: Roll angular acceleration
\ddot{θ}ₙ: Angular acceleration of lower arm against body frame
\ddot{η}ₙ: Angular acceleration of damper axis against body frame
\ddot{z}₆ₙ: Damper stroke acceleration
\ddot{z}₁₂ₙ: Tire deflection acceleration
λ₁ₙ˜λ₃ₙ: Lagrangian multipliers
where suffix ‘n’ indicates the position of the wheels.

$$\begin{matrix}{\ddot{z}}_{0} = {λ}_{3 n} - g - \frac{\ddot{α} {m}_{b} {C}_{β } {A}_{2} - {\dot{α}}^{2} {m}_{b} {C}_{β} {A}_{1} - \ddot{β} \{ {m}_{ba} {C}_{β} + {m}_{b} {A}_{1} {S}_{β} \} + {\dot{β}}^{2} ( {m}_{ba} {S}_{β} + {m}_{b} {A}_{1} {C}_{β} ) + \{ {\ddot{z}}_{6 n} {m}_{sn} {C}_{αγη n} - 2 ( \dot{α} + {\dot{η}}_{n} ) {\dot{z}}_{6 n} {m}_{sn} {S}_{αγη n} + ( \ddot{α} + {\ddot{θ}}_{n} ) {m}_{aw 1 n} {C}_{αγθ n} - {( \dot{α} + {\dot{θ}}_{n} )}^{2} {m}_{aw 1 n} {S}_{αγθ n} - ( \ddot{α} + {\ddot{η}}_{n} ) {z}_{6 n} {m}_{sn} {S}_{αγη n} - {( \dot{α} + {\dot{η}}_{n} )}^{2} {z}_{6 n} {m}_{sn} {C}_{αγη n} - \ddot{α} {m}_{sawcn} {S}_{αγ n} - {\dot{α}}^{2} {m}_{sawcn} {C}_{αγ n} + \ddot{α} {m}_{sawbn} {C}_{α} - {\dot{α}}^{2} {m}_{sawbn} {S}_{α} - \ddot{β} {m}_{sawan} \} {C}_{β} - 2 \dot{β} \{ {\dot{z}}_{6 n} {m}_{sn} {C}_{αγη τ} + ( \dot{α} + {\dot{θ}}_{n} ) {m}_{aw 1 n} {C}_{αγθ n} - ( \dot{α} + {\dot{η}}_{n} ) {z}_{6 n} {m}_{sn} {S}_{αγη n} - \dot{α} {m}_{sawcn} {S}_{αγ n} + \dot{α} {m}_{sawbn} {C}_{α} - \dot{β} {m}_{sawan} / 2 \} {S}_{β} - ( \ddot{β} {S}_{β} + {\dot{β}}^{2} {C}_{β} ) \{ {m}_{aw 1 n} {S}_{αγθ n} + {z}_{6 n} {m}_{sn} {C}_{αγη n} + {m}_{sawcn} {C}_{αγ n} + {m}_{sawbn} {S}_{α} \}}{{m}_{b} + {m}_{sawn}} & ( 7.1 ) \\ \ddot{β} = \frac{2 \dot{β} [ \dot{α} {m}_{b} {A}_{1} {A}_{2} + {m}_{sn} {B}_{1} \{ {\dot{z}}_{6 n} {C}_{αγη n} - ( \dot{α} + {\dot{η}}_{n} ) {z}_{6 n} {S}_{αγη n} - \dot{α} {A}_{4} \} + {m}_{an} {B}_{2} \{ ( \dot{α} + {\dot{θ}}_{n} ) {e}_{1 n} {C}_{αγθ n} - \dot{α} {A}_{6} \} + {m}_{wn} {B}_{3} \{ ( \dot{α} + {\dot{θ}}_{n} ) {e}_{3 n} {S}_{αγθ n} - \dot{α} {A}_{6} \} ] - \ddot{α} {m}_{ba} {A}_{2} + {\dot{α}}^{2} {m}_{ba} {A}_{1} - {\ddot{z}}_{6 n} {m}_{sn} {a}_{1 n } {C}_{αγη n} + 2 {\dot{z}}_{6 n} ( \dot{α} + {\dot{η}}_{n} ) {m}_{sn} {a}_{1 n} {S}_{αγη n} + {\ddot{η}}_{n} {m}_{sn} {z}_{6 n} {a}_{1 n} {S}_{αγη n} + {\dot{η}}_{n} ( 2 \dot{α} + {\dot{η}}_{n} ) {m}_{sn} {z}_{6 n} {a}_{1 n} {C}_{αγη n} - {\ddot{θ}}_{n} {m}_{aw 1 n} {a}_{1 n} {C}_{αγθ n} + {\dot{θ}}_{n} ( 2 \dot{α} + {\dot{θ}}_{n} ) {m}_{aw 1 n} {a}_{1 n} {S}_{αγθ n} + \ddot{α} {a}_{1 n} \{ {m}_{sawcn} {S}_{αγ n} - {m}_{sawbn} {C}_{α} + {m}_{sn} {z}_{6 n} {S}_{αγη n} - {m}_{aw 1 n} {C}_{αγη n} \} + {\dot{α}}^{2} {a}_{1 n} \{ {m}_{sawcn} {C}_{αγ n} - {m}_{sawbn} {S}_{α} + {m}_{sn} {z}_{6 n} {C}_{αγη n} + {m}_{aw 1 n} {S}_{αγη n} \} - {\ddot{z}}_{0} [ \{ {m}_{b} ( {b}_{0} {S}_{α} + {c}_{0} {C}_{α} ) + {m}_{aw 1 n} {S}_{αγθ n} + {z}_{6 n} {m}_{sn} {C}_{αγη n} + {m}_{sawcn} {C}_{αγ n} + {m}_{sawbn} {S}_{α} \} {S}_{β} + ( {m}_{ba} + {m}_{sawan} ) {C}_{β} ] + {\dot{z}}_{0} ( 1 - \dot{β} ) ( {m}_{ba} + {m}_{sawan} ) {S}_{β} - g [ {m}_{ba} {C}_{β} + {m}_{b} {A}_{1} {S}_{β} + \{ {m}_{sn} {z}_{6 n} {C}_{αγη n} + {m}_{aw 1 n} {S}_{αγθ n} + {m}_{sawcn} {C}_{αγ n} + {m}_{sawbn} {S}_{α} \} {S}_{β} + {m}_{sawan} {C}_{β} ] + {λ}_{3 n} \{ ( {z}_{12 n} {C}_{α} + {e}_{3 n} {S}_{αγθ n} + {c}_{2 n} {C}_{αγ n} + {b}_{2 n} {S}_{α} ) {S}_{β} - {a}_{1 n} {C}_{β} \}}{- ( {m}_{saw 2 n} + {m}_{bal} + {m}_{b} {A}_{1}^{2} + {m}_{sn} {B}_{1}^{2} + {m}_{an} {B}_{2}^{2} + {m}_{wn} {B}_{3}^{2} )} & ( 7.2 ) \\ \ddot{α} = \frac{{\ddot{z}}_{0} \{ {m}_{b} {A}_{2} + {m}_{aw 1 n} {C}_{αγθ n} - {z}_{6 n} {m}_{sn} {S}_{αγη n} - {m}_{sawcn} {S}_{αγ n} + {m}_{sawbn} {C}_{α} \} {C}_{β} - \ddot{β} {m}_{ba} {A}_{2} {m}_{sn} ( 2 {\ddot{az}}_{6 n} + {\ddot{η}}_{n} {z}_{6 n} + 2 {\dot{η}}_{n} {\dot{z}}_{6 n} ) ( {z}_{6 n} + {E}_{1 n} ) - 2 \dot{α} ( {m}_{sn} {z}_{6 n} {\dot{η}}_{n} {E}_{2 n} + {\dot{θ}}_{n} {m}_{aw 1 n} {H}_{2 n} ) + {\ddot{z}}_{6 n} {m}_{sn} {E}_{2 n} - {\dot{η}}_{n}^{2} {m}_{sn} {z}_{6 n} {E}_{2 n} + \ddot{θ} ( {m}_{aw 2 In } - {m}_{aw 1 n} {H}_{1 n} ) - {\dot{θ}}_{n}^{2} {m}_{aw 1 n} {H}_{2 n} + \ddot{β} {a}_{1 n} ( {m}_{sawcn} {S}_{αγ n} - {m}_{sawbn} {C}_{α} + {m}_{sn} {z}_{6 n} {S}_{αγη n} - {m}_{aw 1 n} {C}_{αγθ n} ) - {\dot{β}}^{2} \{ {m}_{b} {A}_{2} {A}_{1} + {m}_{sn} {B}_{1} ( - {z}_{6 n} {S}_{αγη n} - {A}_{4} ) + {m}_{an} {B}_{2} ( {e}_{1 n} {C}_{αγθ n} - {A}_{6} ) + {m}_{wn} {B}_{3} ( {e}_{3 n} {C}_{αγθ n} - {A}_{6} ) \} + {gm}_{b} {A}_{2} {C}_{β} - g \{ {m}_{sn} {z}_{6 n} {S}_{αγη n} - {m}_{aw 1 n} {C}_{αγθ n} + {m}_{sawcn} {S}_{αγ n} - {m}_{sawbn} {C}_{α} \} {C}_{β} - \ddot{β} {m}_{ba} {A}_{2} + {λ}_{3 n} ( {z}_{12 n} {S}_{α} - {e}_{3 n} {C}_{αγθ n} + {c}_{2 n} {S}_{αγ n} - {b}_{2 n} {C}_{α} ) {C}_{β}}{- \{ {m}_{bbI} + {m}_{sawIn} + {m}_{sn} {z}_{6 n} ( {z}_{6 n} + 2 {E}_{1 n} ) - 2 {m}_{aw 1 n} {H}_{1 n} \}} & ( 7.3 ) \\ {\ddot{θ}}_{n} = \frac{\ddot{α} ( {m}_{aw 2 In} - {m}_{aw 1 n} {H}_{t} ) - \ddot{β} {m}_{aw 1 n} {a}_{1 n} {C}_{αγθ n} + {\ddot{z}}_{0} {m}_{aw 1 n} {C}_{αγθ n} {C}_{β} + {\dot{α}}^{2} {m}_{aw 1 n} {H}_{2} - {\dot{β}}^{2} ( {m}_{an} {B}_{2} {e}_{1 n} {C}_{αγθ n} + {m}_{wn} {B}_{3} {e}_{3 n} {C}_{αγθ n} ) + {gm}_{aw 1 n} {C}_{αγθ n} {C}_{β} - {λ}_{1 n} {e}_{2 n} {S}_{θ n} - {λ}_{2 n} {e}_{2 n} {C}_{θ n} - {λ}_{3 n} {e}_{3 n} {C}_{αγθ n} {C}_{β} [ {k}_{zi} {e}_{0 i}^{2} \{ sin ( {γ}_{i} + {θ}_{i} ) + sin ( {γ}_{ii} + {θ}_{ii} ) \} cos ( {γ}_{n} + {θ}_{n} ) \vert {k}_{ziii} {e}_{0 iii}^{2} ( {γ}_{iii} + {θ}_{iii} ) + sin ( {γ}_{iv} + {θ}_{iv} ) \} cos ( {γ}_{n} + {θ}_{n} ) ]}{- {m}_{aw 2 In}} & ( 7.4 ) \\ {\ddot{η}}_{n} = \frac{{\ddot{θ}}_{n} {e}_{2 n} {S}_{θ n} + {\dot{θ}}_{n}^{2} {e}_{2 n} {C}_{θ n} - {\ddot{z}}_{6 n} {S}_{η n} - 2 {\dot{η}}_{n} {\dot{z}}_{6 n} {C}_{η n} + {\dot{η}}_{n}^{2} ( {z}_{6 n} - {d}_{1 n} ) {S}_{η n}}{( {z}_{6 n} - {d}_{1 n} ) {C}_{η n}} & ( 7.5 ) \\ {\ddot{z}}_{6 n} = \frac{{\ddot{θ}}_{n} {e}_{2 n} {C}_{θ n} - {\dot{θ}}_{n}^{2} {e}_{2 n} {S}_{θ n} + {\ddot{η}}_{n} ( {z}_{6} - {d}_{1 n} ) {S}_{η n} + 2 {\dot{η}}_{n} {\dot{z}}_{6 n} {S}_{η n} + {\dot{η}}_{n}^{2} ( {z}_{6 n} - {d}_{1 n} ) {C}_{η n}}{{C}_{η n}} & ( 7.6 ) \\ {\dot{z}}_{12 n} = \frac{\{ {\dot{α z}}_{12 n} {S}_{α} - ( \dot{α} + {\dot{θ}}_{n} ) {e}_{3 n} {C}_{αγθ n} + {\dot{α c}}_{2 n} {S}_{αγ n} - {\dot{α b} }_{2 n} {C}_{α} \} {C}_{β} - {\dot{z}}_{0} + \dot{β} [ \{ {z}_{12 n} {C}_{α} + {e}_{3 n} {S}_{αγθ n} + {c}_{2 n} {C}_{αγ n} + {b}_{2 n} {S}_{α} \} {S}_{β} + {a}_{1 n} {C}_{β} ] + {\dot{R}}_{n} ( t )}{{C}_{α} {C}_{β}} & ( 7.7 ) \\ {λ}_{1 n} = \frac{{m}_{sn} {z}_{6 n} \{ {\ddot{η}}_{n} {z}_{6 n} + 2 {\dot{η}}_{n} {\dot{z}}_{6 n} + \ddot{α} ( {z}_{6 n} + {E}_{1} ) + 2 {\ddot{az}}_{6 n} + \ddot{β} {a}_{1 n} {S}_{αγη n} - {\ddot{z}}_{0} {S}_{αγη n} {C}_{β} + {\dot{α}}^{2} {E}_{2} + {\dot{β}}^{2} {B}_{1} {S}_{αγη n} - {gS}_{αγη n} {C}_{β} \} - {λ}_{2 n} ( {z}_{6 n} - {d}_{1 n} ) {S}_{η n}}{- ( {z}_{6 n} - {d}_{1 n} ) {C}_{η n}} & ( 7.8 ) \\ {λ}_{2 n} = \frac{{m}_{sn} \{ {\ddot{z}}_{6 n} + \ddot{α} {E}_{2} - \ddot{β} {a}_{1 n} {C}_{αγη n} + {\ddot{z}}_{0} {C}_{αγη n} {C}_{β} - {\dot{η}}_{n}^{2} {z}_{6 n} - {\dot{α}}^{2} ( {z}_{6 n} + {E}_{1} ) - {\dot{β}}^{2} {B}_{1} {C}_{αγη n} - 2 {\dot{η}}_{n} \dot{α} {z}_{6 n} + {gC}_{αγη n} {C}_{β} \} + {k}_{sn} ( {z}_{6 n} - {l}_{sn} ) + {c}_{sn} {\dot{z}}_{6 n} + {λ}_{1 n} {S}_{η n}}{- {C}_{η n}} & ( 7.9 ) \\ {λ}_{3 n} = \frac{{c}_{wn} {\dot{z}}_{12 n} + {k}_{wn} ( {z}_{12 n} - {l}_{wn} )}{{C}_{α}} & ( 7.10 ) \\ \begin{matrix}where \\ \begin{matrix}n = i : front left , ii : front right , iii : rear left iv : rear right \\ {m}_{ ba} = {m}_{ b} ( {a}_{ 0} + {a}_{ 1} ) \\ {m}_{bbl} = {m}_{ b} ( {b}_{ 0}^{ 2} + {c}_{ 0}^{ 2} ) + {I}_{ bx} \\ {m}_{ bal} = { {m}_{ b} ( {a}_{ 0} + {a}_{ 1} )}^{2} + {I}_{ by} \\ {m}_{ sawn} = {m}_{ sn} + {m}_{ an} + {m}_{ wn} \\ {m}_{sawan} = ( {m}_{sn} + {m}_{an} + {m}_{wn} ) {a}_{1 n} \\ {m}_{ sawbn} = ( {m}_{ sn} + {m}_{ an} + {m}_{ wn} ) {b}_{ 2 n} \\ {m}_{ sawcn} = {m}_{ sn} {c}_{ 1 n} + ( {m}_{ an} + {m}_{ wn} ) {c}_{ 2 n} \\ {m}_{ saw 2 n} = ( {m}_{ sn} + {m}_{ an} + {m}_{ wn} ) {a}_{ 1 n}^{ 2} \\ {m}_{ sawIn} = {m}_{ an} {e}_{ 1 n}^{ 2} + {m}_{ wn} {e}_{ 3 n}^{ 2} + {m}_{ sn} ( {c}_{ 1 n}^{ 2} + {b}_{ 2 n}^{ 2} - 2 {c}_{ 1 n} {b}_{ 2 n} sin {γ}_{n} ) + ( {m}_{ an} + {m}_{ wn} ) ( {c}_{2 n}^{ 2} + {b}_{2 n}^{ 2} - 2 {c}_{2 n} {b}_{2 n} sin {γ}_{n} ) + {I}_{ axn} \\ {m}_{ aw 2 In} = {m}_{ an} {e}_{ 1 n}^{ 2} + {m}_{ wn} {e}_{ 3 n}^{ 2} + {I}_{ axn} \\ {m}_{ aw 1 n} = {m}_{ an} {e}_{ 1 n} + {m}_{ wn} {e}_{ 3 n} \\ {m}_{ aw 2 n} = {m}_{ an} {e}_{ 1 n}^{ 2} + {m}_{ wn} {e}_{ 3 n}^{ 2} \\ {A}_{ 1} = {b}_{ 0} sin α + {c}_{ 0} cos α \\ {A}_{ 2} = {b}_{ 0} cos α - {c}_{ 0} sin α \\ {A}_{ 4 n} = {c}_{ 1 n} sin ( α + {γ}_{n} ) - {b}_{2 n} cos α \\ {A}_{6 n} = {c}_{2 n} sin ( α + {γ}_{n} ) - {b}_{2} cos α \\ {B}_{1 n} = {z}_{6 n} cos ( α + {γ}_{n} + {η}_{n} ) + {c}_{1 n} cos ( α + {γ}_{n} ) + {b}_{2 n} sin α \\ {B}_{2 n} = {e}_{1 n} sin ( α + {γ}_{n} + {θ}_{n} ) + {c}_{2 n} cos ( α + {γ}_{n} ) + {b}_{2 n} sin α \\ {B}_{3 n} = {e}_{3 n} sin ( α + {γ}_{n} + {θ}_{n} ) + {c}_{2 n} cos ( α + {γ}_{n} ) + {b}_{2 n} sin α \\ {E}_{1 n} = {c}_{1 n} cos {η}_{n} - {b}_{2 n} sin ( {γ}_{n} + {η}_{n} ) \\ {E}_{2 n} = {c}_{1 n} sin {η}_{n} + {b}_{2 n} cos ( {γ}_{n} + {η}_{n} ) \\ {H}_{1 n} = {c}_{2 n} sin {θ}_{n} - {b}_{2 n} cos ( {γ}_{n} + {θ}_{n} ) \\ {H}_{2 n} = {c}_{2 n} cos {θ}_{n} + {b}_{2 n} sin ( {γ}_{n} + {θ}_{n} ) \\ {S}_{α} = sin α , \\ {S}_{β} = sin β , \\ {S}_{αγ n} = sin ( α + {γ}_{n} ) , \\ {S}_{αγη n} = sin ( α + {γ}_{n} + {η}_{n} ) , \\ {S}_{αγ θ n} = ( α + {γ}_{n} + {θ}_{n} ) \\ {C}_{α} = cos α , \\ {C}_{β} = cos β , \\ {C}_{αγ n} = cos ( α + {γ}_{n} ) , \\ {C}_{αγη n} = cos ( α + {γ}_{n} + {η}_{n} ) , \\ {C}_{αγθ n} = cos ( α + {γ}_{n} + {θ}_{n} )\end{matrix} )\end{matrix} & ( 7.11 )\end{matrix}$$

FIG. 5 is a block diagram of suspension control system. where the suspension system 526 (the car and suspension from FIG. 13) is represented by equations (7.1)-(7.11).

Structure of the Soft Computing Optimizer

In FIGS. 3 and 4 the SC optimizer 242 creates a FIS using the teaching signal from the SSCQ 130. The SC optimizer 242 provides GA-based FNN learning including rule extraction and KB optimization. The SC optimizer 242 can use as a teaching signal either an output from the SSCQ 130 and/or output from the suspension system 120 (or a model of the suspension system 120).

In one embodiment, the SC optimizer 242 includes (as shown in FIG. 3) a fuzzy inference engine in the form of a FNN. The SC optimizer also allows FIS structure selection using models, such as, for example, Sugeno FIS order 0 and 1, Mamdani FIS, Tsukamoto FIS, etc. The SC optimizer 242 also allows selection of the FIS structure optimization method including optimization of linguistic variables, and/or optimization of the rule base. The SC optimizer 242 also allows selection of the teaching signal source, including: the teaching signal as a look up table of input-output patterns; the teaching signal as a fitness function calculated as a dynamic system response; the teaching signal as a fitness function is calculated as a result of control of a real suspension system; etc.

In one embodiment, output from the SC optimizer 242 can be exported to other programs or systems for simulation or actual control of a suspension system 130. For example, output from the FC optimizer 242 can be exported to a simulation program for simulation of suspension system dynamic responses, to an online controller (to use in control of a real suspension system), etc.

The Operation of the SC Optimizer

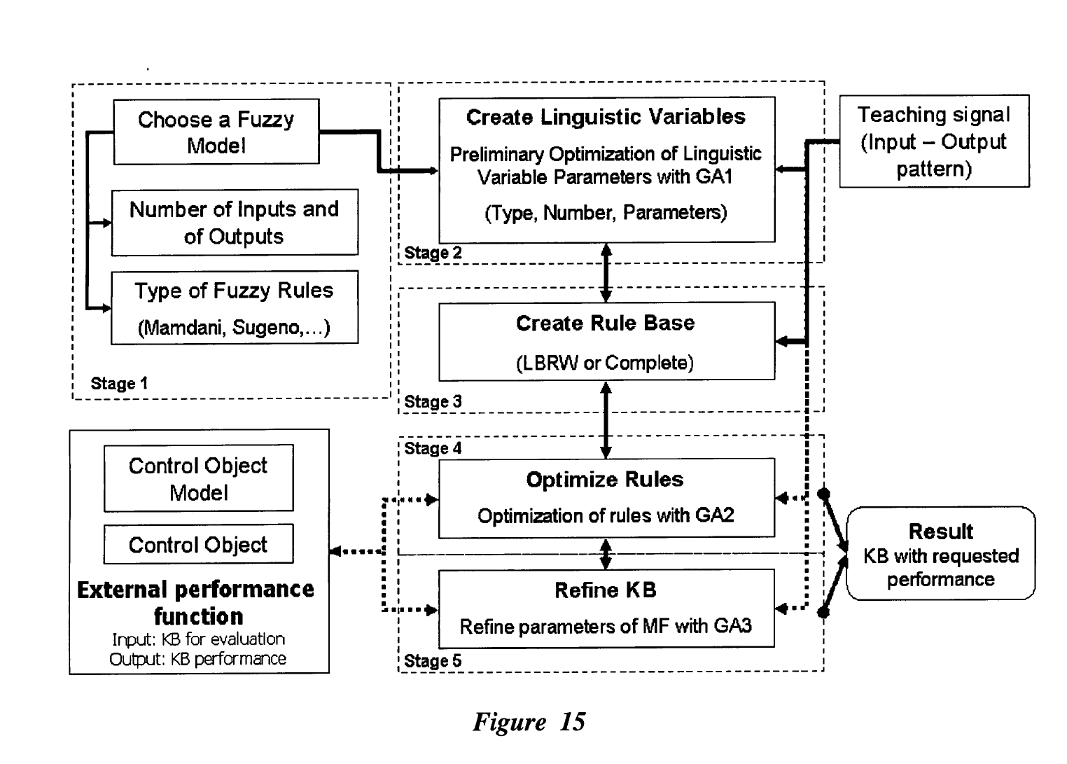

FIG. 15 is a high-level flowchart 400 for the SC optimizer 242. By way of explanation, and not by way of limitation, the operation of the flowchart is shown as five stages, labeled Stages 1, 2, 3, 4, and 5.

In Stage 1, the user selects a fuzzy model by selecting one of parameters such as, for example, the number of input and output variables, the type of fuzzy inference model (Mamdani, Sugeno, Tsukamoto, etc.), and the source of the teaching signal

In Stage 2, a first GA (GA1) optimizes linguistic variable parameters, using the information obtained in Stage 1 about the general system configuration, and the input-output training patterns, obtained from the training signal as an input-output table. In one embodiment, the teaching signal is obtained using the structure presented above.

In Stage 3, a precedent part of the rule base is created and rules are ranked according to their firing strength. Rules with high firing strength are kept, whereas weak rules with small firing strength are eliminated.

In Stage 4, a second GA (GA2) optimizes a rule base, using the fuzzy model obtained in Stage 1, optimal linguistic variable parameters obtained in Stage 2, selected set of rules obtained in Stage 3 and the teaching signal.

In Stage 5, the structure of FNN is further optimized. In order to reach the optimal structure, the classical derivative-based optimization procedures can be used, with a combination of initial conditions for back propagation, obtained from previous optimization stages. The result of Stage 5 is a specification of fuzzy inference structure that is optimal for the suspension system 120. Stage 5 is optional and can be bypassed. If Stage 5 is bypassed, then the FIS structure obtained with the GAs of Stages 2 and 4 is used.

In one embodiment, Stage 5 can be realized as a GA which further optimizes the structure of the linguistic variables, using set of rules obtained in the Stage 3 and 4. In this case only parameters of the membership functions are modified in order to reduce approximation error.

In one embodiment of Stage 4 and Stage 5, selected components of the KB are optimized. In one embodiment, if the KB has more than one output signals, the consequent part of the rules may be optimized independently for each output in Stage 4. In one embodiment, if KB has more than one input, membership functions of selected inputs are optimized in Stage 5.

In one embodiment, while Stage 4 and Stage 5 the actual suspension system response in form of the fitness function can be used as performance criteria of FIS structure while GA optimization.

In one embodiment, the SC optimizer 242 uses a GA approach to solve optimization problems related with choosing the number of membership functions, the types and parameters of the membership functions, optimization of fuzzy rules and refinement of KB.

GA optimizers are often computationally expensive because each chromosome created during genetic operations is evaluated according to a fitness function. For example, a GA with a population size of 100 chromosomes evolved 100 generations, may require up to 10000 calculations of the fitness function. Usually this number is smaller, since it is possible to keep track of chromosomes and avoid re-evaluation. Nevertheless, the total number of calculations is typically much greater than the number of evaluations required by some sophisticated classical optimization algorithm. This computational complexity is a payback for the robustness obtained when a GA is used. The large number of evaluations acts as a practical constraint on applications using a GA. This practical constraint on the GA makes it worthwhile to develop simpler fitness functions by dividing the extraction of the KB of the FIS into several simpler tasks, such as: define the number and shape of membership functions; select optimal rules; fix optimal rules structure; and refine the KB structure. Each of these tasks are discussed in more detail below. In one embodiment, the SC optimizer 242 uses a divide-and-conquer type of algorithm applied to the KB optimization problem.

Definition of the Numbers and of Shapes of the Membership Functions with GA

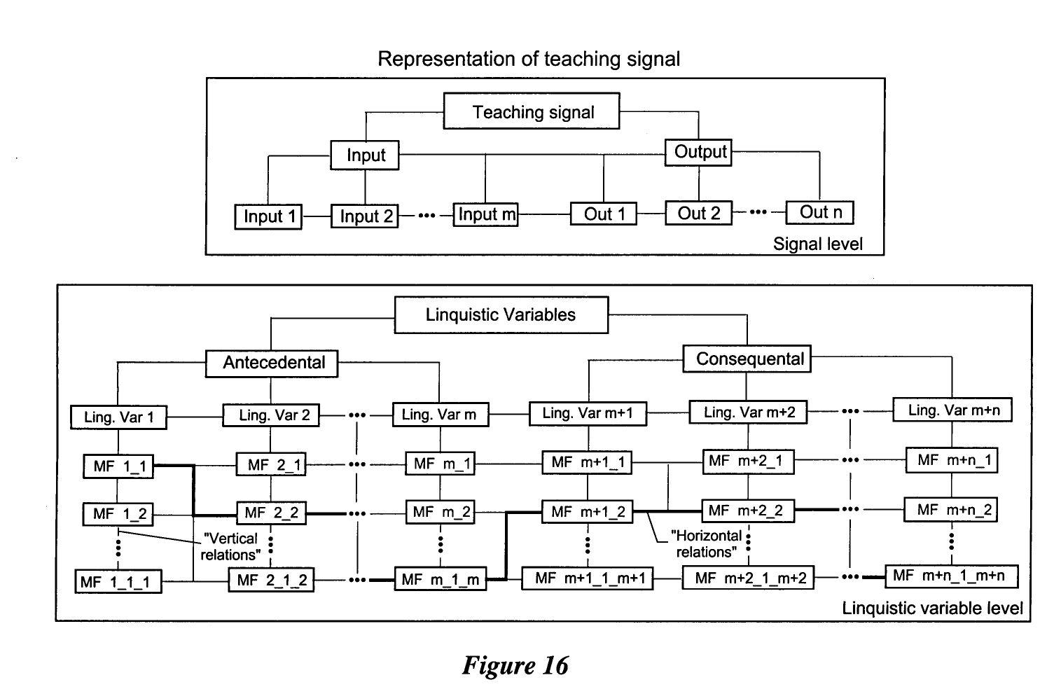

In one embodiment, the teaching signal, representing one or more input signals and one or more output signals, can be presented as shown in FIG. 16. The teaching signal is divided into input and output parts. Each of the parts is divided into one or more signals. Thus, at each time point of the teaching signal there is a correspondence between the input and output parts, indicated as a horizontal line in FIG. 16.

Each component of the teaching signal (input or output) is assigned to a corresponding linguistic variable, in order to explain the signal characteristics using linguistic terms. Each linguistic variable is described by some unknown number of membership functions, like “Large”, “Medium”, “Small”, etc. FIG. 16 shows various relationships between the membership functions and their parameters.

“Vertical relations” represent the explicitness of the linguistic representation of the concrete signal, e.g., how the membership functions is related to the concrete linguistic variable. Increasing the number of vertical relations will increase the number of membership functions, and as a result, will increase the correspondence between possible states of the original signal, and its linguistic representation. An infinite number of vertical relations would provide an exact correspondence between signal and its linguistic representation, because each possible value of the signal would be assigned a membership function, but in this case the situations as “over learning” may occur. Smaller number of vertical relations will increase the robustness, since some small variations of the signal will not affect much the linguistic representation. The balance between robustness and precision is a very important moment in design of the intelligent systems, and usually this task is solved by Human expert.

“Horizontal relations” represent the relationships between different linguistic variables. Selected horizontal relations can be used to form components of the linguistic rules.

To define the “horizontal” and “vertical” relations mathematically, consider a teaching signal:
[x(t),y(t)],
Where:

t=1, . . . , N—time stamps;

N—number of samples in the teaching signal;

x(t)=(x₁(t), . . . xₘ(t))—input components;

y(t)=(y₁(t), . . . yₙ(t))—output components.

Define the linguistic variables for each of the components. A linguistic variable is usually defined as a quintuple: (x,T(x),U,G,M), where x is the name of the variable, T(x) is a term set of the x, that is the set of the names of the linguistic values of x, with a fuzzy set defined in U as a value, G is a syntax rule for the generation of the names of the values of the x and M is a semantic rule for the association of each value with its meaning. In the present case, x is associated with the signal name from x or y, term set T(x) is defined using vertical relations, U is a signal range. In some cases, one can use normalized teaching signals, then the range of U is [0,1]. The syntax rule G in the linguistic variable optimization can be omitted, and replaced by indexing of the corresponding variables and their fuzzy sets.

Semantic rule M varies depending on the structure of the FIS, and on the choice of the fuzzy model. For the representation of all signals in the system, it is necessary to define m+n linguistic variables:

Let [X,Y], X=(X₁, . . . ,Xₘ), Y=(Y₁, . . . , Yₙ) be the set of the linguistic variables associated with the input and output signals correspondingly. Then for each linguistic variable one can define a certain number of fuzzy sets to represent the variable:
X₁:{μ_{X}_{₁}¹, . . . , μ_{X}_{₁}^{l}^{_{X1}}}, . . . , Xₘ:{μ_{Xm}^{l}, . . . , μ_{Xm}^{l}^{_{Xm}}};
Y₁:{μ_{Y}_{₁}¹, . . . , μ_{Y}_{₁}^{l}^{_{Y1}}}, . . . , Yₙ:{μ_{Y}_{ₙ}¹, . . . , μ_{Y}_{ₙ}^{l}^{_{Yn}}}
Where

μ_{X}_{ᵢ}^{j}^{ᵢ}, i=1, . . . , m, jᵢ=1, . . . l_{X}_{ᵢ} are membership functions of the i th component of the input variable; and

μ_{Y}_{ᵢ}^{j}^{ᵢ}, i=1, . . . , n, jᵢ=1, . . . , l_{Y}_{ᵢ} are membership functions of the i th component of the output variable.

Usually, at this stage of the definition of the KB, the parameters of the fuzzy sets are unknown, and it may be difficult to judge how many membership functions are necessary to describe a signal. In this case, the number of membership functions l_{X}_{ᵢ} ∈[1, L_{MAX}], i=, . . . , m can be considered as one of the parameters for the GA (GA1) search, where L_{MAX} is the maximum number of membership functions allowed. In one embodiment, L_{MAX} is specified by the user prior to the optimization, based on considerations such as the computational capacity of the available hardware system.

Knowing the number of membership functions, it is possible to introduce a constraint on the possibility of activation of each fuzzy set, denoted as p_{X}_{ᵢ}^{j}. One of the possible constraints can be introduced as:

$${p}_{{X}_{i}}^{j ′} \geq \frac{1}{{l}_{{X}_{i}}} , \\ i = 1 , … , m ;$$

$$j = 1 , … , {l}_{{X}_{i}}$$

This constraint will cluster the signal into the regions with equal probability, which is equal to division of the signal's histogram into curvilinear trapezoids of the same surface area. Supports of the fuzzy sets in this case are equal or greater to the base of the corresponding trapezoid. How much greater the support of the fuzzy set should be, can be defined from an overlap parameter. For example, the overlap parameter takes zero, when there is no overlap between two attached trapezoids. If it is greater than zero then there is some overlap. The areas with higher probability will have in this case “sharper” membership functions. Thus, the overlap parameter is another candidate for the GA1 search. The fuzzy sets obtained in this case will have uniform possibility of activation.

Modal values of the fuzzy sets can be selected as points of the highest possibility, if the membership function has unsymmetrical shape, and as a middle of the corresponding trapezoid base in the case of symmetric shape. Thus one can set the type of the membership functions for each signal as a third parameter for the GA1.

The relation between the possibility of the fuzzy set and its membership function shape can also be found from geometrical view point. The possibility of activation of each membership function is calculated as follows:

$${p}_{{X}_{i}}^{j} = p ( {x}_{i} \text{\textbar} {x}_{i} = {μ}_{{X}_{i}}^{j} ) = \frac{1}{N} {\sum }_{t = 1}^{N} {μ}_{{X}_{i}}^{j} ( {x}_{i} ( t ) ) \qquad ( 8.1 )$$

Mutual possibility of activation of different membership functions can be defined as:

$${p}_{{X}_{i} \vert {X}_{k}}^{( j , l )} = p ( {x}_{i} {\vert}_{{x}_{i} = {μ}_{{X}_{i}}^{j} , {x}_{k} = {μ}_{{X}_{k}}^{l}} ) = \frac{1}{N} {\sum }_{t = 1}^{N} [ {μ}_{{X}_{i}}^{j} ( {x}_{i} ( t ) ) * {μ}_{{X}_{k}}^{l} ( {x}_{k} ( t ) ) ] \qquad ( 8.2 )$$

where * denotes selected T-norm (Fuzzy AND) operation; j=1, . . . , l_{X}, l=1, . . . ,l_{X}_{ᵢ} are indexes of the corresponding membership functions.

In fuzzy logic literature, T-norm, denoted as * is a two-place function from [0,1]×[0,1] to [0,1]. It represents a fuzzy intersection operation and can be interpreted as minimum operation, or algebraic product, or bounded product or drastic product. S-conorm, denoted by \dot{+}, is a two-place function, from [0,1]×[0,1] to [0,1]. It represents a fuzzy union operation and can be interpreted as algebraic sum, or bounded sum and drastic sum. Typical T-norm and S-conorm operators are presented in the Table 3.

TABLE 3

| T-norms (fuzzy intersection) | S-conorms (fuzzy union) |
|---|---|
| min(x, y)—minimum operation | max(x, y)—maximum operation |
| xy—algebraic product | x + y − xy—algebraic sum |
| x*y = max [0, x + y − 1]—bounded product | $x \dot{+} y = min [ 1 , x + y ] - bounded sum$ |
| $x * y = \{ \begin{matrix}x , & if y = 1 \\ y , & if x = 1 \\ 0 , & if x , y < 1\end{matrix} - drastic product$ | $x \dot{+} y = \{ \begin{matrix}x , & if y = 0 \\ y , & if x = 0 \\ 0 , & if x , y > 0\end{matrix} - drastic sum$ |

If i=k, and j≠l, then equation (8.2) defines “vertical relations”; and if i≠k, then equation (8.2) defines “horizontal relations”. The measure of the “vertical” and of the “horizontal” relations is a mutual possibility of the occurrence of the membership functions, connected to the correspondent relation.

The set of the linguistic variables is considered as optimal, when the total measure of “horizontal relations” is maximized, subject to the minimum of the “vertical relations”.

Hence, one can define a fitness function for the GA1 which will optimize the number and shape of membership functions as a maximum of the quantity, defined by equation (8.2), with minimum of the quantity, defined by equation (8.1).

The chromosomes of the GA1 for optimization of linguistic variables according to Equations (8.1) and (8.2) have the following structure:

$$\underbrace{[ {l}_{{X}_{1}} , … , {l}_{{Y}_{n}} ]}_{m + n} \underbrace{[ {α}_{{X}_{1}} , … , {α}_{{Y}_{n}} ]}_{m + n} \underbrace{[ {T}_{{X}_{1}} , … , {T}_{{Y}_{N}} ]}_{m + n}$$

Where:

I_{x(y)}_{ᵢ} ∈[1, L_{MAX}] are genes that code the number of membership functions for each linguistic variable Xᵢ(Yᵢ);

α_{X(Y)}_{ᵢ} are genes that code the overlap intervals between the membership functions of the corresponding linguistic variable Xᵢ(Yᵢ); and

T_{x(y)}_{ᵢ} are genes that code the types of the membership functions for the corresponding linguistic variables.

Another approach to the fitness function calculation is based on the Shannon information entropy. In this case, instead of the equations (8.1) and (8.2), for the fitness function representation, one can use the following information quantity taken from the analogy with information theory:

$$\begin{matrix}\begin{matrix}{H}_{{X}_{ i}}^{j} = - {p}_{{X}_{i}}^{j} log ( {p}_{{X}_{i}}^{j} ) \\ = - p ( {x}_{i} \text{\textbar} {x}_{i} = {μ}_{{X}_{i}}^{j} ) log [ p ( {x}_{i} \text{\textbar} {x}_{i} = {μ}_{{X}_{i}}^{j} ) ] \\ = - \frac{1}{N} {\sum }_{t = 1}^{N} {μ}_{{X}_{i}}^{j} ( {x}_{i} ( t ) ) log [ {μ}_{{X}_{i}}^{j} ( {x}_{i} ( t ) ) ]\end{matrix} & ( 8.1 a ) \\ and & \\ \begin{matrix}{H}_{{X}_{i} \vert {X}_{k}}^{( j , l )} = H ( {x}_{i} {\vert}_{{x}_{i} = {μ}_{{X}_{i}}^{j} , {x}_{k} = {μ}_{{X}_{k}}^{l}} ) \\ = - \frac{1}{N} {\sum }_{t = 1}^{N} [ {μ}_{{X}_{ i}}^{j} ( {x}_{i} ( t ) ) * {μ}_{{X}_{k}}^{l} ( {x}_{k} ( t ) ) ] log \\ [ {μ}_{{X}_{i}}^{j} ( {x}_{i} ( t ) ) * {μ}_{{X}_{k}}^{l} ( {x}_{k} ( t ) ) ]\end{matrix} & ( 8.2 a )\end{matrix}$$

In this case, GA1 will maximize the quantity of mutual information (8.2a), subject to the minimum of the information about each signal (8.1a). In one embodiment, the combination of information and probabilistic approach can also be used.

In case of the optimization of number and shapes of membership functions in Sugeno-type FIS, it is enough to include into GA chromosomes only the input linguistic variables. The detailed fitness functions for the different types of fuzzy models will be presented in the following sections, since it is more related with the optimization of the structure of the rules.

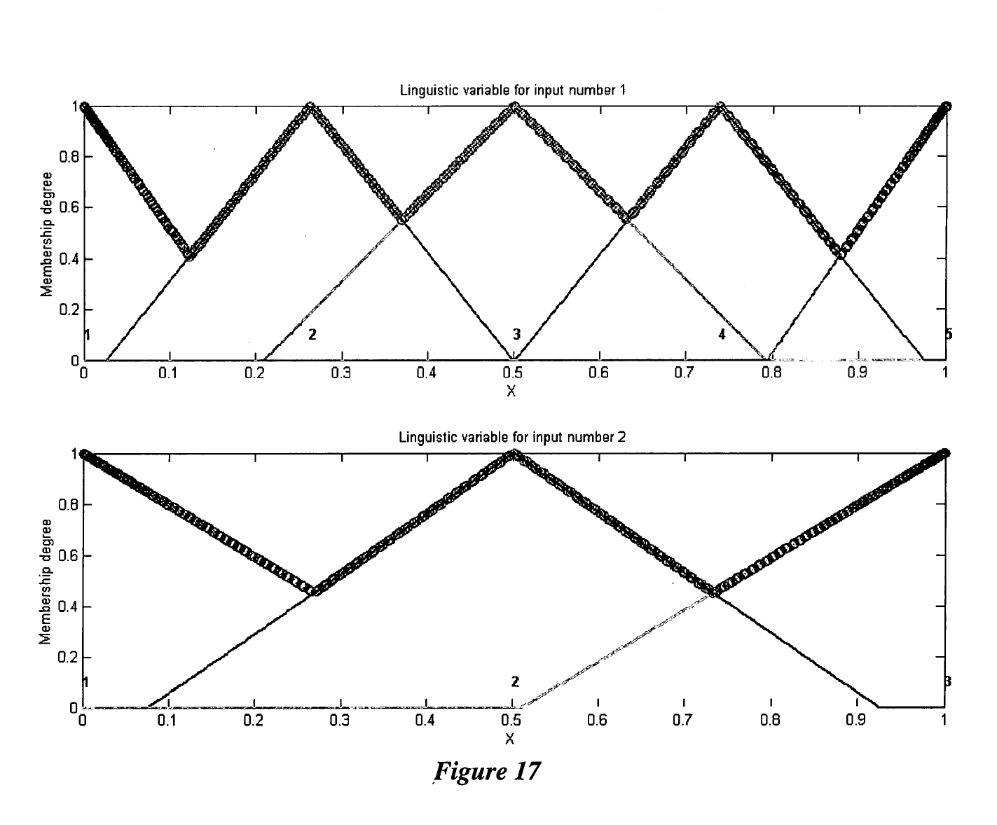

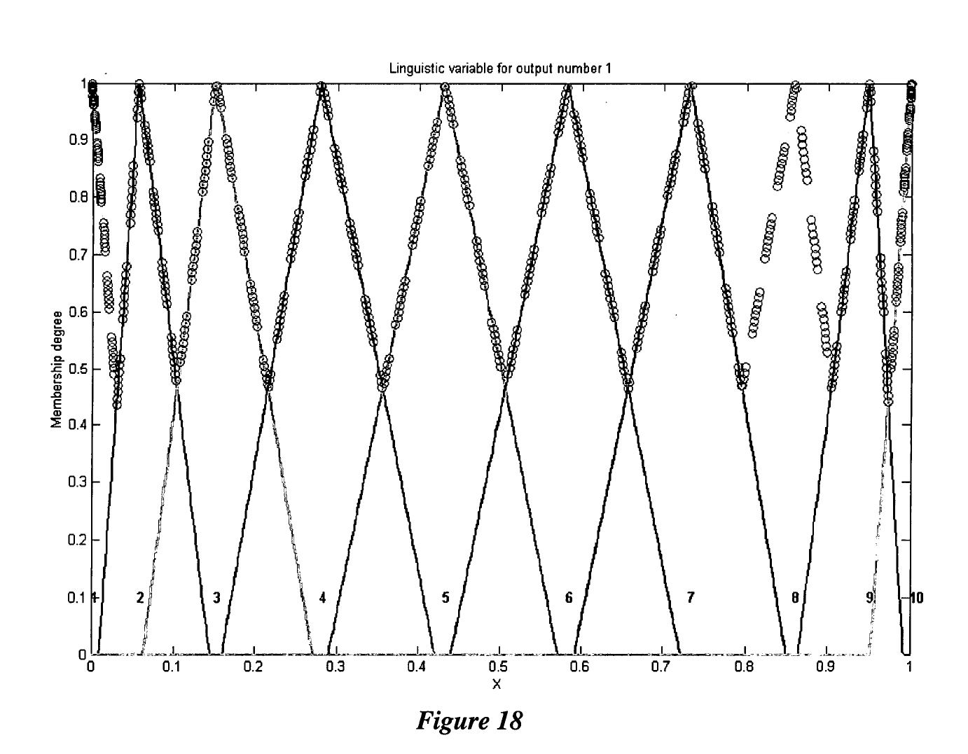

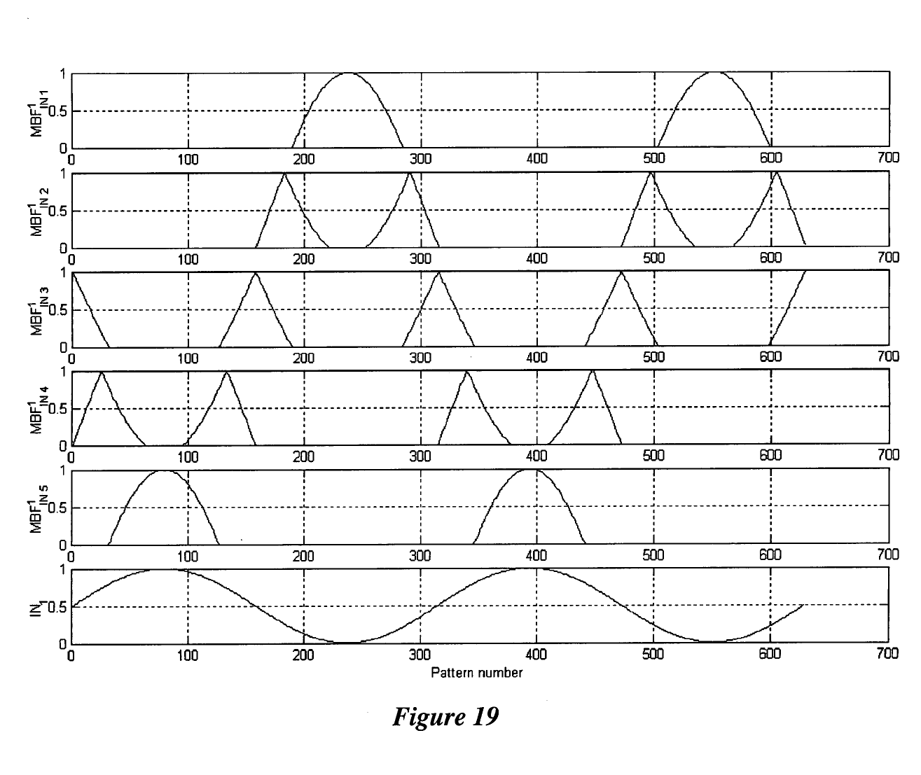

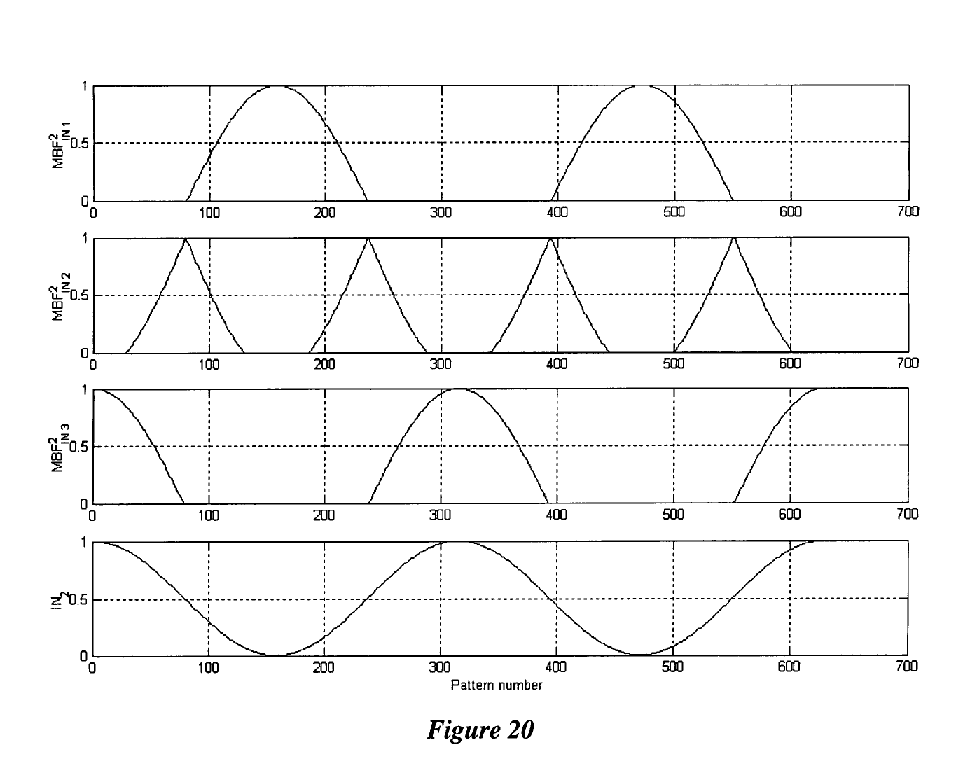

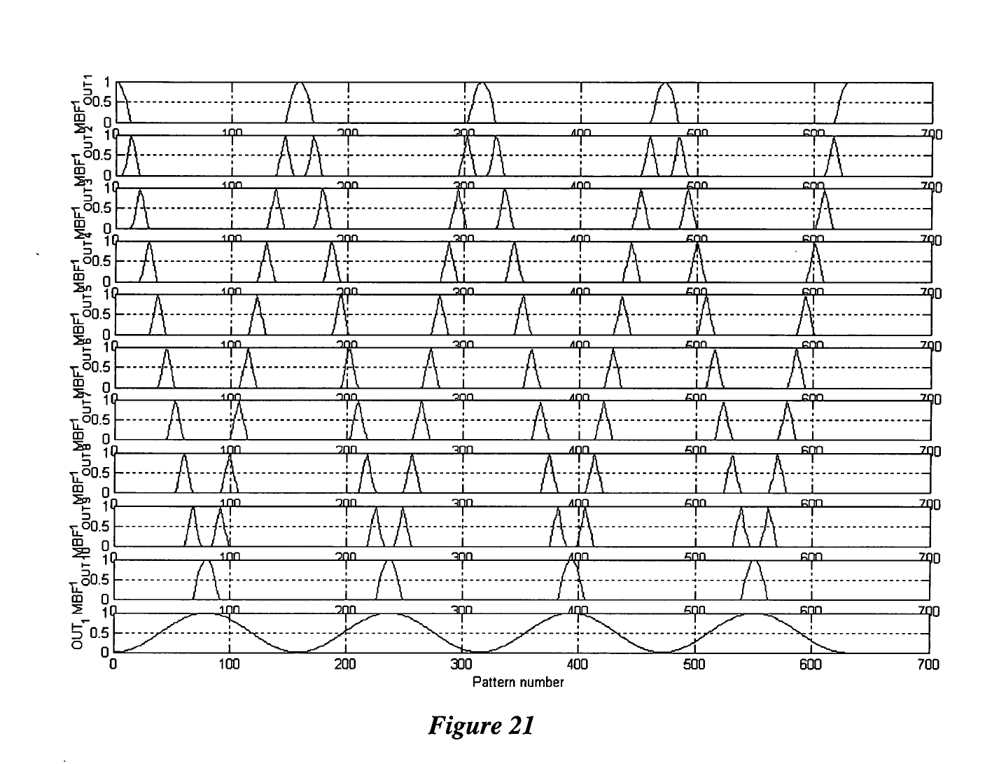

Results of the membership function optimization GA1 are shown in FIGS. 17 and 18. FIG. 17 shows results for input variables. FIG. 18 shows results for output variables. FIGS. 19-21 show the activation history of the membership functions presented in FIGS. 17 and 18. The lower graphs of FIGS. 19-21 are original signals, normalized into the interval [0, 1]

Optimal Rules Selection

The pre-selection algorithm selects the number of optimal rules and their premise structure prior optimization of the consequent part.

Consider the structure of the first fuzzy rule of the rule base
R¹(t)=IF x₁(t) is μ₁¹(x₁) AND x₁_{₂}(t) is μ₂¹(x₂) AND . . . AND xₘ(t) is μₘ¹(xₘ),
THEN y₁(t) is μₘ₊₁^{{l}^{ₘ₊₁}^{}}(y₁), Y₂(t) is μₘ₊₂^{{l}^{ₘ₊₂}^{}}(y₂), yₙ(t) is μₘ₊ₙ^{{l}^{ₘ₊ₙ}^{}}(yₙ)
Where:

m is the number of inputs;

n is the number of outputs;

xᵢ(t), i=1, . . . , m are input signals;

yⱼ(t), j=1, . . . , n are output signals;

μₖ^{l}^{ₖ} are membership functions of linguistic variables;

k=1, . . . , m+n are the indexes of linguistic variables;

lₖ=2, 3, . . . are the numbers of the membership functions of each linguistic variable;

μₖ^{{l}^{ₖ}^{}}—are membership functions of output linguistic variables, upper index;

{lₖ} means the selection of one of the possible indexes; and

t is a time stamp.

Consider the antecedent part of the rule:
R_{lN}¹(t)=IF x₁(t) is μ₁¹(x₁) AND xₗ_{₂}(t) is μ₂¹(x₂) AND . . . AND xₘ(t) is μₘ¹(xₘ)
The firing strength of the rule R¹ in the moment t is calculated as follows:
R_{ƒs}(t)=min [μ₁¹(x₁(t))), μ₂¹(x₂(t))), . . . , μₘ¹(xₘ(t))]
for the case of the min-max fuzzy inference, and as
R_{ƒs}¹(t)=Π[μ₁¹(t)), μ₂¹(x₂(t)), . . . , μₘ¹(xₘ(t))]
for the case of product-max fuzzy inference.

In general case, here can be used any of the T-norm operations.

The total firing strength R_{ƒs}¹ of the rule, the quantity R_{ƒs}¹(t) can be calculated as follows:

$${R}_{fs}^{1} = \frac{1}{T} {\int }_{t} {R}_{fs}^{1} ( t ) ⅆ t$$

for a continuous case, and:

$${R}_{fs}^{1} = \frac{1}{T} {\sum }_{t} {R}_{fs}^{1} ( t )$$

for a discrete case.

In a similar manner, the firing strength of each s-th rule is calculated as:

$${R}_{fs}^{s} = \frac{1}{N} {\int }_{t} {R}_{fs}^{s} ( t ) ⅆ t , \\ or \\ {R}_{fs}^{s} = \frac{1}{T} {\sum }_{t} {R}_{fs}^{s} ( t ) , \qquad ( 8.3 )$$

where

$$s = 1 , 2 , … , {\prod }_{i = 1}^{m} {l}_{i}$$

is a linear rule index

N—number of points in the teaching signal or maximum of t in continuous case.

In one embodiment, the local firing strength of the rule can be calculated in this case instead of integration, the maximum operation is taken in Eq. (8.3):

$${R}_{fs}^{s} = {max}_{t} {R}_{fs}^{s} ( t ) \qquad ( 8.4 )$$

In this case, the total strength of all rules will be:

$${R}_{fs} = {\sum }_{s = 1}^{{L}_{0}} {R}_{fs}^{s} ,$$

where:

$${L}_{0} = {\prod }_{k = 1}^{m} {l}_{k}$$

Number of rules in complete rule base

Quantity R_{ƒs} is important since it shows in a single value the integral characteristic of the rule base. This value can be used as a fitness function which optimizes the shape parameters of the membership functions of the input linguistic variables, and its maximum guarantees that antecedent part of the KB describes well the mutual behavior of the input signals. Note that this quantity coincides with the “horizontal relations,” introduced in the previous section, thus, it is optimized automatically by GA1.

Alternatively, if the structure of the input membership functions is already fixed, the quantities R_{ƒs}^{s} can be used for selection of the certain number of fuzzy rules. Many hardware implementations of FCs have limits that constrain, in one embodiment, the total possible number of rules. In this case, knowing the hardware limit L of a certain hardware implementation of the FC, the algorithm can select L≦L₀ of rules according to a descending order of the quantities R_{ƒs}^{s}. Rules with zero firing strength can be omitted.

It is generally advantageous to calculate the history of membership functions activation prior to the calculation of the rule firing strength, since the same fuzzy sets are participating in different rules. In order to reduce the total computational complexity, the membership function calculation is called in the moment t only if its argument x(t) is within its support. For Gaussian-type membership functions, support can be taken as the square root of the variance value σ^{2.}

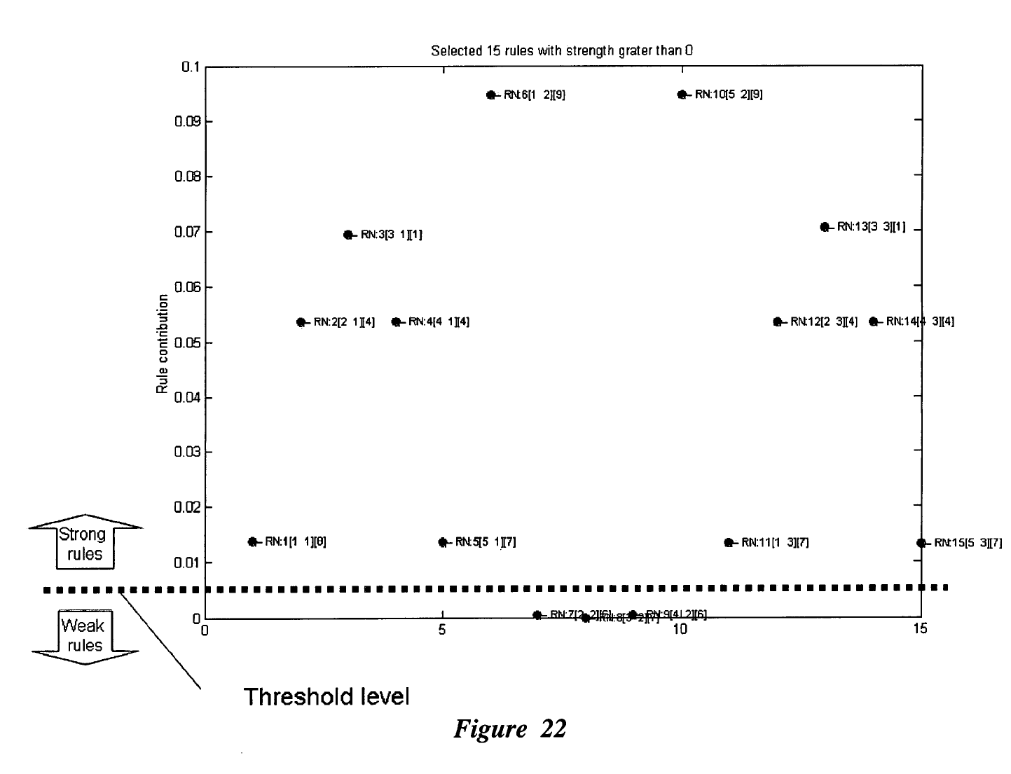

An example of the rule pre-selection algorithm is shown in FIG. 22, where the abscissa axis is an index of the rules, and the ordinate axis is a firing strength of the rule R_{ƒs}^{s}. Each point represents one rule. In this example, the KB has 2 inputs and one output. A horizontal line shows the threshold level. The threshold level can be selected based on the maximum number of rules desired, based on user inputs, based on statistical data and/or based on other considerations. Rules with relatively high firing strength will be kept, and the remaining rules are eliminated. As is shown in FIG. 22, there are rules with zero firing strength. Such rules give no contributions to the control, but may occupy hardware resources and increase computational complexity. Rules with zero firing strength can be eliminated by default. In one embodiment, the presence of the rules with zero firing strength may indicate the explicitness of the linguistic variables (linguistic variables contain too many membership functions). The total number of the rules with zero firing strength can be reduced during membership functions construction of the input variables. This minimization is equal to the minimization of the “vertical relations.”

This algorithm produces an optimal configuration of the antecedent part of the rules prior to the optimization of the rules. Optimization of the consequential part of KB can be applied directly to the optimal rules only, without unnecessary calculations of the “un-optimal rules”. This process can also be used to define a search space for the GA (GA2), which finds the output (consequential) part of the rule.

Optimal Selection of Consequental Part of KB with GA2

A chromosome for the GA2 which specifies the structure of the output part of the rules can be defined as:
[I₁, . . . , I_{M}], Iᵢ=[I₁, . . . , Iₙ], Iₖ={1, . . . , l_{Y}_{ₖ}}, k=1, . . . , n
where:

Iᵢ are groups of genes which code single rule;

Iₖ are indexes of the membership functions of the output variables;

n is the number of outputs; and

M is the number of rules.

In one embodiment, the history of the activation of the rules can be associated with the history of the activations of membership functions of output variables or with some intervals of the output signal in the Sugeno fuzzy inference case. Thus, it is possible to define which output membership functions can possibly be activated by the certain rule. This allows reduction of the alphabet for the indexes of the output variable membership functions from {{1, . . . , l_{Y}_{₁}}, . . . , {1, . . . , l_{Y}_{ₙ}}}ⁿ to the exact definition of the search space of each rule:
{l^{min}^{Y}_{₁}, . . . l^{max}_{Y}_{₁}}₁, . . . , {l^{min}_{Y}_{ₙ}, . . . , l^{max}_{Y}_{ₙ}}₁, . . . , {l^{min}_{Y}_{₁}, . . . , l^{max}_{Y}₁}_{N}, . . . , {l^{min}_{Y}_{ₙ}, . . . , l^{max}_{Y}_{ₙ}}_{N}

Thus the total search space of the GA is reduced. In cases where only one output membership function is activated by some rule, such a rule can be defined automatically, without GA2 optimization.

In one embodiment, for a Sugeno 0 order FIS, instead of indexes of output membership functions, corresponding intervals of the output signals can be taken as a search space.

For some combinations of the input-output pairs of the teaching signal, the same rules and the same membership functions are activated. Such combinations are uninteresting from the rule optimization view point, and hence, can be removed from the teaching signal, reducing the number of input-output pairs, and as a result total number of calculations. The total number of points in the teaching signal (t), in this case, will be equal to the number of rules plus the number of conflicting points (points when the same inputs result in different output values).

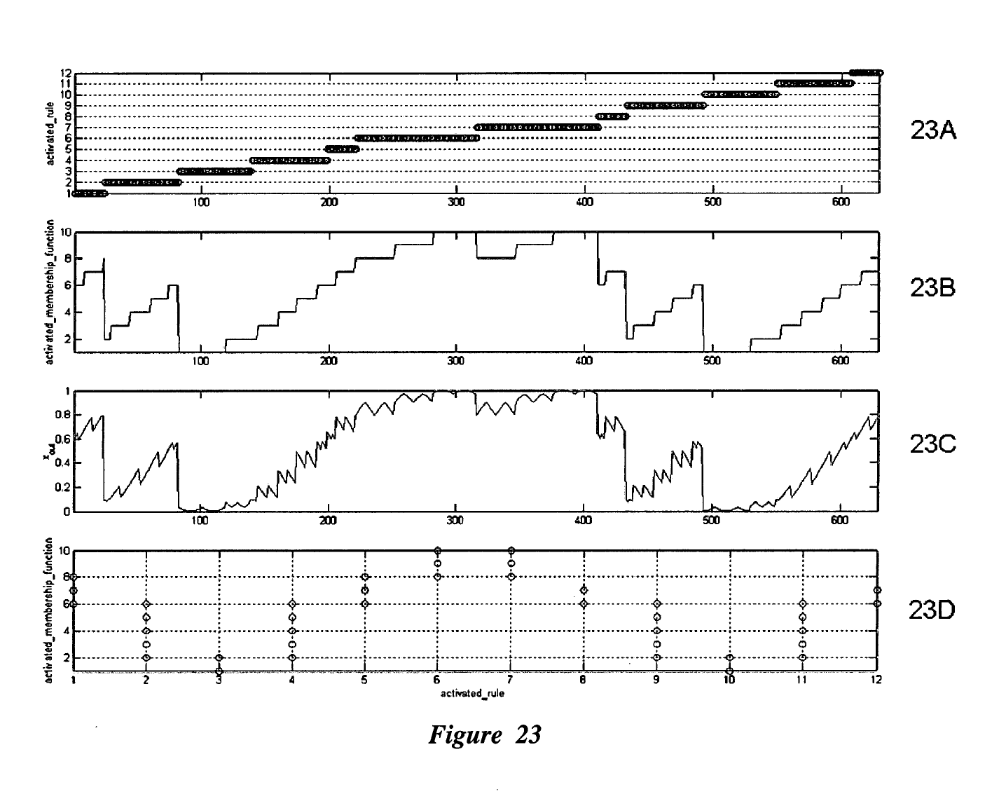

FIG. 23A shows the ordered history of the activations of the rules, where the Y-axis corresponds to the rule index, and the X-axis corresponds to the pattern number (t). FIG. 23B shows the output membership functions, activated in the same points of the teaching signal, corresponding to the activated rules of FIG. 23A. Intervals when the same indexes are activated in FIG. 23B are uninteresting for rule optimization and can be removed. FIG. 23C shows the corresponding output teaching signal. FIG. 23D shows the relation between rule index, and the index of the output membership functions it may activate. From FIG. 23D one can obtain the intervals [l^{min}_{T}_{ᵢ}, l^{max}_{Y}_{ᵢ}]^{j}, j=1, . . . , N where j is the rule index, for example if j=1, l^{min}_{Y}_{₁}=6, lₘₐₓ_{Y}_{₁}=8.

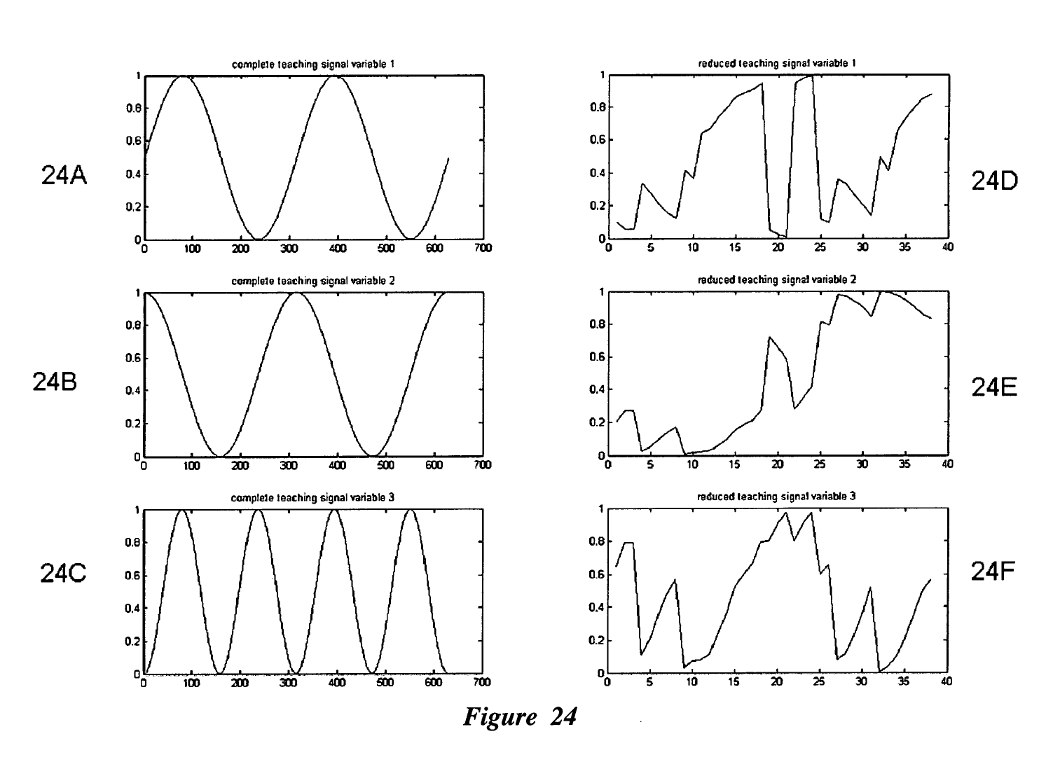

FIGS. 24A-F show plots of the teaching signal reduction using analysis of the possible rule configuration for three signal variables. FIGS. 24A-C show the original signals. FIGS. 24D-F show the results of the teaching signal reduction using the rule activation history. The number of points in the original signal is about 600. The number of points in reduced teaching signal is about 40. Bifurcation points of the signal, as shown in FIG. 23B are kept.

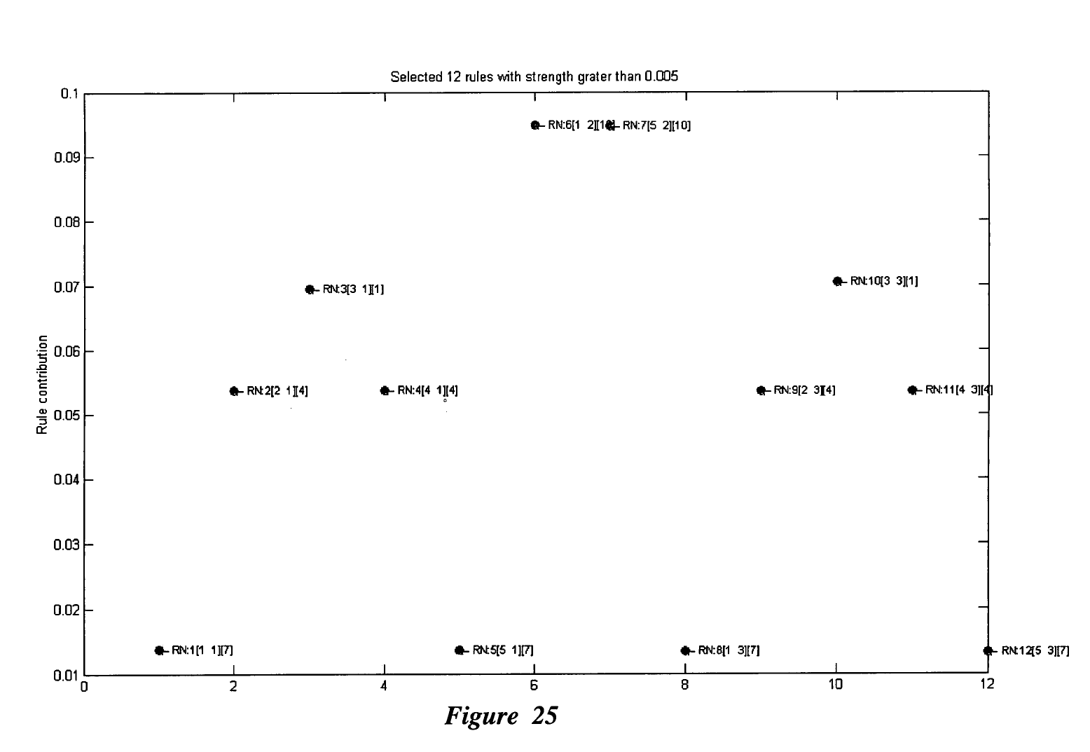

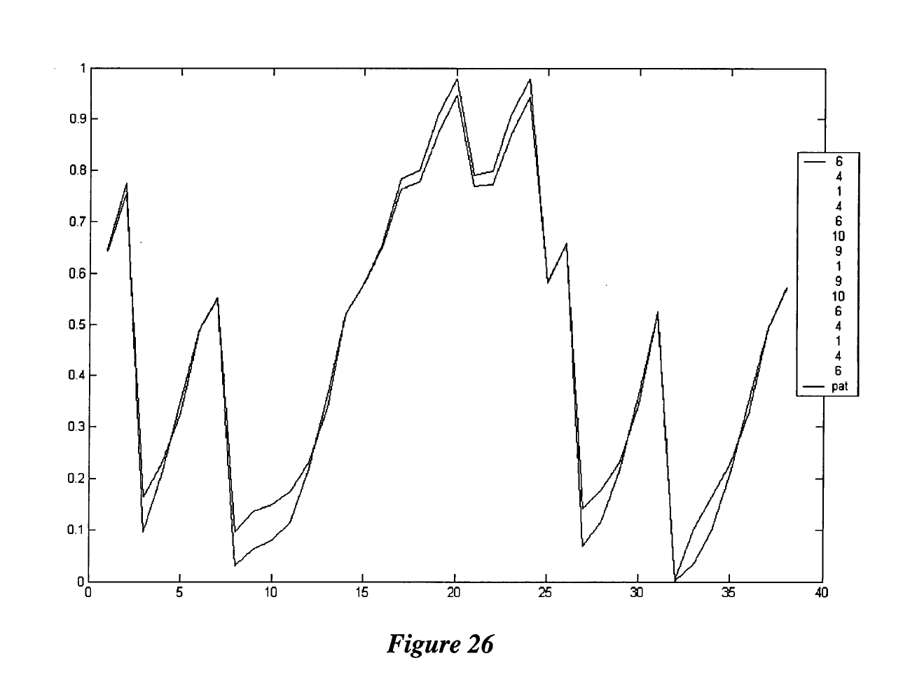

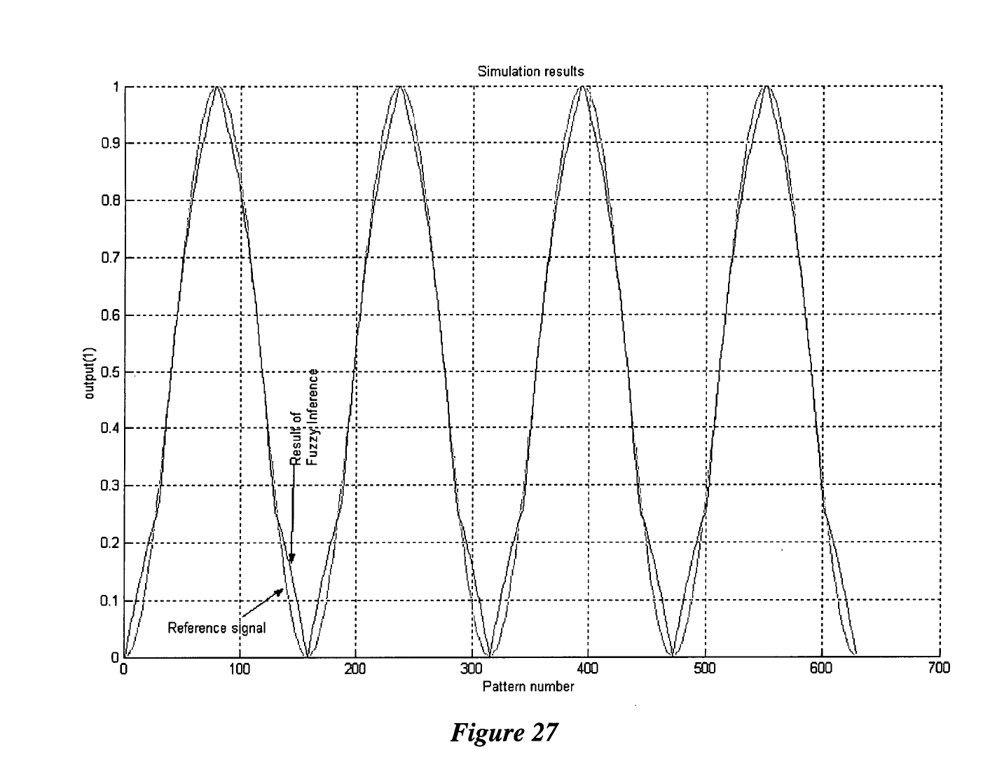

FIG. 25 is a diagram showing rule strength versus rule number for 12 selected rules after GA2 optimization. FIG. 26 shows approximation results using a reduced teaching signal corresponding to the rules from FIG. 25. FIG. 27 shows the complete teaching signal corresponding to the rules from FIG. 25.

Fitness Evaluation is GA2

The previous section described optimization of the FIS, without the details into the type of FIS selection. In one embodiment, the fitness function used in the GA2 depends, at least in part, on the type of the optimized FIS. Examples of fitness functions for the Mamdani, Sugeno and/or Tsukamoto FIS models are described herein. One of ordinary skill in the art will recognize that other fuzzy models can be used as well.

Define error E^{p} as a difference between the output part of teaching signal and the FIS output as:

$${E}^{p} = \frac{1}{2} {( {d}^{p} - F ( {x}_{1}^{p} , {x}_{2}^{p} , … , {x}_{n}^{p} ) )}^{2}$$

$$and$$

$$E = {\sum }_{p} {E}^{p} ,$$

where x₁^{p},x₂^{p}, . . . ,xₙ^{P} and d^{p} are values of input and output variables in the p training pair, respectively. The function F(x₁^{p},x₂^{p}, . . . ,xₙ^{p}) is defined according to the chosen FIS model.
Mamdani Model

For the Mamdani model, the function F(x₁^{p},x₂^{p}, . . . ,xₙ^{p}) is defined as:

$$F ( {x}_{1} , … , {x}_{n} ) = \frac{{\sum }_{l = 1}^{M} {\overline{y}}^{l} {\prod }_{i = 1}^{n} {μ}_{{j}_{i}}^{l} ( {x}_{i} )}{{\sum }_{l = 1}^{M} {\prod }_{i = 1}^{n} {μ}_{{j}_{i}}^{l} ( {x}_{i} )} = \frac{{\sum {\overline{y}}^{l} {z}^{l}}_{l = 1}^{M}}{{\sum }_{i = 1}^{M} {z}^{l}} , \qquad ( 8.5 )$$

where

$${z}^{l} = {\prod }_{i = 1}^{n} {μ}_{{j}_{i}}^{l} ( {x}_{i} )$$

and \overline{y}^{l} is the point of maximum value (called also as a central value) of μ_{y}^{l}(y), Π denotes the selected T-norm operation.
Sugeno Model Generally

Typical rules in the Sugeno fuzzy model can be expressed as follows:
IF x₁ is μ^{(l)}ⱼ_{₁}(x₁) AND x₂ is μ^{(l)}ⱼ_{₂}(x₂) AND . . . AND xₙ is μ^{(l)}ⱼ_{ₙ}(xₙ)
THEN y=ƒ^{l}(x₁, . . . ,xₙ),
where l=1,2, . . . , M—the number of fuzzy rules M defined as {number of membership functions of x₁ input variable}x {number of membership functions of x₂ input variable}× . . . ×{number of membership functions of xₙ input variable}.

The output of Sugeno FIS is calculated as follows:

$$F ( {x}_{1} , {x}_{2} , … , {x}_{n} ) = \frac{{\sum }_{l = 1}^{M} {f}^{l} {\prod }_{i = 1}^{n} {μ}_{{j}_{i}}^{l} ( {x}_{i} )}{{\sum }_{l = 1}^{M} {\prod }_{i = 1}^{n} {μ}_{{j}_{i}}^{l} ( {x}_{i} )} . \qquad ( 8.6 )$$

First-Order Sugeno Model

Typical rules in the first-order Sugeno fuzzy model can be expressed as follows:
IF x₁ is μ^{(l)}ⱼ_{₁}(x₁) AND x₂ is μ^{(l)}ⱼ_{₂}(x₂) AND . . . AND xₙ is μ^{(l)}ⱼ_{ₙ}(xₙ)
THEN y=ƒ^{l}(x₁, . . . ,xₙ)=p₁^{(l)}x₁+p₂^{(l)}x₂+ . . . pₙ^{(l)}xₙ+r^{(l)},
(Output variables described by some polynomial functions.)
The output of Sugeno FIS is calculated according equation (8.6).
Zero-Order Sugeno Model

Typical rules in the zero-order Sugeno FIS can be expressed as follows:
IF x₁ is μ^{(l)}ⱼ_{₁}(x₁) AND x₂ is μ^{(l)}ⱼ_{₂}(x₂) AND . . . AND xₙ is μ^{(l)}ⱼ_{ₙ}(xₙ)
THEN y=r^{(l)},
The output of zero-order Sugeno FIS is calculated as follows

$$F ( {x}_{1} , {x}_{2} , … , {x}_{n} ) = \frac{{\sum }_{l = 1}^{M} {r}^{l} {\prod }_{i = 1}^{n} {μ}_{{j}_{i}}^{l} ( {x}_{i} )}{{\sum }_{l = 1}^{M} {\prod }_{i = 1}^{n} {μ}_{{j}_{i}}^{l} ( {x}_{i} )} \qquad ( 8.7 )$$

Tsukamoto Model

The typical rule in the Tsukamoto FIS is:
IF x₁ is μ^{(l)}ⱼ_{₁}(x₁) AND x₂ is μ^{(l)}ⱼ_{₂}(x₂) AND . . . AND xₙ is μ^{(l)}ⱼ_{ₙ}(xₙ)
THEN y is μₖ^{(l)}(y),

where j₁ ∈Iₘ_{₁} is the set of membership functions describing linguistic values of x₁ input variable; j₂∈Iₘ_{₂} is the set of membership functions describing linguistic values of x₂ input variable; and so on, jₙ∈Iₘ_{ₙ} is the set of membership functions describing linguistic values of xₙ input variable; and k∈O is the set of monotonic membership functions describing linguistic values of y output variable.

The output of the Tsukamoto FIS is calculated as follows:

$$F ( {x}_{1} , … , {x}_{n} ) = \frac{{\sum }_{l = 1}^{M} {y}^{l} {\prod }_{i = 1}^{n} {μ}_{{j}_{i}}^{l} ( {x}_{i} )}{{\sum }_{l = 1}^{M} {\prod }_{i = 1}^{n} {μ}_{{j}_{i}}^{l} ( {x}_{i} )} = \frac{{\sum }_{l = 1}^{M} {y}^{l} {z}^{l}}{{\sum }_{l = 1}^{M} {z}^{l}} , \\ where {z}^{l} = {\prod }_{i = 1}^{n} {μ}_{{j}_{i}}^{l} ( {x}_{i} ) and {z}^{l} = {μ}_{k}^{( l )} ( {y}^{l} ) \qquad ( 8.8 )$$

Refinement of the KB Structure with GA

Stage 4 described above generates a KB with required robustness and performance for many practical control system design applications. If performance of the KB generated in Stage 4 is, for some reason, insufficient, then the KB refinement algorithm of Stage 5 can be applied.

In one embodiment, the Stage 5 refinement process of the KB structure is realized as another GA (GA3), with the search space from the parameters of the linguistic variables. In one embodiment, the chromosome of GA3 can have the following structure:

{[Δ₁,Δ₂,Δ₃]}^{L};Δᵢ∈[−prmᵢ^{j},1−prmᵢ^{j}];i=1,2,3;j=1,2, . . . , L, where L is the total number of the membership functions in the system In this case, the quantities Δᵢ are modifiers of the parameters of the corresponding fuzzy set, and the GA3 finds these modifiers according to the fitness function as a minimum of the fuzzy inference error. In such an embodiment, the refined KB has the parameters of the membership functions obtained from the original KB parameters by adding the modifiers prm_{new}ᵢ=prmᵢ+Δᵢ.

Different fuzzy membership function can have the same number of parameters, for example Gaussian membership functions have two parameters, as a modal value and variance. Iso-scalene triangular membership functions also have two parameters. In this case, it is advantageous to introduce classification of the membership functions regarding the number of parameters, and to introduce to GA3 the possibility to modify not only parameters of the membership functions, but also the type of the membership functions, form the same class. Classification of the fuzzy membership functions regarding the number of parameters is presented in the Table 4.

TABLE 4
Class

| One | Two | Three | Four |
|---|---|---|---|
| parametric | parametric | parametric | parametric |
| Crisp | Gaussian | Non symmetric | Trapezoidal |
| | Isosceles triangular | Gaussian | Bell |
| | Descending linear | Triangular | |
| | Ascending linear | | |
| | Descending Gaussian | | |
| | Ascending Gaussian | | |

GA3 improves fuzzy inference quality in terms of the approximation error, but may cause over learning, making the KB too sensitive to the input. In one embodiment, a fitness function for rule base optimization is used. In one embodiment, an information-based fitness function is used. In another embodiment, the fitness function used for membership function optimization in GA1 is used. To reduce the search space, the refinement algorithm can be applied only to some selected parameters of the KB. In one embodiment, refinement algorithm can be applied to selected linguistic variables only.

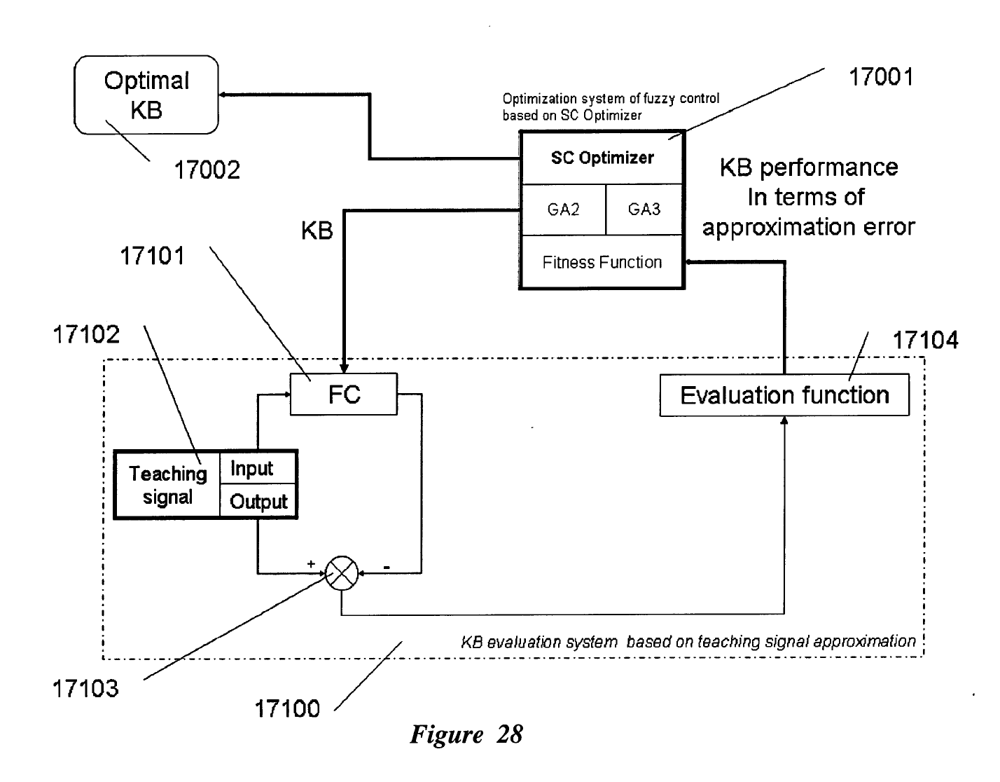

The structure realizing evaluation procedure of GA2 or GA3 is shown in FIG. 28. In FIG. 28, the SC optimizer 17001 sends the KB structure presented in the current chromosome of GA2 or of GA3 to FC 17101. An input part of the teaching signal 17102 is provided to the input of the FC 17101. The output part of the teaching signal is provided to the positive input of adder 17103. An output of the FC 17101 is provided to the negative input of adder 17103. The output of adder 17103 is provided to the evaluation function calculation block 17104. Output of evaluation function calculation block 17104 is provided to a fitness function input of the SC optimizer 17001, where an evaluation value is assigned to the current chromosome.

In one embodiment, evaluation function calculation block 17104 calculates approximation error as a weighted sum of the outputs of the adder 17103.

In one embodiment, evaluation function calculation block 17104 calculates the information entropy of the normalized approximation error.

Optimization of KB Based on Suspension System Response

In one embodiment of Stages 4 and 5, the fitness function of GA can be represented as some external function Fitness=ƒ(KB), which accepts as a parameter the KB and as output provides KB performance. In one embodiment, the function ƒ includes the model of an actual suspension system controlled by the system with FC. In this embodiment, the suspension system model in addition to suspension system dynamics provides for the evaluation function.

In one embodiment, function ƒ might be an actual suspension system controlled by an adaptive P(I)D controller with coefficient gains scheduled by FC and measurement system provides as an output some performance index of the KB.

In one embodiment, the output of the suspension system provides data for calculation of the entropy production rate of the suspension system and of the control system while the suspension system is controlled by the FC with the structure from the KB.

In one embodiment, the evaluation function is not necessarily related to the mechanical characteristics of the motion of the suspension system (such as, for example, in one embodiment control error) but it may reflect requirements from the other viewpoints such as, for example, entropy produced by the system, or harshness and or bad feelings of the operator expressed in terms of the frequency characteristics of the suspension system dynamic motion and so on.

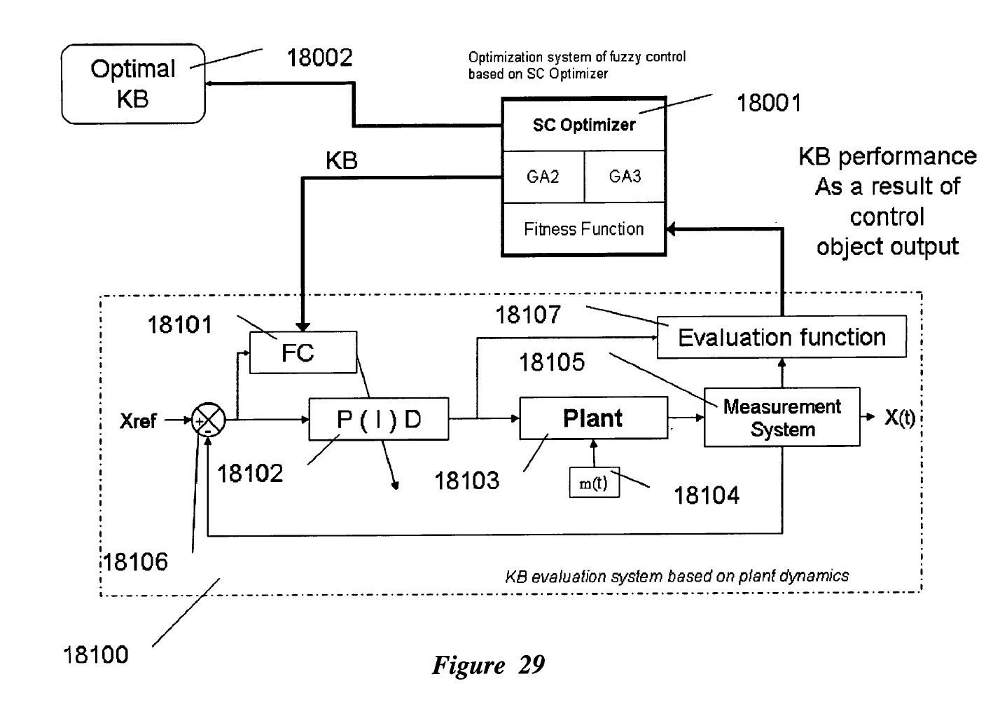

FIG. 29 shows one embodiment, the structure-realizing KB evaluation system based on suspension system dynamics. In FIG. 29, the SC optimizer 18001 provides the KB structure presented in the current chromosome of the GA2 or of the GA3 to the FC 18101. The FC is embedded into the KB evaluation system based on suspension system dynamics 18100. The KB evaluation system based on suspension system dynamics 18100 includes the FC 18101, an adaptive P(I)D controller 18102 which uses the FC 18101 as a scheduler of the coefficient gains, a suspension system 18103, a stochastic excitation generation system 18104, a measurement system 18105, an adder 18106, and an evaluation function calculation block 18107. An output of the P(I)D controller 18102 is provided as a control force to the suspension system 18103 and as a first input to the evaluation function calculation block 18107. Output of the excitation generation system 18104 is provided to the Suspension system 18103 to simulate an operational environment. An output of the Suspension system 18103 is provided to the measurement system 18105. An output of the measurement system 18105 is provided to the negative input of the adder 18106 and together with the reference input Xref forms in adder 18106 control error which is provided as an input to the P(I)D controller 18102 and to the FC 18101. An output of the measurement system 18105 is provided as a second input of the evaluation function calculation block 18107. The evaluation function calculation block 18107 forms the evaluation function of the KB and provides it to the fitness function input of SC optimizer 18001. Fitness function block of SC optimizer 18001 ranks the evaluation value of the KB presented in the current chromosome into the fitness scale according to the current parameters of the GA2 or of the GA3.

In one embodiment, the evaluation function calculation block 18107 forms evaluation function as a minimum of the entropy production rate of the suspension system 18103 and of the P(I)D controller 18102.

In one embodiment, the evaluation function calculation block 18107 applies Fast Fourier Transformation on one or more outputs of the measurement system 18105, to extract one or more frequency characteristics of the suspension system output for the evaluation.

In one embodiment, the KB evaluation system based on suspension system dynamics 18100 uses a nonlinear model of the suspension system 18103.

In one embodiment, the KB evaluation system based on suspension system dynamics 18100 is realized as an actual suspension system with one or more parameters controlled by the adaptive P(I)D controller 18102 with control gains scheduled by the FC 18101.

In one embodiment, suspension system 18103 is a stable suspension system.

In one embodiment, suspension system 18103 is an unstable suspension system.

The output of the SC optimizer 18001 is an optimal KB 18002.

Teaching Signal Acquisition

In the previous sections it was stated that the SC optimizer 242 uses as an input the teaching signal which contains the suspension system response for the optimal control signal. One embodiment of teaching signal acquisition is described in connection with FIG. 9.

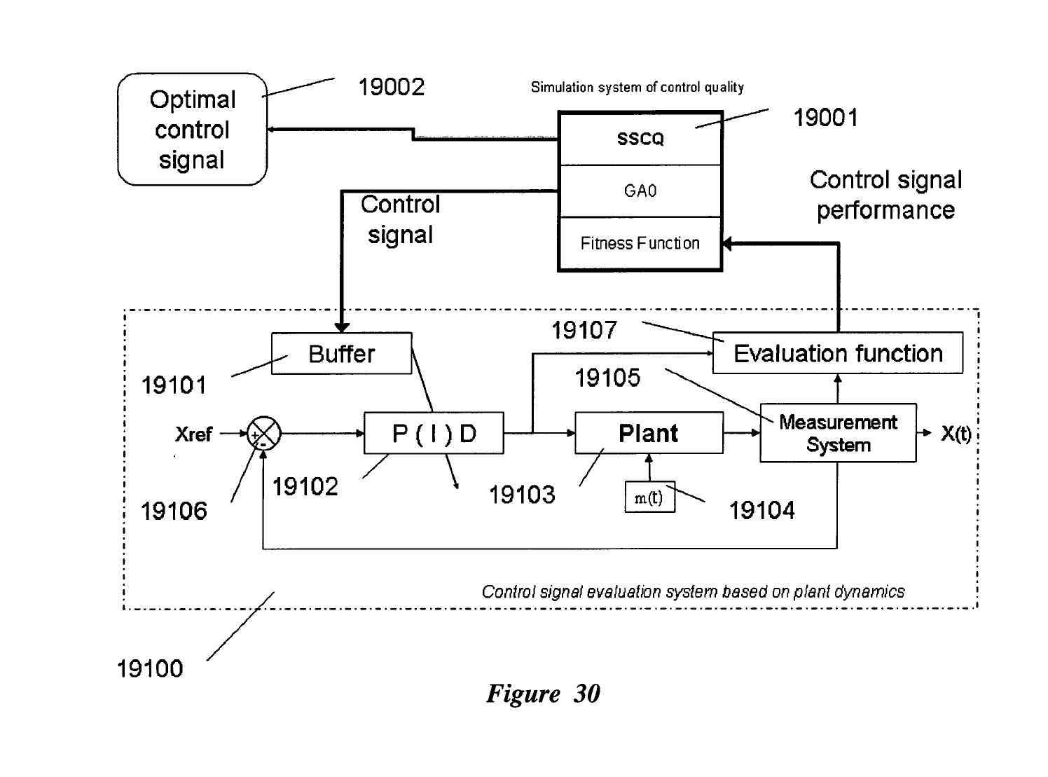

FIG. 30 shows optimal control signal acquisition. FIG. 30 is an embodiment of the system presented in FIGS. 2 and 3, where the FLCS 140 is omitted and the suspension system 120 is controlled by the P(I)D controller 150 with coefficient gains scheduled directly by the SSCQ 130.

The structure presented in FIG. 30 contains an SSCQ 19001, which contains a GA (GA0). The chromosomes in the GA0 contain the samples of coefficient gains as {kₚ,k_{D},kₗ}^{N}. The number of samples N corresponds with the number of lines in the future teaching signal. Each chromosome of the GA0 is provided to a Buffer 19101 which schedules the P(I)D controller 19102 embedded into the control signal evaluation system based on suspension system dynamics 19100.

The control signal evaluation system based on suspension system dynamics 19100 includes the buffer 19101, the adaptive P(I)D controller 19102 which uses Buffer 19101 as a scheduler of the coefficient gains, the suspension system 19103, the stochastic excitation generation system 19104, the measurement system 19105, the adder 19106, and the evaluation function calculation block 19107. Output of the P(I)D controller 19102 is provided as a control force to the suspension system 19103 and as a first input to the evaluation function calculation block 19107. Output of the excitation generation system 19104 is provided to the Suspension system 19103 to simulate an operational environment. An output of Suspension system 19103 is provided to the measurement system 19105. An output of the measurement system 19105 is provided to the negative input of the adder 19106 and together with the reference input Xref forms in adder 19106 control error which is provided as an input to P(I)D controller 19102. An output of the measurement system 19105 is provided as a second input of the evaluation function calculation block 19107. The evaluation function calculation block 19107 forms the evaluation function of the control signal and provides it to the fitness function input of the SSCQ 19001. The fitness function block of the SSCQ 19001 ranks the evaluation value of the control signal presented in the current chromosome into the fitness scale according to the current parameters of the GAO.

An output of the SSCQ 19001 is the optimal control signal 19002.

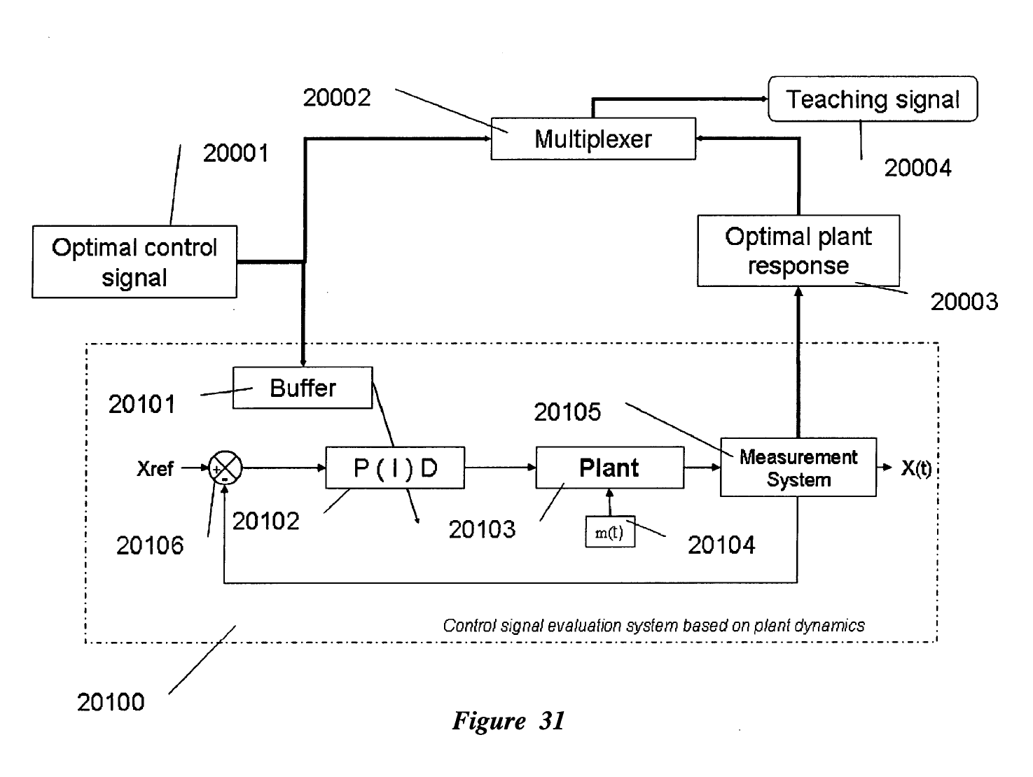

In one embodiment, the teaching for the SC optimizer 242 is obtained from the optimal control signal 19002 as shown in FIG. 31. In FIG. 31, the optimal control signal 20001 is provided to the buffer 20101 embedded into the control signal evaluation system based on suspension system dynamics 20100 and as a first input of the multiplexer 20001. Control signal evaluation system based on suspension system dynamics 20100 includes a buffer 20101, an adaptive P(I)D controller 20102 which uses the buffer 20101 as a scheduler of the coefficient gains, a suspension system 20103, a stochastic excitation generation system 20104, a measurement system 20105 and an adder 20106. On output of the P(I)D controller 20102 is provided as a control force to the suspension system 20103. An output of the excitation generation system 20104 is provided to the suspension system 20103 to simulate an operational environment. An output of suspension system 20103 is provided to the measurement system 29105. An output of the measurement system 20105 is provided to the negative input of the adder 20106 and together with the reference input Xref forms in adder 20106 control error which is provided as an input to P(I)D controller 20102. An output of the measurement system 20105 is the optimal suspension system response 20003. The optimal suspension system response 20003 is provided to the multiplexer 20002. The multiplexer 20002 forms the teaching signal by combining the optimal suspension system response 20003 with the optimal control signal 20001. The output of the multiplexer 20002 is the optimal teaching signal 20004, which is provided as an input to the SC optimizer 242.

In one embodiment, optimal suspension system response 20003 can be transformed in a manner that provides better performance of the final FIS.

In one embodiment, high and/or low and/or band pass filter is applied to the measured optimal suspension system response 20003 prior to optimal teaching signal 20004 formation.

In one embodiment, detrending and/or differentiation and/or integration operation is applied to the measured optimal suspension system response 20003 prior to optimal teaching signal 20004 formation.

In one embodiment, other operations which the person skill of art may provide is applied to the measured optimal suspension system response 20003 prior to optimal teaching signal 20004 formation.

Comparison Between Back Propagation FNN and SC Optimizer Control Results.

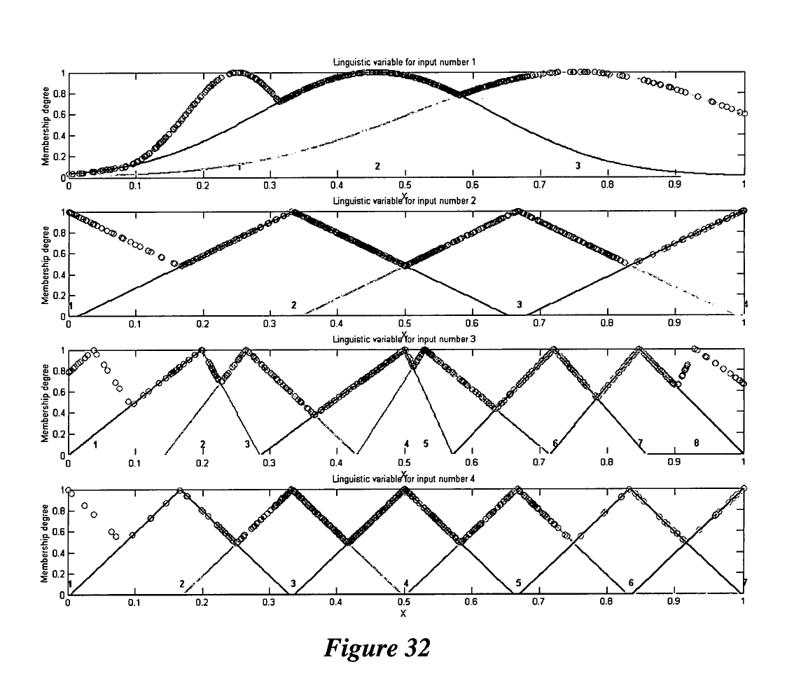

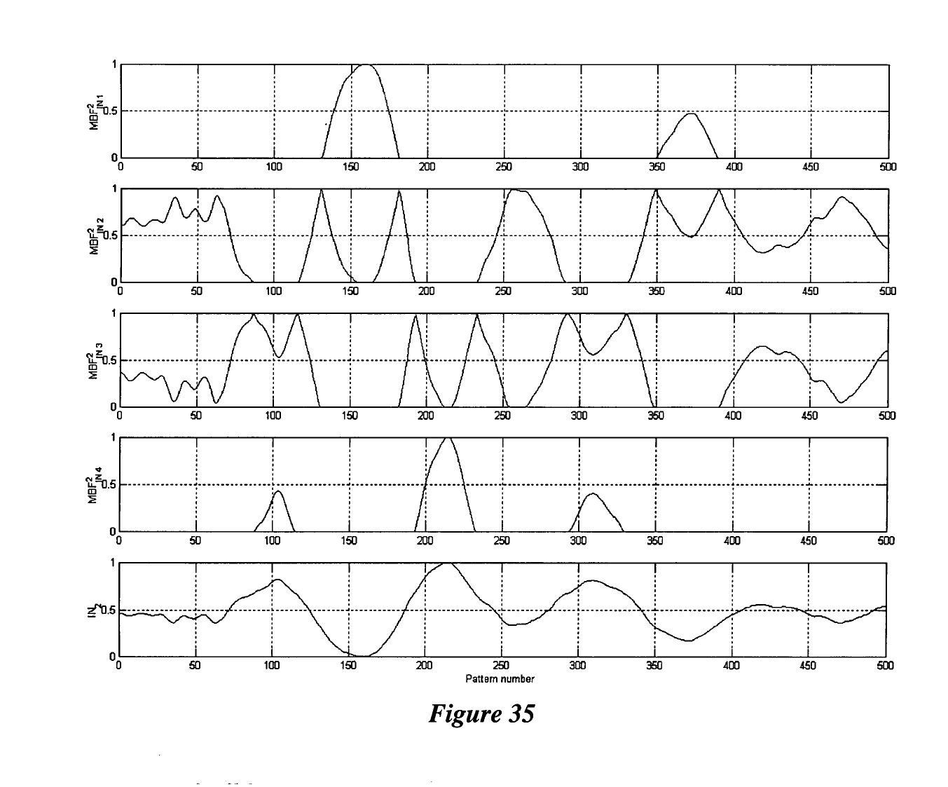

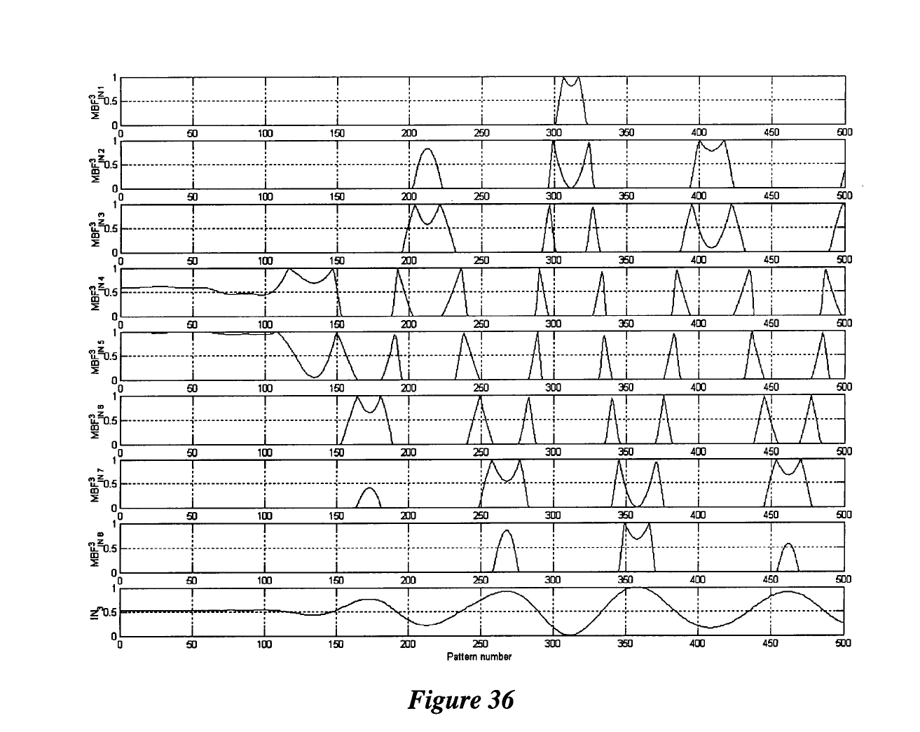

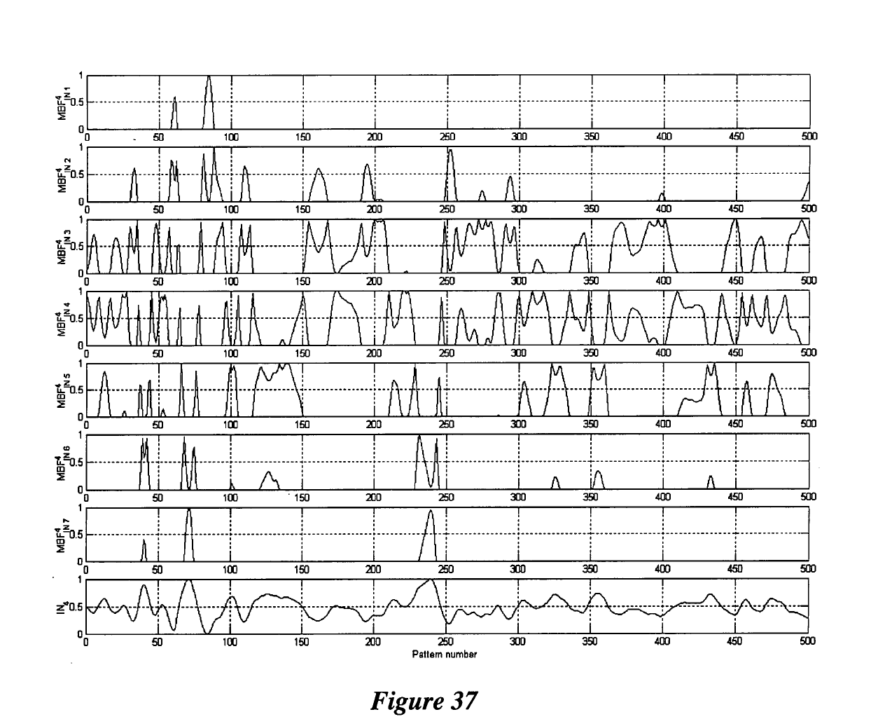

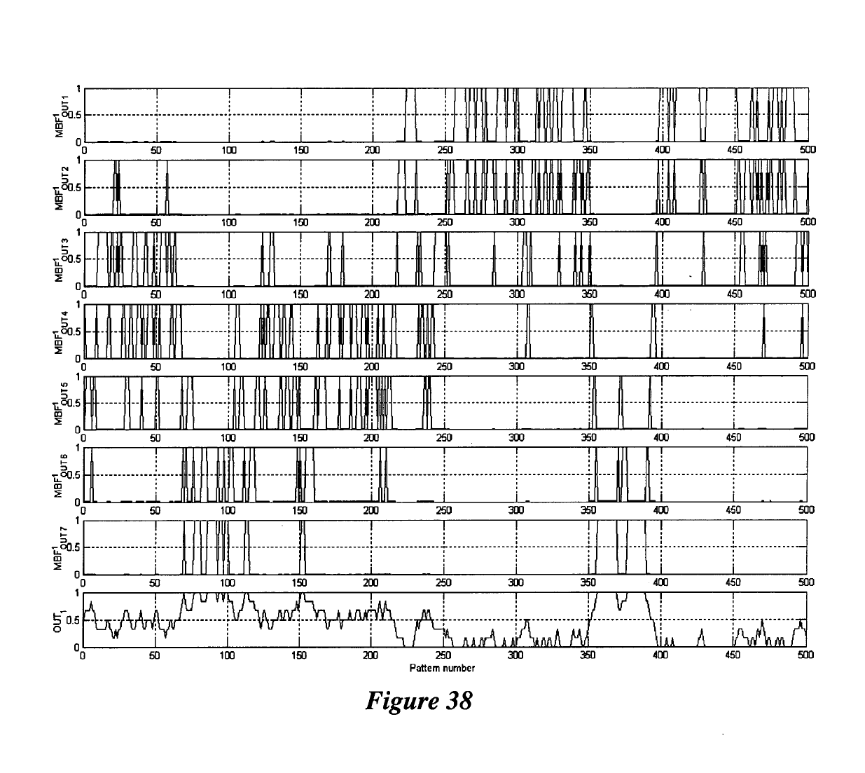

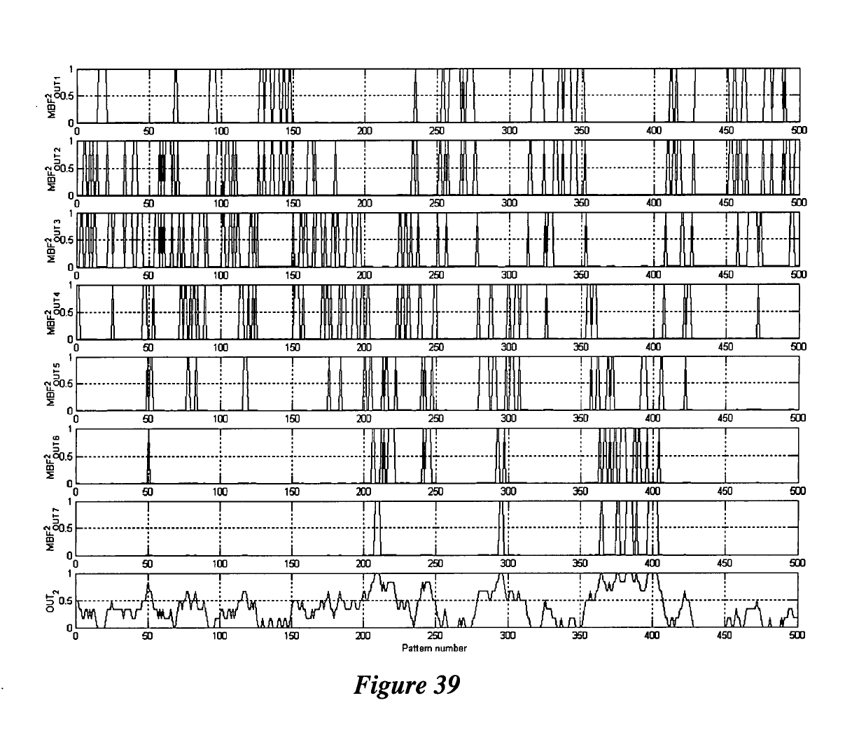

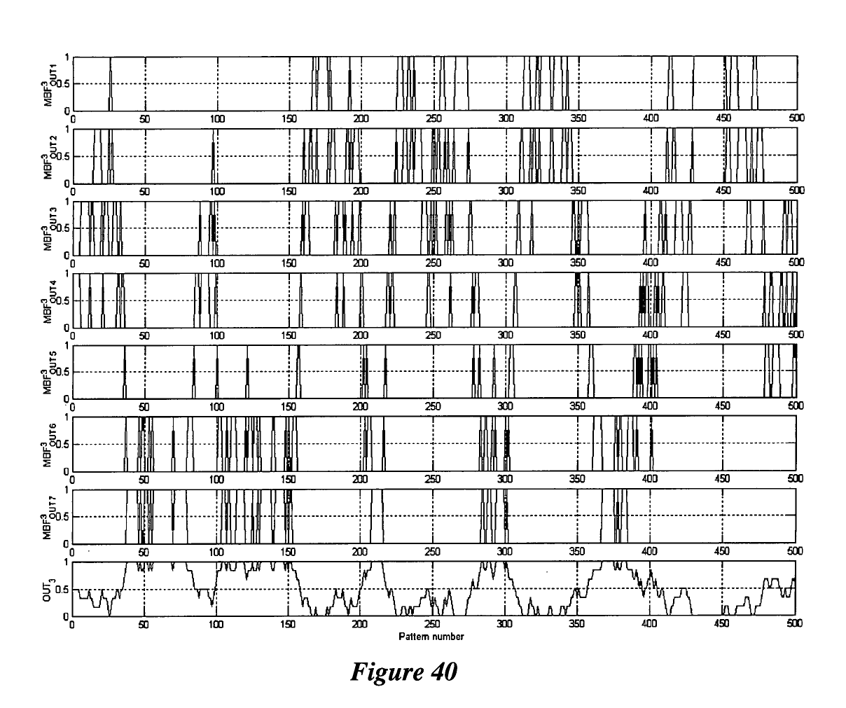

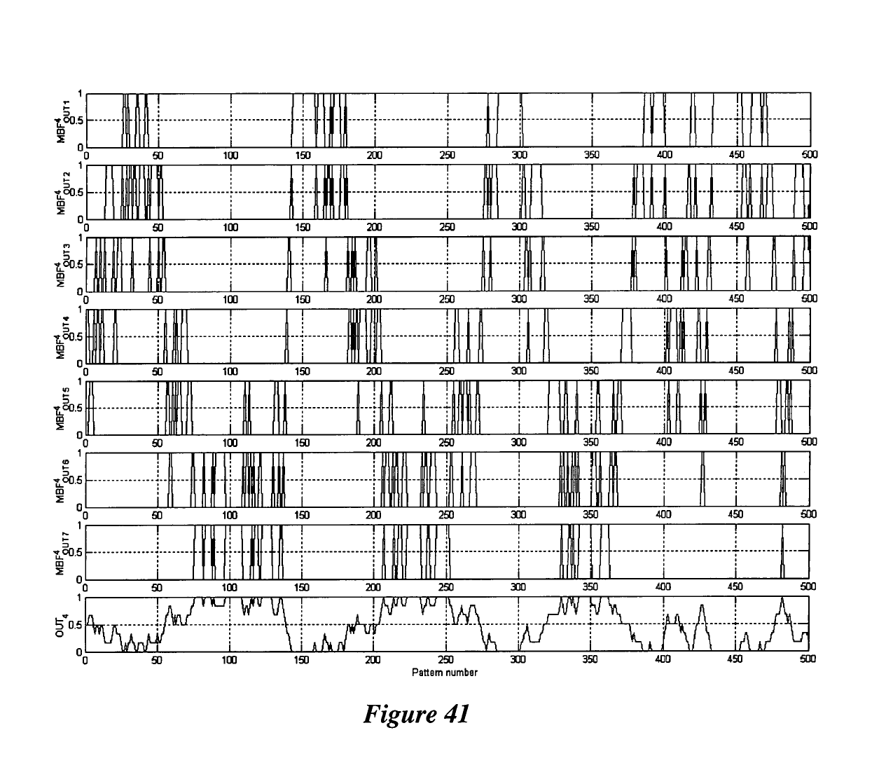

FIGS. 32-50 shows one example of the approximation of a teaching signal used for the control of a suspension system. The teaching signal acquisition algorithm is presented in the application on a GA controller with Step Constraints.

Many controlled plants must be moved from one control state to another control state in a stepwise fashion. For example, a stepping motor moves by stepping in controlled increments and cannot be arbitrarily moved from a first shaft position to a second shaft position without stepping through all shaft positions in between the first shaft position and the second shaft position.

In one embodiment, a Genetic Algorithm with step-coded chromosomes is used to develop a teaching signal that provides good control qualities for a controller with discrete constraints, such as, for example, a step-constrained controller. The step-coded chromosomes are chromosomes where at least a portion of the chromosome is constrained to a stepwise alphabet. The step-coded chromosome can also have portion which are position coded (i.e., coded in a relatively more continuous manner that is not stepwise constrained).

Every electromechanical control system has a certain time delay, which is usually caused by the analog to digital conversion of the sensor signals, computation of the control gains in the computation unit, by mechanical characteristics of the control actuator, and so on. Additionally, many control units do not have continuous characteristics. For example, when the control actuators are step motors, such step motors can change only one step up or one step down during a control cycle. From an optimization point of view, such a stepwise constraint can constrain the search space of the genetic algorithm 131 in the SSCQ 130. In other words, to control a step-motor with N positions, it is not necessary to check all the possible N positions each time the stepper motor position is updated. It is enough to check only the cases when the stepper motor position is going change one step up, one step down, or hold position. This gives only 3 possibilities, and thus, reduces the search space from the size of N points to three points. Such reduction of the search space will lead to better performance of the genetic algorithm 131, and thus, will lead to better overall performance of the intelligent control system.

As described above, the SSCQ 130 can be used to perform optimal control of different kinds of nonlinear dynamic systems, when the control system unit is used to generate discrete impulses to the control actuator, which then increases or decreases the control coefficients depending on the specification of the control actuator (such as, for example, the actuators in the dampers 801-804).

Without loss of generality, the conventional PID controller 150 in the control system 100 (shown in FIG. 1) can be a PID controller 350 with discrete constraints. This type of control is called step-constraint control. In one embodiment, the structure of the SSCQ 130 for step-constraint control is modified by the addition of constraints to the PID controllers 1034 and 1050. Moreover, the PID controllers in the SSCQ 130 are constrained by discrete constraints and at least a portion of the chromosomes of the GA 231 in the SSCQ 130 are step-coded rather than position-coded. In the case of step-constrained control, the SSCQ buffers 2301 and 2301 have the structure presented in the Table 5 below, and can be realized by a new coding method for discrete constraints in the GA 131.

TABLE 5

| | |
|---|---|
| Time* | CGS |

| | | | |
|---|---|---|---|
| T | STEPₚ(T)** | STEP_{I}(T) | STEP_{D}(T) |
| T + T^{c} | STEPₚ(T + T^{c}) | STEP_{I}(T + T^{c}) | STEP_{D}(T + T^{c}) |
| . . . | . . . | . . . | . . . |
| T + T^{e} | STEPₚ(T + T^{e}) | STEP_{I}(T + T^{e}) | STEP_{D}(T + T^{e}) |

Time column corresponds to time assigned after decoding of a chromosome, and STEP denotes the changing direction values from the stepwise alphabet {−1,0,1} corresponding to (STEP UP, HOLD, STEP DOWN) respectively.

In order to map such step-like control signals into the real parameters of the controller, an additional model of the control system that accepts such step-like inputs is developed by addition of the following transformation:

$${K}_{i} ( t + {T}^{c} , STEP ) = \{ \begin{matrix}if ( STEP = 1 ) \& ( {K}_{i} ( t ) < {K}_{i}^{max} then {K}_{i} ( t ) STEP\_UP \\ if ( STEP = - 1 ) \& ( {K}_{i} ( t ) > {K}_{i}^{min} ) then {K}_{i} ( t ) - STEP\_DOWN \\ else {K}_{i} ( t )\end{matrix}$$

Step-based coding reduces the search space of the GA.

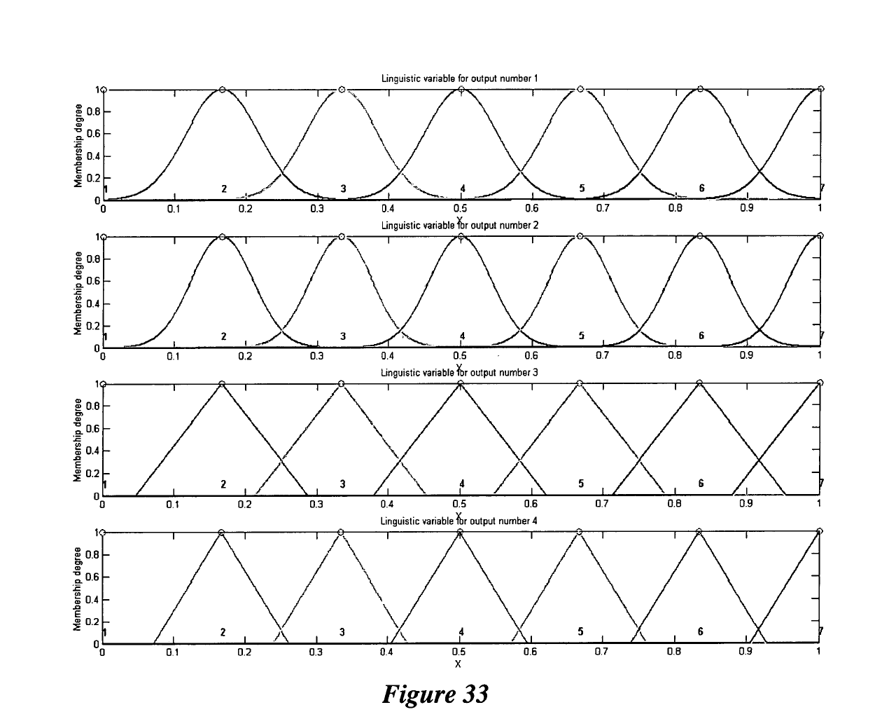

FIG. 32 shows input membership functions, number, type and parameters are obtained automatically. FIG. 33 shows output membership functions, number, type and parameters are obtained automatically.

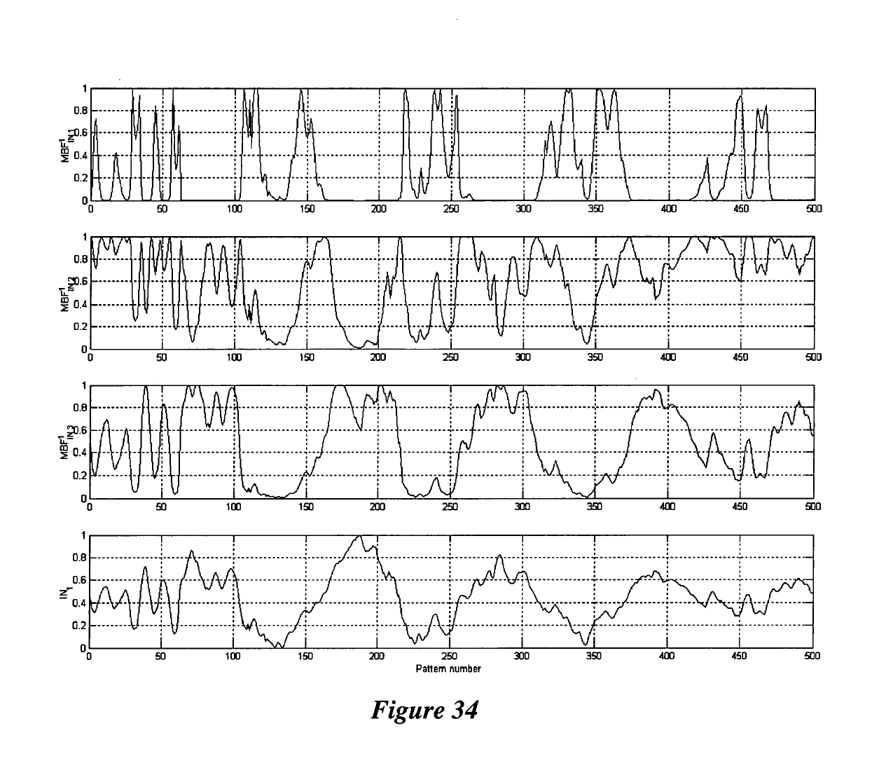

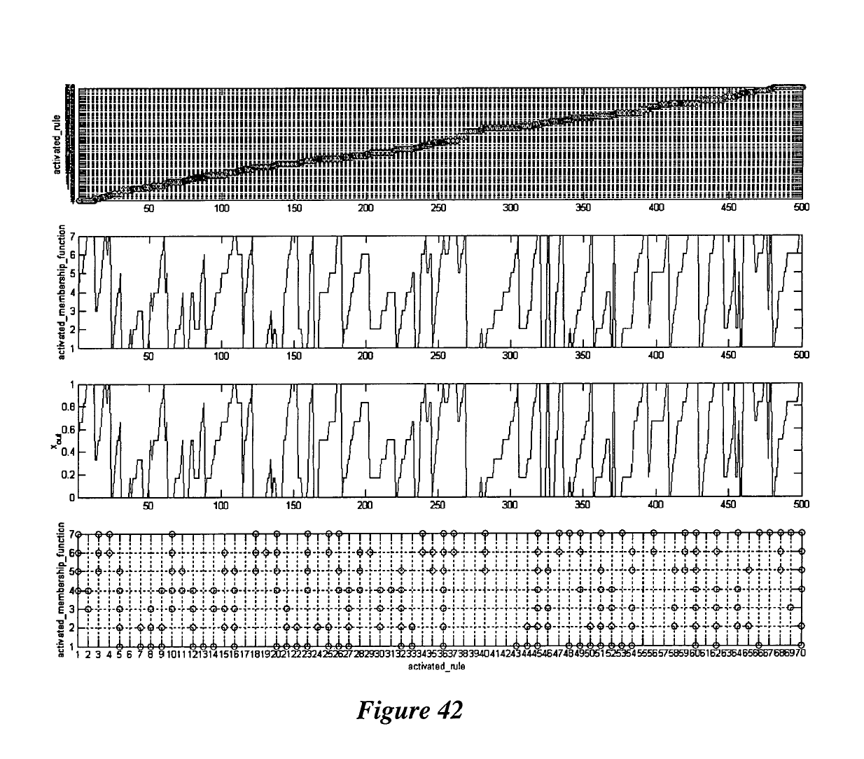

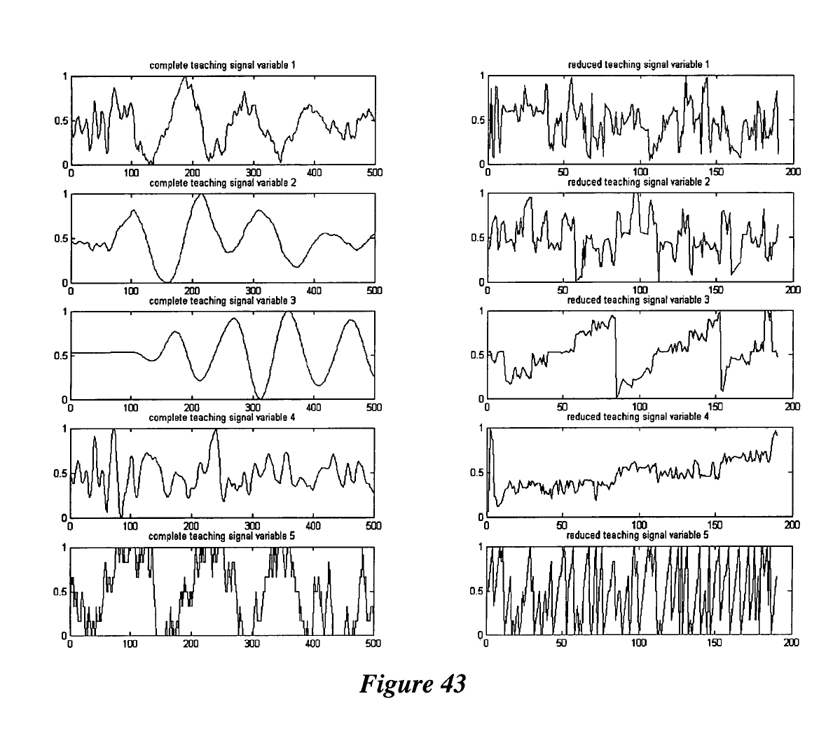

FIGS. 34-41 show the history of the activation of the fuzzy sets, activated by the teaching signal. FIG. 42 shows operation of the rule structure optimization algorithm. FIG. 43 shows rule optimization using an incomplete teaching signal, where each pattern configuration corresponds to one configuration of input-output pairs with a given structure of membership functions.

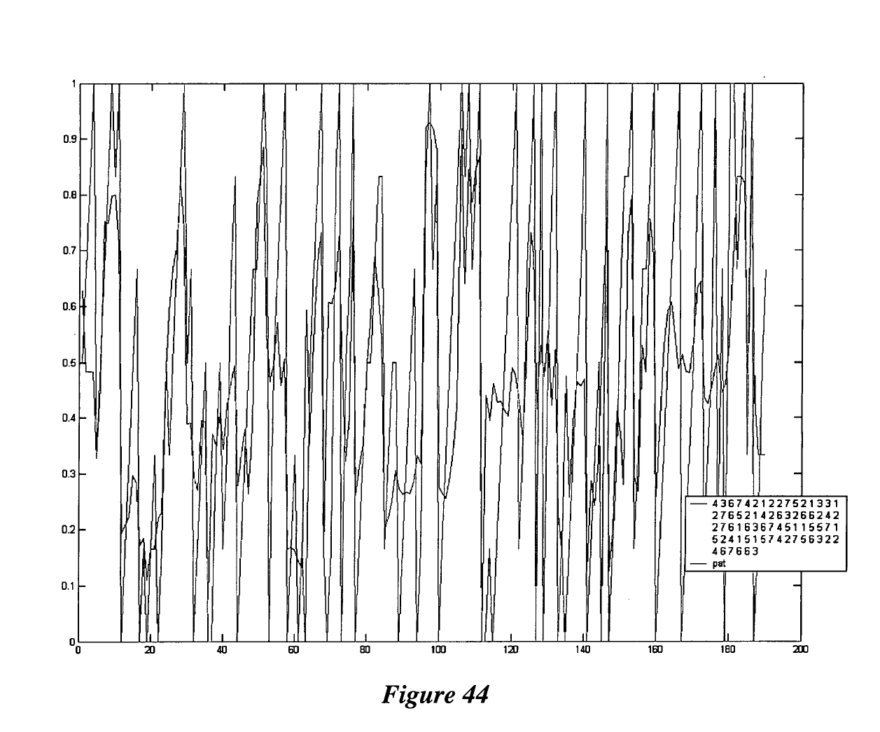

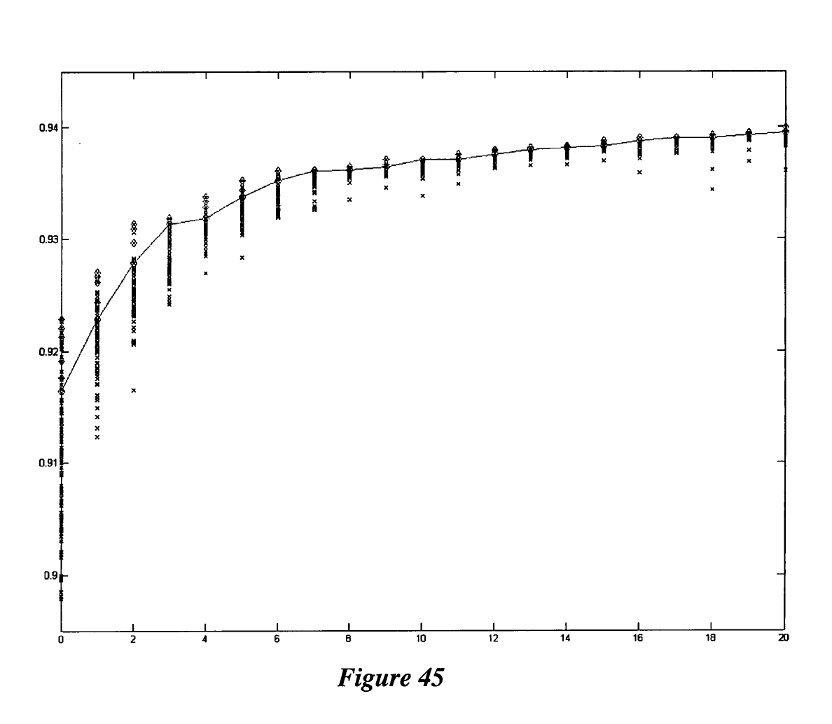

FIG. 44 shows the resulting approximation of the reduced teaching signal for the output number 4. FIG. 45 shows dynamics of the genetic optimization of the rules structure.

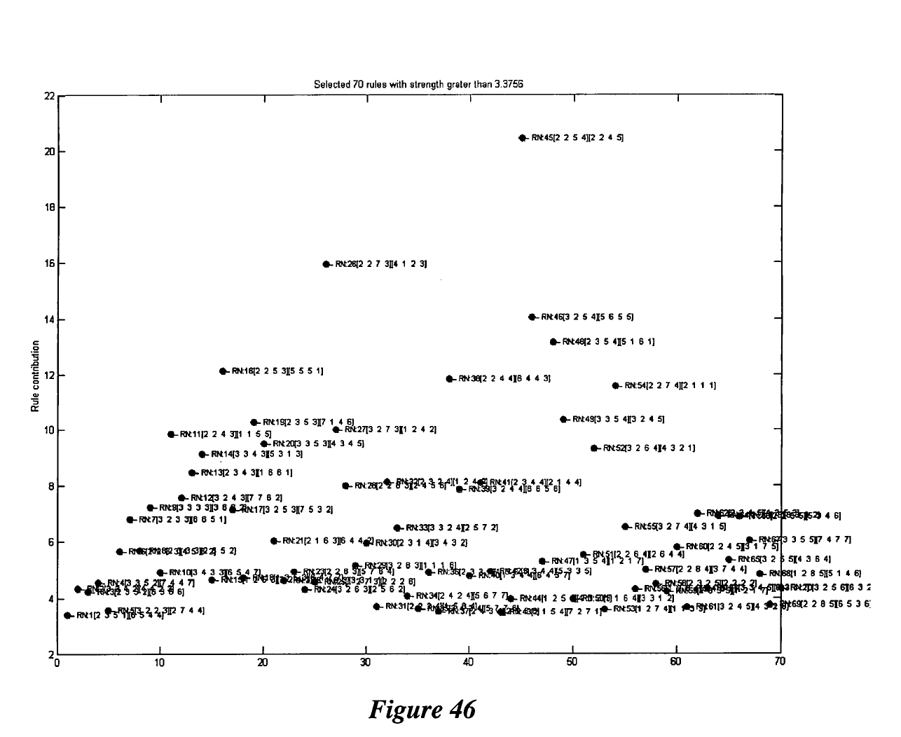

FIG. 46 shows the best 70 rules obtained with GA 2. The threshold level was set to prepare maximum 70 rules.

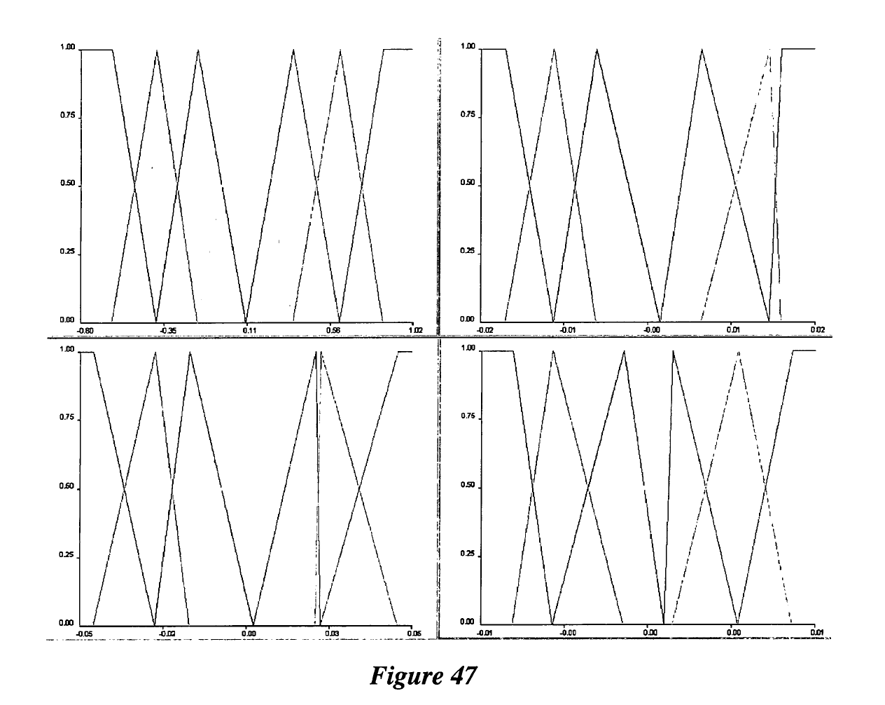

FIG. 47 shows membership functions obtained with a Back-Propagation fuzzy neural network, AFM. The number of membership functions, and their types were set manually. Back propagation searches only membership function parameters.

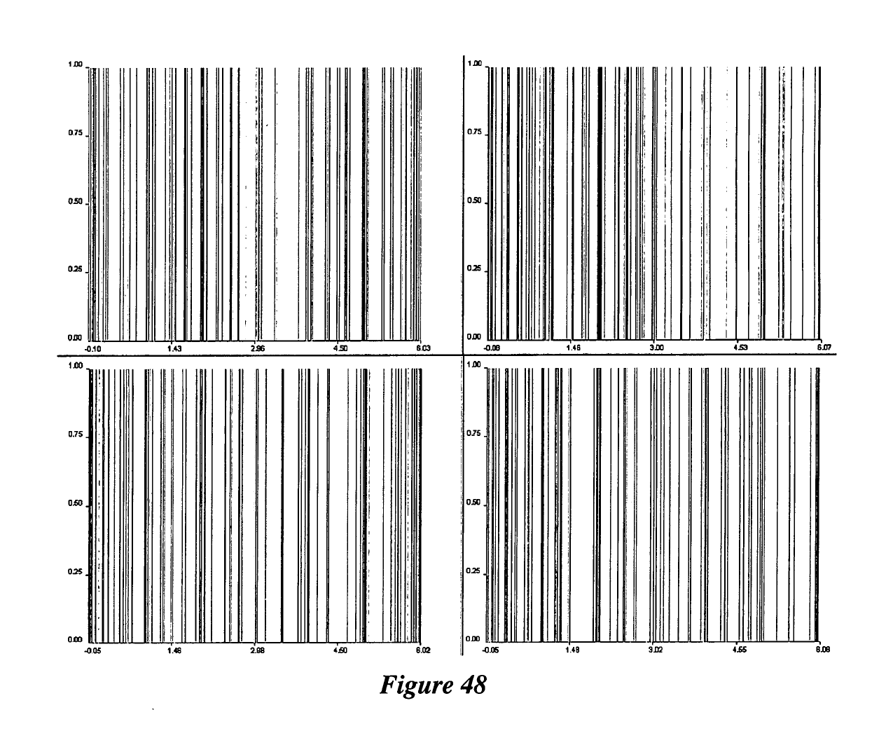

FIG. 48 shows Sugeno 0 order type membership functions obtained with a back propagation FNN. The number of membership functions is equal to the number of rules. Each output membership function has is crisp value.

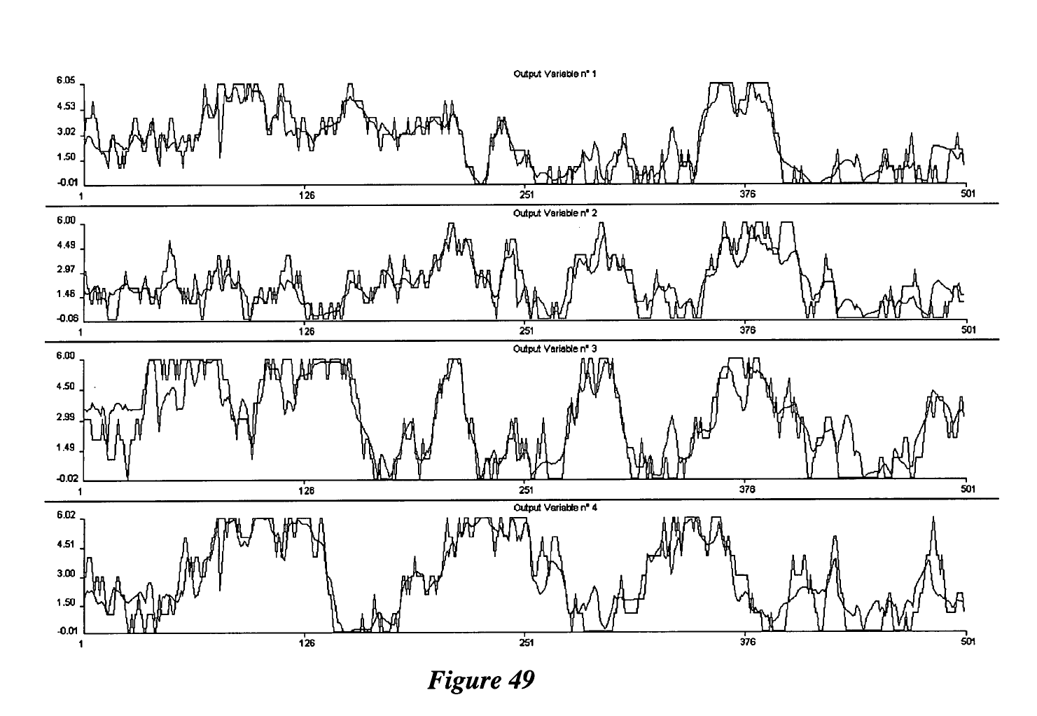

FIG. 49 shows results of approximation with a FNN trained by back-propagation.

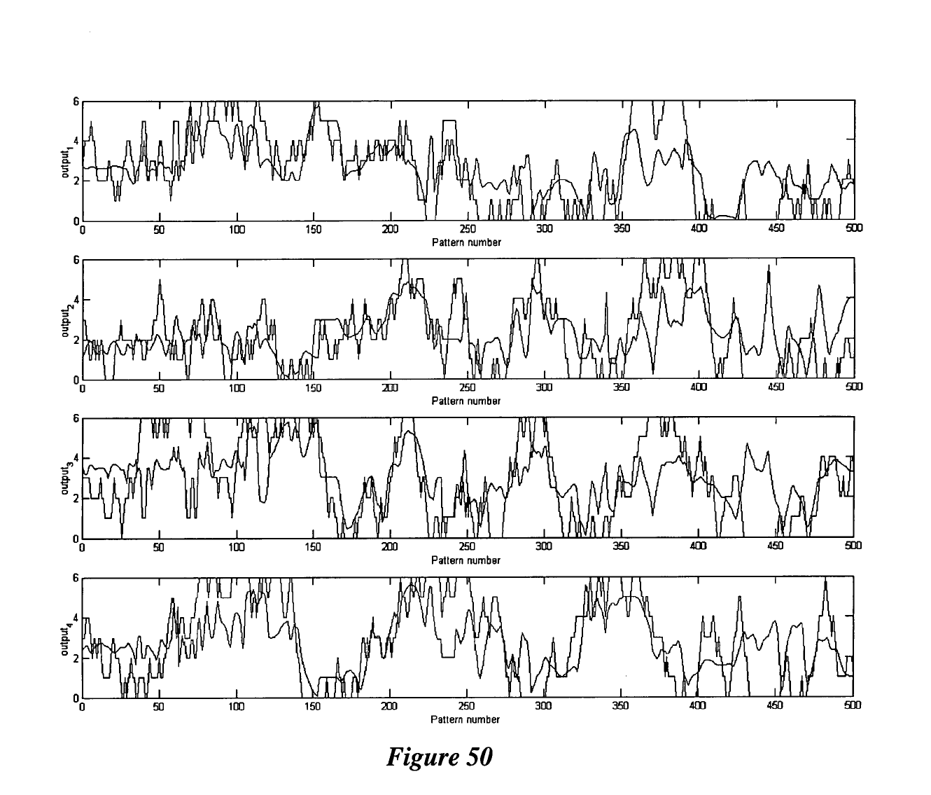

FIG. 50 shows results of teaching signal approximation using the SC optimizer.

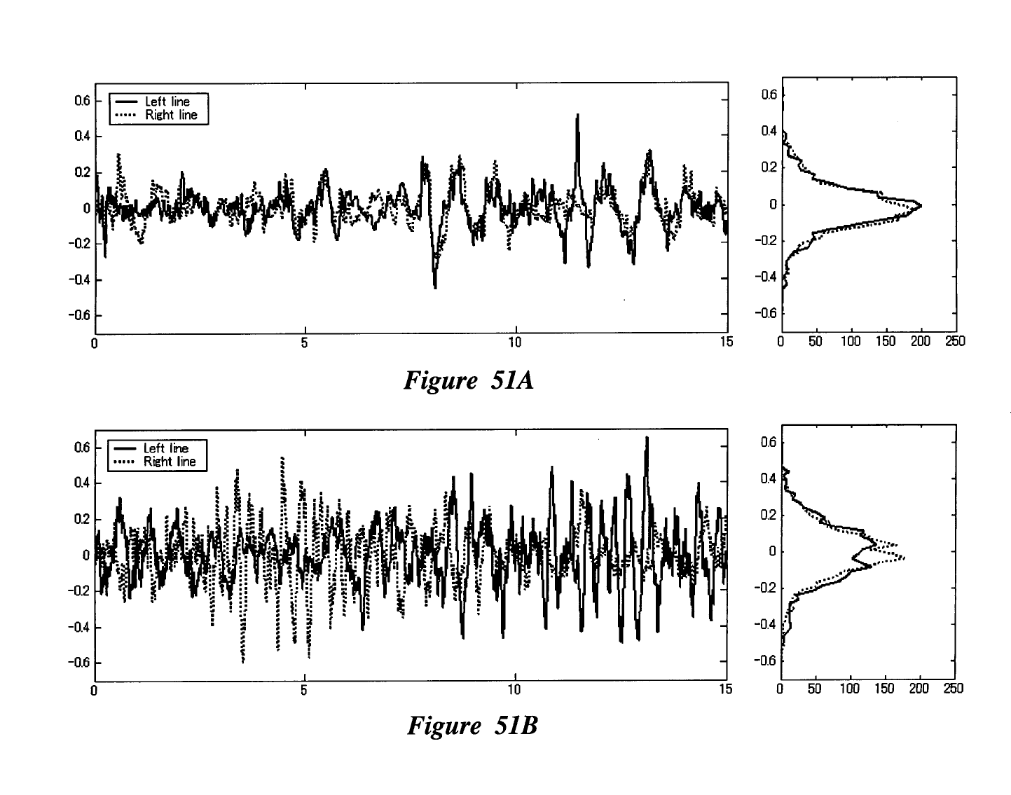

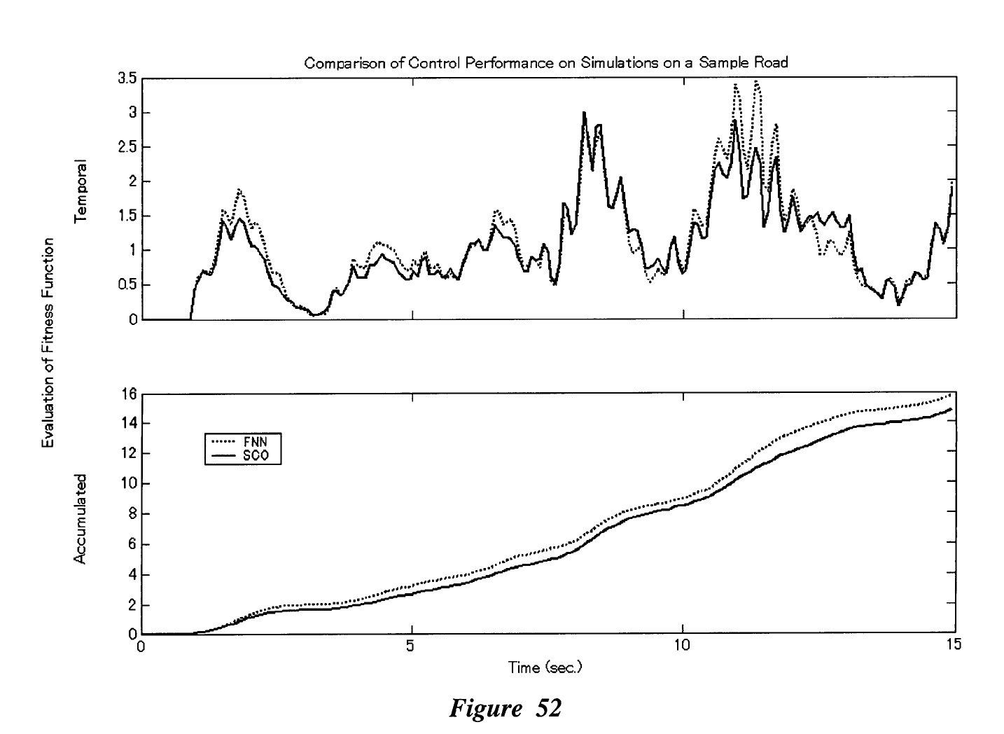

FIG. 51(a) shows a sample road signal that is used for knowledge base creation and simulations to compare FNN and SCO control (FIG. 52).

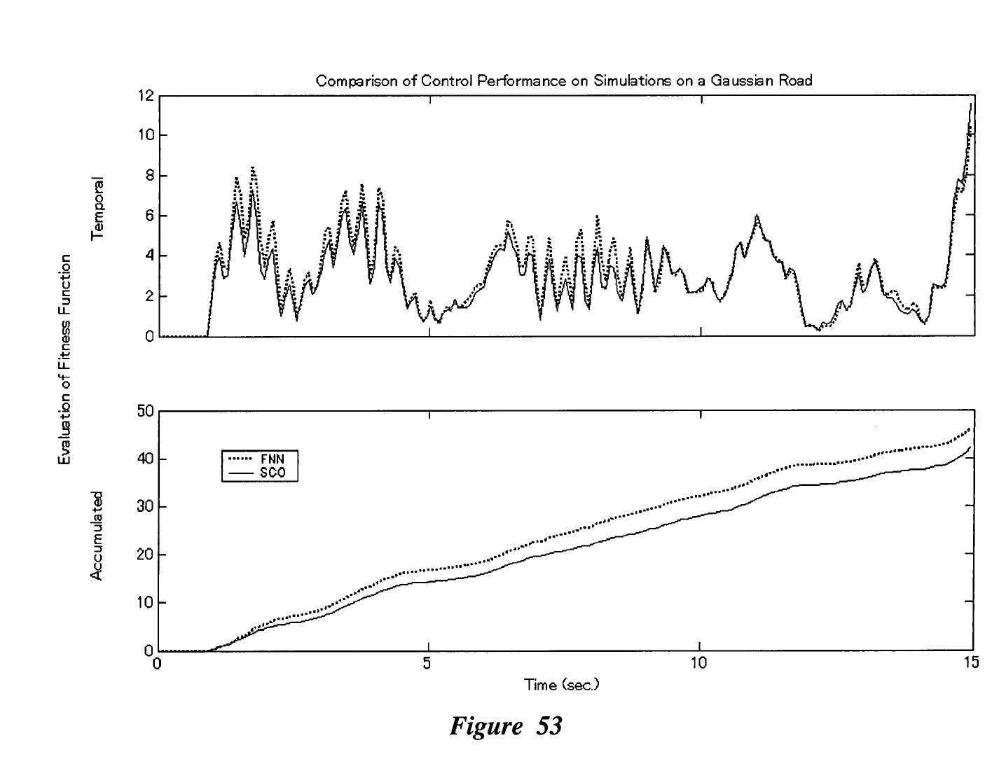

FIG. 51(b) shows a Gaussian road signal used for other simulations to compare FNN and SCO control (FIG. 53) to evaluate robustness.

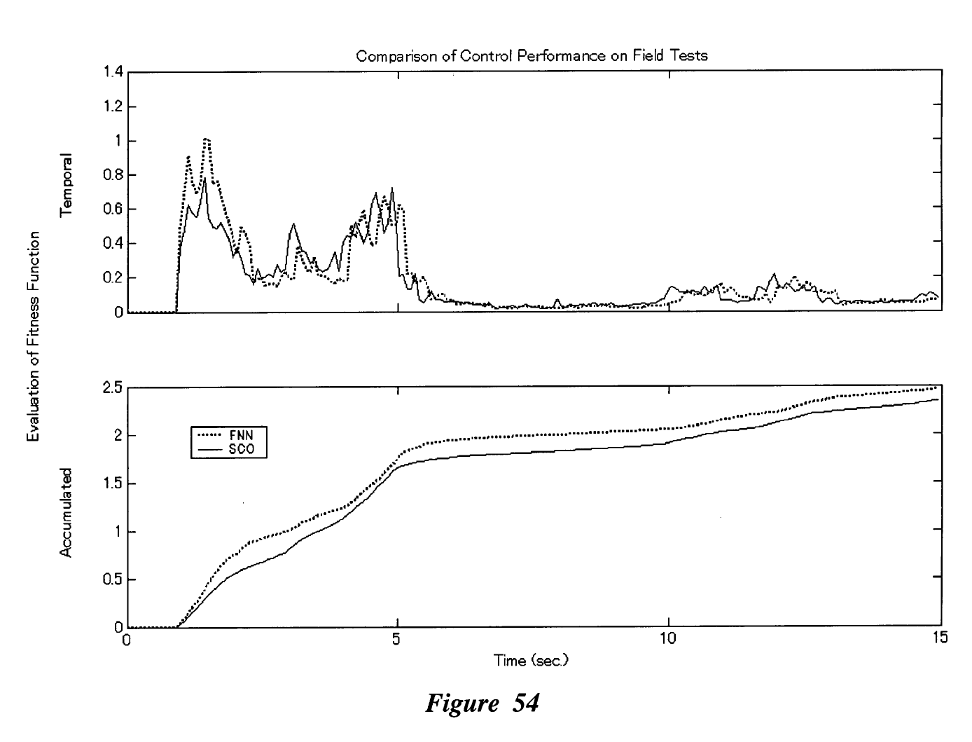

FIG. 54 shows test results comparing FNN and SCO control showing that the reduced KB obtained by the SC optimizer increases robustness of the controller without loss of control quality as compared to the classical FNN approach.

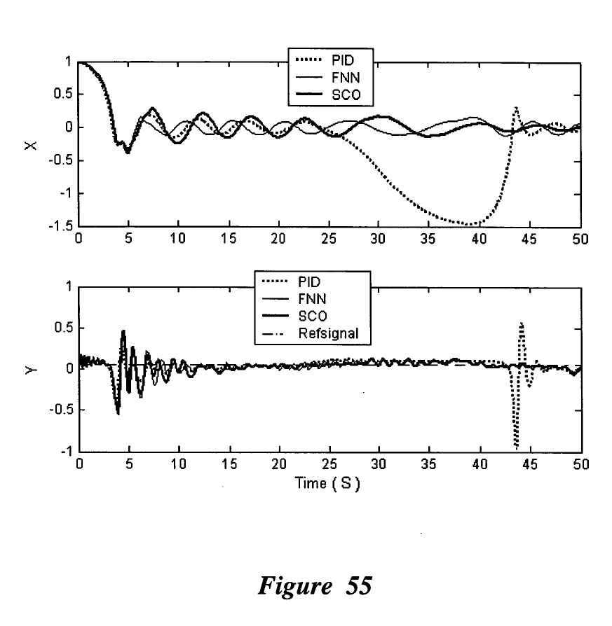

FIG. 55 shows a motion of the coupled nonlinear oscillators along x-y axes under non Gaussian (Rayleigh noise) stochastic excitation with fuzzy control in TS initial conditions. Here the comparison of motion under PID control, FNN-based control and SCO-based control is shown.

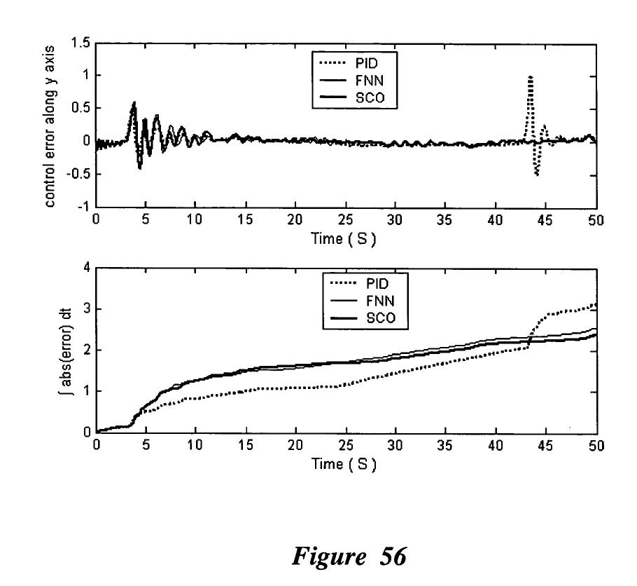

FIG. 56 shows control error of the coupled nonlinear oscillators motion under non-Gaussian stochastic excitation (Rayleigh noise) in TS initial conditions. Here the comparison of control errors under PID control, FNN-based control and SCO-based control is shown.

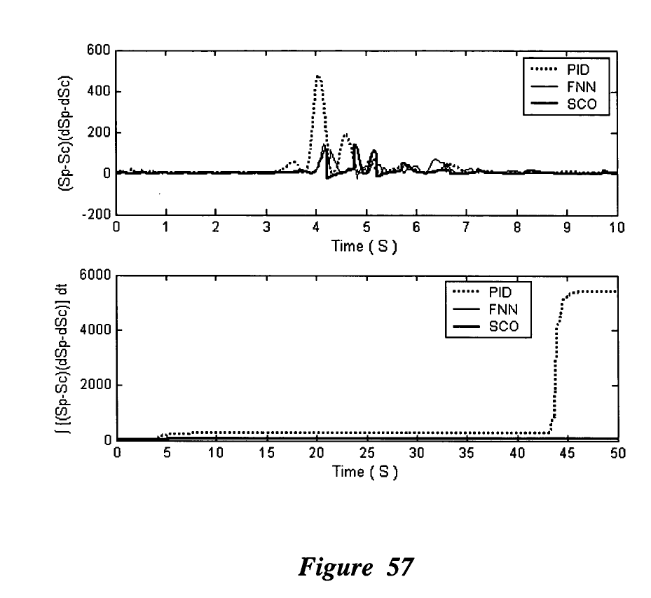

FIG. 57 shows generalized entropy characteristics of the coupled nonlinear oscillators motion under non-Gaussian stochastic excitation (Rayleigh noise) in TS initial conditions. The comparison of generalized entropy characteristics under PID control, FNN-based control and SCO-based control is shown.

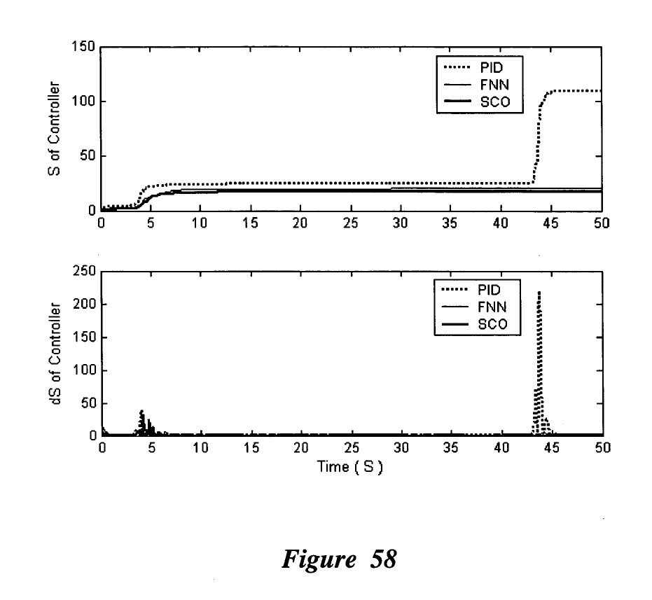

FIG. 58 shows controllers entropy characteristics in TS initial conditions. Here the comparison of PID, FNN-and SCO-based controllers entropy characteristics is shown.

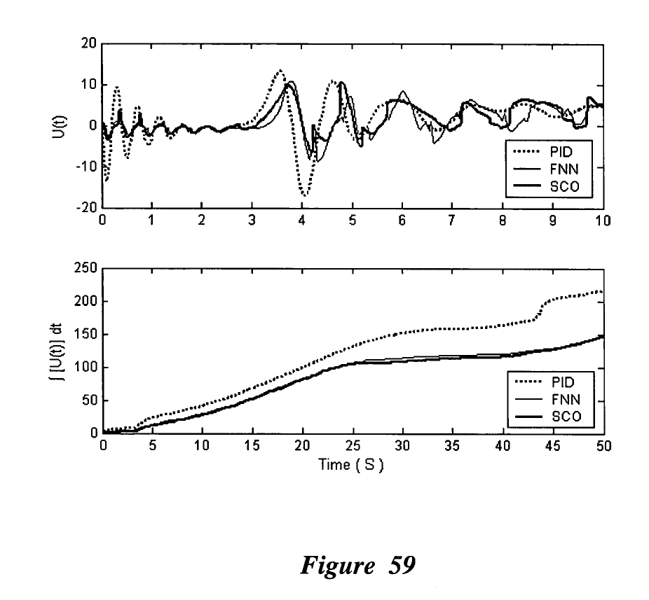

FIG. 59 shows control force characteristics in TS initial conditions. Here the comparison of PID, FNN-and SCO-based control force characteristics is shown.

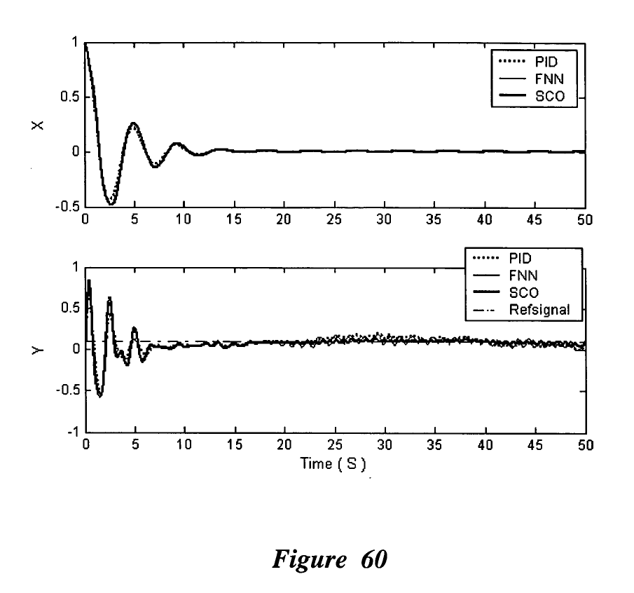

FIG. 60 shows results of robustness investigations using a FC with the same KB (obtained from the teaching signal for the given initial conditions) in the new control situation, where new reference signal and new model parameters are considered. The comparison of motion along x-y axes under PID control, FNN-based control and SCO-based control is shown.

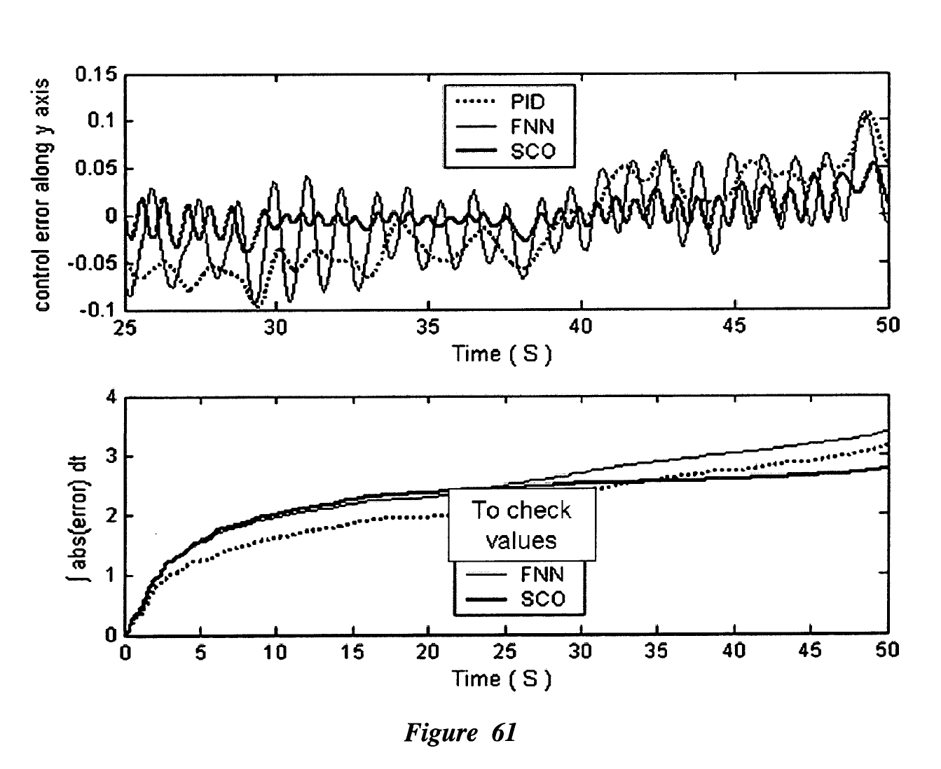

FIG. 61 shows results of robustness investigations using a FC with the same KB (obtained from the teaching signal for the given initial conditions) in the new control situation, where new reference signal and new model parameters are considered. The comparison of control errors under PID control, FNN-based control and SCO-based control is shown.

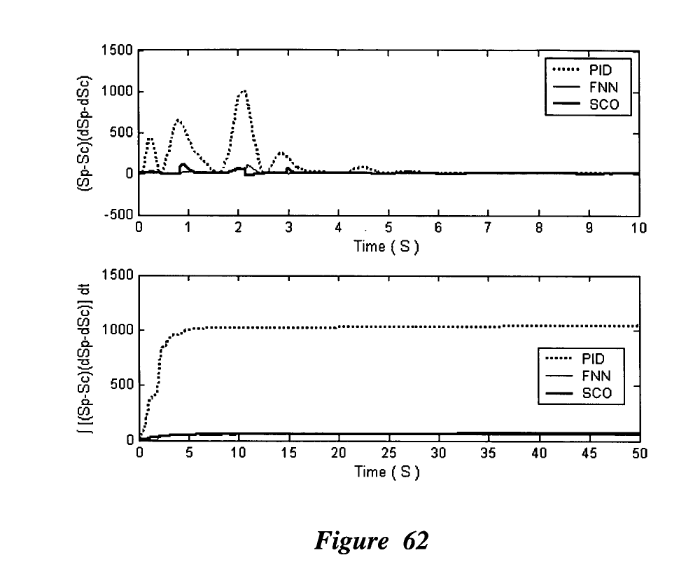

FIG. 62 shows results of robustness investigations using a FC with the same KB (obtained from the teaching signal for the given initial conditions) in the new control situation, where new reference signal and new model parameters are considered. The comparison of generalized entropy characteristics under PID control, FNN-based control and SCO-based control is shown.

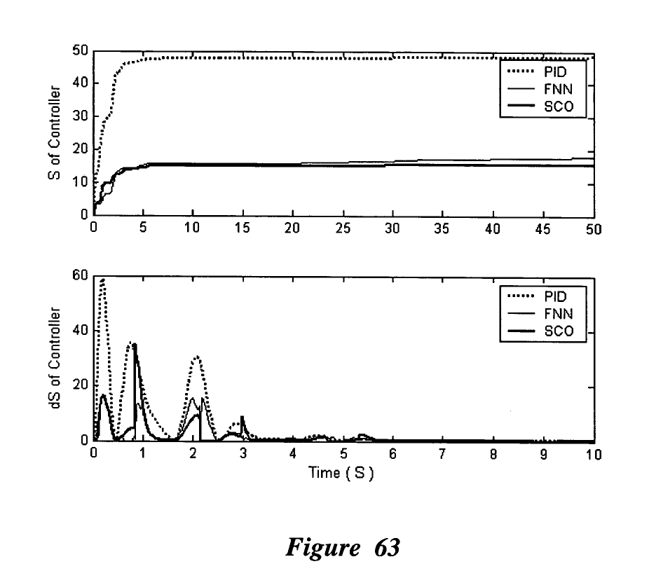

FIG. 63 shows results of robustness investigations using a FC with the same KB (obtained from the teaching signal for the given initial conditions) in the new control situation, where new reference signal and new model parameters are considered. The comparison of PID, FNN-and SCO-based controllers entropy characteristics is shown.

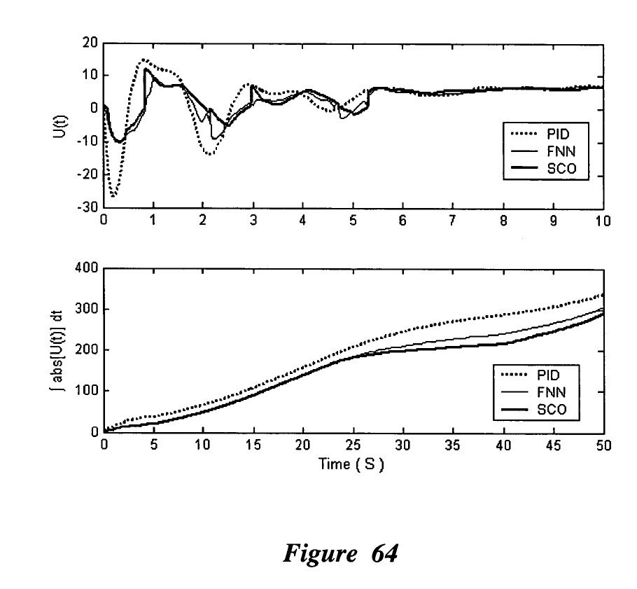

FIG. 64 shows results of robustness investigations using a FC with the same KB (obtained from the teaching signal for the given initial conditions) in the new control situation, where new reference signal and new model parameters are considered. The comparison of PID, FNN-and SCO-based control force characteristics is shown.

Coupled Nonlinear Oscillators Simulation Results.

The nonlinear equations of motion for coupled nonlinear oscillators (such as a suspension system) are as follows:

$$\{ \begin{matrix}\ddot{x} + 2 {β}_{1} \dot{x} + {ω}_{1}^{2} [ 1 - k \cdot y ] x = 0 \\ \ddot{y} + 2 {β}_{2} \ddot{y} + {ω}_{2}^{2} y + \frac{{π}^{2}}{2 l} [ x \ddot{x} + {\dot{x}}^{2} ] = \frac{1}{M} [ u ( t ) + ξ ( t ) ] .\end{matrix} \qquad ( 9.1 )$$

Here ξ(t) is the given stochastic excitation (non-Gaussian, Rayleigh, noise). Equations of entropy production are the following:

$$\frac{ⅆ {S}_{x}}{ⅆ t} = 2 {β}_{1} \dot{x} \cdot \dot{x} ; \\ \frac{ⅆ {S}_{y}}{ⅆ t} = 2 {β}_{2} \dot{y} \cdot \dot{y} . \qquad ( 9.2 )$$

The system (9.1) is a stable system (in Lyapunov sense).

In this example one state variable y is controlled. Consider the following model parameters: β₁=0.03;β₂=0.3;ω₁=1.5;ω₂=4;k=10;l=0.5;M=5. Initial conditions and reference signal are the following: [1 0] [0 0]; y=0.05. In this example a Sugeno 0 FIS is used with three inputs and three outputs variables. Inputs varaibles are: control error, derivative of control error and integral of control error. Output variables are K-gains of PID Controller. By using the SC Optimizer and a teaching signal (TS) obtained outside of the SC Optimizer one can design a KB which optimally approximates the given training signal. For the training signal design uses the stochastic simulation system based on a GA with a chosen fitness function that minimizes control error and entropy production rate. The KB design process by using he SC Optimizer is characterized as follows:
Number of input variables to FC: 3 {e,\dot{e}, ∫edt};
Number of FC output variables: 3 {kₚ,k_{d},kᵢ};
Filtering of original TS and using new filtering TS for the optimization of number of membership functions (filter value=0.707);
GA₁: Optimal number of membership functions for each input variables: 9,9,7;
GA₂ with Sum of firing strength criterion; and
Complete number of fuzzy rules: 9·9·7=567 rules; Optimized KB: 30 rules.

For comparisions of control quality and robustness between the of SC Optimizer, a FNN and a traditional PID, the following control criteria are use:

We use the following control quality criteria:

minimum of control error [control criterion]
minimum of (Sₚ−S_{c})(\dot{S}ₚ−\dot{S}_{c}) [thermodynamic criterion]
minimum of control force [physical realization criterion]

The control quality of FC_{SCO} obtained by SC Optimizer (with 30 rules) can be compared with the FC_{FNN} obtained by traditional SC approach based on FNN-tuning (with 42 rules) and traditional PID-Controller with K=(10 10 10). Results of comparison are shown in Table 5 and in FIGS. 55-59.

Table 5 shows dynamic and thermodynamic characteristics of the suspension system motion along y-axis under SCO, FNN and PID control.

TABLE 5

| | PID | | FNN | | SCoptimizer | |
|---|---|---|---|---|---|---|
| | Range | Deviation | Range | Deviation | Range | Deviation |
| ‘e’ | 1.5325 | 0.1167 | 1.0070 | 0.0890 | 0.9722 | 0.0859 |
| ‘de’ | 7.3598 | 0.4677 | 5.0332 | 0.4035 | 5.1133 | 0.3945 |
| ‘y’ | 1.5325 | 0.1167 | 1.0070 | 0.0890 | 0.9722 | 0.0859 |
| ‘dy’ | 7.3588 | 0.4672 | 5.0325 | 0.4035 | 5.1139 | 0.3945 |
| ‘dSp’ | 13.2189 | 0.8517 | 4.3455 | 0.3889 | 4.0603 | 0.3843 |
| ‘Sp’ | 6.5490 | 1.7160 | 4.8846 | 1.1975 | 4.6684 | 1.1475 |
| ‘dSc’ | 220.4565 | 14.2093 | 31.1692 | 1.9442 | 24.4137 | 1.8328 |
| ‘Sc’ | 109.3542 | 28.6858 | 20.2708 | 5.2477 | 17.2922 | 4.3793 |
| ‘U’ | 74.5734 | 5.3260 | 19.4743 | 3.0812 | 17.1051 | 3.0922 |
| ‘Kp’ | 0 | 0 | 10.0000 | 0.4350 | 2.1335 | 0.4894 |
| ‘Kd’ | 0 | 0 | 5.3916 | 1.3972 | 9.9998 | 2.1889 |
| ‘Ki’ | 0 | 0 | 10.0000 | 3.7158 | 9.9998 | 4.2867 |
| Sp − Sc*d(Sp − Sc) | 14170 | 872.0309 | 164.1939 | 10.3939 | 162.8299 | 10.1579 |

Results of comparison show that the fuzzy PID-controller designed by the SC Optimizer realizes more effective control than the FC_{FNN}- and traditional PID-controllers.

It is also useful to take the FC_{SCO} and FC_{FNN} developed for the above case (see FIGS. SW1,2,3,4, and 5) and use them in a new control situation. Consider the following change of initial control situation: (1) new reference signal=0.1 and (2) new model parameters β₁=0.3;β₂=0.3;ω₁=1.5;ω₂=4;k=1;l=0.5;M=5 Compare now control performance in the new control situation of FC_{SCO} obtained by SCO (with 30 rules), FC_{FNN} obtained by traditional SC-approach based on FNN-tuning (with 42 rules) and traditional PID-Controller with K=(10 10 10). Results are shown in Table 6 and in FIGS. 60-64. Table 6 shows dynamic and thermodynamic characteristics of system motion along y-axis under different types of controllers.

TABLE 6

| | PID | | FNN | | SCoptimizer | |
|---|---|---|---|---|---|---|
| | Range | Deviation | Range | Deviation | Range | Deviation |
| ‘e’ | 1.2422 | 0.1086 | 1.4224 | 0.1267 | 1.3942 | 0.1234 |
| ‘de’ | 4.3145 | 0.3108 | 5.7805 | 0.4235 | 5.6931 | 0.4183 |
| ‘y’ | 1.2422 | 0.1086 | 1.4224 | 0.1267 | 1.3942 | 0.1234 |
| ‘dy’ | 4.3152 | 0.3108 | 5.7812 | 0.4234 | 5.6949 | 0.4184 |
| ‘dSp’ | 3.5292 | 0.3007 | 5.0747 | 0.5074 | 4.9259 | 0.5093 |
| ‘Sp’ | 2.8975 | 0.3362 | 5.3761 | 0.6489 | 5.2495 | 0.6657 |
| ‘dSc’ | 58.8211 | 5.0108 | 15.5021 | 1.6977 | 35.2406 | 1.9011 |
| ‘Sc’ | 48.2896 | 5.5560 | 17.8712 | 2.5642 | 15.5046 | 1.8928 |
| ‘U’ | 41.4872 | 4.0933 | 22.7527 | 4.3992 | 22.1568 | 4.4499 |
| ‘Kp’ | 0 | 0 | 10.0000 | 0.3662 | 2.0132 | 0.5335 |
| ‘Kd’ | 0 | 0 | 5.3031 | 1.6317 | 5.2761 | 1.6351 |
| ‘Ki’ | 0 | 0 | 10.0000 | 3.8313 | 9.9998 | 4.2252 |
| Sp − Sc*d(Sp − Sc) | 1011.6 | 99.3574 | 108.2710 | 7.3551 | 129.3079 | 7.4024 |

Simulations results given above (as in training signal control situation and in the new control situation) show that the fuzzy PID-controller designed by the SC Optimizer with relatively fewer rules than a traditional FNN controller realizes more effective and robust control than the FNN and/or a traditional PID-controller.

Although the foregoing has been a description and illustration of specific embodiments of the invention, various modifications and changes can be made thereto by persons skilled in the art, without departing from the scope and spirit of the invention as defined by the claims attached hereto.

What is claimed is:

1. An optimization control method for controlling an electronically-controlled suspension system, comprising:
using a controller genetic algorithm to develop an optimzed teaching signal, said genetic algorithm having a fitness function that computes a difference between a time differential of entropy inside a shock absorber and/or inside the whole vehicle including passengers and/or other load and a time differential of entropy in a control signal provided to said shock absorber from an fuzzy controller that controls said shock absorber while said shock absorber is being perturbed by a road signal;
using first genetic algorithm to optimize a fuzzy inference engine to develop a knowledge base structure by optimizing at least one of, a number of input variables of said knowledge base, a number of output variables of said knowledge base, a type of fuzzy inference model used by said fuzzy inference engine, and a preliminary type of membership function;
using said teaching/training signal to learn/train said fuzzy inference engine by setting knowledge paramteres in said knowledge base; and
providing said knowledge base to said fuzzy controller to control said shock absorber.

2. The optimization control method of claim 1, wherein said time differential reduces an entropy provided to said shock absorber from said control unit.

3. The optimization control method of claim 1, wherein said fuzzy controller comprises a fuzzy neural network, and wherein a value of a coupling coefficient for a fuzzy rule is optimized by using a second genetic algorithm.

4. The optimization control method of claim 1, wherein said fuzzy controller comprises an offline module and a online control module, said method further comprising optimizing a control parameter based on said controller genetic algorithm by using said fitness function, determining said control parameter of said online control module based on said control parameter and controlling said shock absorber using said online control module.

5. The optimization control method of claim 4, wherein said offline module provides optimization using a simulation model, said simulation model based on a kinetic model of a vehicle suspension system.

6. The optimization control method of claim 4, wherein said shock absorber is arranged to alter a damping force by altering a cross-sectional area of an oil passage, and said control unit controls a throttle valve to thereby adjust said cross-sectional area of said oil passage.

7. The soft computing optimizer of claim 1, wherein said fuzzy inference engine comprises a Fuzzy Neural Network.

8. The soft computing optimizer of claim 1, wherein said fuzzy inference model comprises a Mamdani model.

9. The soft computing optimizer of claim 1, wherein said fuzzy inference model comprises a Sugeno model.

10. The soft computing optimizer of claim 1, wherein said fuzzy inference model comprises a Tsukamoto model.

11. The soft computing optimizer of claim 1, wherein said first genetic algorithm is configured to optimize said knowledge base according to said teaching signal.

12. The soft computing optimizer of claim 1, further comprising a classical derivative-based optimizer to further optimize an optimized knowledge base produced by said first genetic algorithm.

13. The soft computing optimizer of claim 1, where said first genetic algorithm uses a fitness function based on a response of a model of a suspension system comprising said shock absorber.

14. The soft computing optimizer of claim 1, where said first genetic algorithm uses a fitness function based on a response of said shock absorber in a suspension system.

15. The soft computing optimizer of claim 1, where said first genetic algorithm uses a fitness function based on minimizing entropy production.

16. A method for control of a suspension system comprising the steps of: determining a fitness function for a teaching signal genetic optimizer using a first entropy production rate and a second entropy production rate; providing said fitness function to said teaching signal genetic optimizer; providing a teaching signal output from said teaching signal genetic optimizer to an information filter; providing a compressed teaching signal from said information filter to a soft computing optimizer for optimizing a structure of a knowledge base for a fuzzy neural network, providing said knowledge base to a fuzzy controller, said fuzzy controller using an error signal and said knowledge base to produce a coefficient gain schedule; and providing said coefficient gain schedule to a linear controller.

17. The method of claim 16, wherein said genetic optimizer minimizes entropy production under one or more constraints.

18. The method of claim 17, wherein at least one of said constraints is related to a user-perceived evaluation of control performance.

19. The method of claim 16, wherein said model of said suspension system comprises a model of a suspension system.

20. The method of claim 16, wherein said second control system is configured to control a physical suspension system.

21. The method of claim 16, wherein said second control system is configured to control a shock absorber.

22. The method of claim 16, wherein said second control system is configured to control a damping rate of a shock absorber.

23. The method of claim 16, wherein said linear controller receives sensor input data from one or more sensors that monitor a vehicle suspension system.

24. The method of claim 23, wherein at least one of said sensors is an acceleration sensor that measures a vertical acceleration.

25. The method of claim 23, wherein at least one of said sensors is a length sensor that measures a change in length of at least a portion of said suspension system.

26. The method of claim 23, wherein at least one of said sensors is an angle sensor that measures an angle of at least a portion of said suspension system with respect to said vehicle.

27. The method of claim 23, wherein at least one of said sensors is an angle sensor that measures an angle of a first portion of said suspension system with respect to a second portion of said suspension system.

28. The method of claim 16, wherein said second control system is configured to control a throttle valve in a shock absorber.

29. The method of claim 16, where optimizing a structure of the knowledge base comprises:
selecting a fuzzy model by selecting one or more parameters, said one or more parameters comprising at least one of a number of input variables, a number of output variables, a type of fuzzy inference model, and a teaching signal;
optimizing linguistic variable parameters of a knowledge base according to said one or more parameters to produce optimized linguistic variables;
ranking rules in said rule base according to firing strength;
eliminating rules with relatively weak firing strength leaving selected rules from said rules in said rule base; and
optimizing said selected rules, using said fuzzy model, said linguistic variable parameters and said optimized linguistic variables, to produce optimized selected rules.

30. The method of claim 29, further comprising optimizing said selected rules using a derivative-based optimization procedure.

31. The method of claim 29, further comprising optimizing parameters of membership functions of said optimized selected rules to reduce approximation errors.

32. The method of claim 16, said soft computing optimizer comprising:
a first genetic optimizer configured to optimize linguistic variable parameters for a fuzzy model in a fuzzy inference system;
a first knowledge base trained by a use of a training signal;
a rule evaluator configured to rank rules in said first knowledge base according to firing strength and eliminating rules with a relatively low firing strength to create a second knowledge base; and
a second genetic analyzer configured to optimize said second knowledge base using said fuzzy model.

33. The method of claim 32, further comprising an optimizer configured to optimize said fuzzy inference model using classical derivative-based optimization.

34. The method of claim 32, further comprising a third genetic optimizer configured to optimize a structure of said linguistic variables using said second knowledge base.

35. The method of claim 32, further comprising a third genetic optimizer configured to optimize a structure of membership functions in said fuzzy inference system.

36. The method of claim 32, wherein said second genetic analyzer uses a fitness function based on measured suspension system responses.

37. The method of claim 32, wherein said second genetic analyzer uses a fitness function based on modeled suspension system responses.

38. The method of claim 32, wherein said second genetic analyzer uses a fitness function configured to reduce entropy production of a controlled suspension system.

39. The method of claim 32, wherein said first genetic algorithm is configured to choose a number of membership functions for said first knowledge base.

40. The method of claim 32, wherein said first genetic algorithm is configured to choose a type of membership functions for said first knowledge base.

41. The method of claim 32, wherein said first genetic algorithm is configured to choose parameters of membership functions for said first knowledge base.

42. The method of claim 32, wherein a fitness function used in said second genetic algorithm depends, at least in part, on a type of membership functions in said fuzzy inference system.

43. The method of claim 32, further comprising a third genetic analyzer configured to optimize said second knowledge base according to a search space from the parameters of said linguistic variables.

44. The method of claim 32, further comprising a third genetic analyzer configured to optimize said second knowledge base by minimizing a fuzzy inference error.

45. The method of claim 32, wherein said second genetic optimizer uses an information-based fitness function.

46. The method of claim 32, wherein said first genetic optimizer uses a first fitness function and said second genetic optimizer uses said first fitness function.

47. The method of claim 32, wherein said second genetic optimizer uses a fitness function configured to optimize mechanical characteristics of a controlled suspension system.

48. The method of claim 32, wherein said second genetic optimizer uses a fitness function configured to optimize entropy properties of a controlled suspension system.

49. The method of claim 32, wherein said second genetic optimizer uses a fitness function configured to optimize based on user preferences.

50. The method optimizer of claim 32, wherein said second genetic optimizer uses a nonlinear model of a controlled suspension system.

51. The method optimizer of claim 32, wherein said second genetic optimizer uses a nonlinear model of an unstable suspension system.

52. The method of claim 32, wherein said teaching signal is obtained from an optimal control signal.

53. The method of claim 32, wherein said optimal control signal comprises a filtered measured control signal.

54. The method of claim 32, wherein said optimal control signal comprises a lowpass filtered measured control signal.

55. The method of claim 32, wherein said optimal control signal comprises a bandpass filtered measured control signal.

56. The method of claim 32, wherein said optimal control signal comprises a highpass filtered measured control signal.

57. A control apparatus comprising:
off-line optimization means for determining a control parameter from an entropy production rate;
soft computing optimizer means to configure a knowledge base;
training means for training said knowledge base; and
online control means for using said knowledge base to develop a control parameter to control a suspension system.

58. A soft computing optimizer for a suspension control system, comprising:
an off-line optimizer for developing a training signal from data obtained by providing at least one road signal disturbance to a first suspension system;
a soft computing optimizer configured to use said training signal to find a structure for a knowledge base;
a training optimizer configured to generate knowledge base corresponding to said structure; and
an online control system configured to use said knowledge base to develop a control parameter to control a second suspension system.

59. The soft computing optimizer of claim 58, said soft computing optimizer configured to:
optimize linguistic variable parameters of a knowledge base for a fuzzy model according to one or more selected parameters to produce optimized linguistic variables;
rank rules in said rule base according to firing strength;
eliminate rules with relatively weak firing strength leaving selected rules from said rules in said rule base;
optimize said selected rules, using said fuzzy model, said linguistic variable parameters and said optimized linguistic variables, to produce optimized selected rules.

60. The soft computing optimizer of claim 58, further comprising an optimizer configured to optimize said fuzzy inference model using classical derivative-based optimization.

61. The soft computing optimizer of claim 58, further comprising a third genetic optimizer configured to optimize a structure of said linguistic variables using said second knowledge base.

62. The soft computing optimizer of claim 58, further comprising a third genetic optimizer configured to optimize a structure of membership functions in said fuzzy inference system.

63. The soft computing optimizer of claim 58, wherein said second genetic analyzer uses a fitness function based on measured suspension system responses.

64. The soft computing optimizer of claim 58, wherein said second genetic analyzer uses a fitness function based on modeled suspension system responses.

65. The soft computing optimizer of claim 58, wherein said second genetic analyzer uses a fitness function configured to reduce entropy production of a controlled suspension system.

66. The soft computing optimizer of claim 58, wherein said first genetic algorithm is configured to choose a number of membership functions for said first knowledge base.

67. The soft computing optimizer of claim 58, wherein said first genetic algorithm is configured to choose a type of membership functions for said first knowledge base.

68. The soft computing optimizer of claim 58, wherein said first genetic algorithm is configured to choose parameters of membership functions for said first knowledge base.

69. The soft computing optimizer of claim 58, wherein a fitness function used in said second genetic algorithm depends, at least in part, on a type of membership functions in said fuzzy inference system.

70. The soft computing optimizer of claim 58, further comprising a third genetic analyzer configured to optimize said second knowledge base according to a search space from the parameters of said linguistic variables.

71. The soft computing optimizer of claim 58, further comprising a third genetic analyzer configured to optimize said second knowledge base by minimizing a fuzzy inference error.

72. The soft computing optimizer of claim 58, wherein said second genetic optimizer uses an information-based fitness function.

73. The soft computing optimizer of claim 58, wherein said first genetic optimizer uses a first fitness function and said second genetic optimizer uses said second fitness function.

74. The soft computing optimizer of claim 58, wherein said second genetic optimizer uses a fitness function configured to optimize mechanical characteristics of a controlled suspension system.

75. The soft computing optimizer of claim 58, wherein said second genetic optimizer uses a fitness function configured to optimize entropy properties of a controlled suspension system.

76. The soft computing optimizer of claim 58, wherein said second genetic optimizer uses a fitness function configured to optimize based on user preferences.

77. The soft computing optimizer of claim 58, wherein said second genetic optimizer uses a nonlinear model of a controlled suspension system.

78. The soft computing optimizer of claim 58, wherein said second genetic optimizer uses a nonlinear model of an unstable suspension system.

79. The soft computing optimizer of claim 58, wherein said teaching signal is obtained from an optimal control signal.

80. The soft computing optimizer of claim 58, wherein said optimal control signal comprises a filtered measured control signal.

81. The soft computing optimizer of claim 58, wherein said optimal control signal comprises a lowpass filtered measured control signal.

82. The soft computing optimizer of claim 58, wherein said optimal control signal comprises a bandpass filtered measured control signal.

83. The soft computing optimizer of claim 58, wherein said optimal control signal comprises a highpass filtered measured control signal.

84. A self-organizing control system for optimization of a knowledge base, comprising:
an fuzzy logic classifier configured to optimize a structure of a knowledge base for a fuzzy inference system;
a genetic analyzer configured to develop a teaching signal for said fuzzy-logic classifier, said teaching signal configured to provide a desired set of control qualities, said genetic analyzer using chromosomes, a portion of said chromosomes being step coded; and
a PID controller with discrete constraints, said PID controller configured to receive a gain schedule from said fuzzy controller.

85. The self-organizing control system of claim 83, wherein said genetic analyzer module uses a fitness function that reduces entropy production in a plant controlled by said PID controller.

86. The self-organizing control system of claim 83, wherein said genetic analyzer is used in an off-line mode to develop said training signal.

87. The self-organizing control system of claim 83, wherein said step-coded chromosomes include an alphabet of step up, step down, and hold.

88. The self-organizing control system of claim 83, further comprising an evaluation model to provide inputs to an entropy-based fitness function.

89. The self-organizing control system of claim 83, wherein said fuzzy logic classifier optimizes a number of membership functions in said knolwedge base.

90. A control system for a suspension system, comprising:
a fuzzy logic classifier system configured to optimize a structure of a knowledge base for a fuzzy controller, said fuzzy controller configured to control a linear controller with discrete constraints; and
a genetic analyzer configured to provide a training signal to said fuzzy logic classifier, said genetic analyzer configured to use step-coded chromosomes.

91. The control system of claim 89, wherein said genetic analyzer uses a difference between a time derivative of entropy in a control signal from a learning control unit and a time derivative of an entropy inside the plant as a measure of control performance.

92. The control system of claim 89, wherein said linear controller produces a control signal based on data obtained from one or more sensors that measure said plant.

93. The control system of claim 89, wherein fuzzy rules in said knowledge base are evolved using a kinetic model of the plant in an offline learning mode.

94. The soft computing optimizer of claim 89, wherein said fuzzy logic classifier comprises a Fuzzy Neural Network.

95. The soft computing optimizer of claim 89, wherein said fuzzy logic classifier comprises a Mamdani model.

96. The soft computing optimizer of claim 89, wherein said fuzzy logic classifier comprises a Sugeno model.

97. The soft computing optimizer of claim 89, wherein said fuzzy logic classifier comprises a Tsukamoto model.

98. The soft computing optimizer of claim 1, wherein said first genetic algorithm is configured to optimize said knowledge base according to said teaching signal.
